(19) United States
(12) Patent Application Publication
(10) Pub. No.: US 2004/0246337 A1
(43) Pub. Date: Dec. 9, 2004

(54) Self-test executable integrated circuit, a design apparatus thereof, and a scan chain design apparatus

(75) Inventors: Tetsu Hasegawa, Kanagawa (JP); Kenichi Anzou, Kanagawa (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: KABUSHIKI KAISHA TOSHIBA, Tokyo (JP)

(21) Appl. No.: 10/809,475

(22) Filed: Mar. 26, 2004

(30) Foreign Application Priority Data
Mar. 26, 2003 (JP) 2003-085923

(51) Int. Cl. H04N 17/00

(52) U.S. Cl. 348/189

(57) ABSTRACT

An integrated includes a test pattern generation unit, which divides a test pattern into scanning test patterns; scan chains, which shift in the scanning test patterns, output them to a logic circuit at the same time, input the test results from the logic circuit, and shift out them; and a test result compression unit, which is connected to the output stages of the scan chains, compresses the test results into the same number of compressed test result signatures as the test results, and outputs them to the scan chains in a first order that allows one-to-one mapping.

### CROSS REFERENCE TO RELATED APPLICATIONS

This application is based upon and claims the benefit of priority from prior Japanese Patent Applications No. P2003-85923, filed on Mar. 26, 2003; the entire contents of which are incorporated herein by reference.

### BACKGROUND OF THE INVENTION

1. Field of the Invention

The present invention relates to a semiconductor integrated circuit such as large scale integrated (LSI) circuit. In particular, it relates to an integrated circuit capable of carrying out a self-test.

2. Description of the Related Art

One of the test facilitating methods for solving the difficulty in testing complex LSI circuits is the logic built-in self test (BIST). This logic BIST automatically carries out within an integrated circuit, generation of a test pattern for a to-be-tested target logic and analysis of the results from testing the to-be-tested target logic using a logic circuit configured in an outer area thereof.

### SUMMARY OF THE INVENTION

According to a first aspect of the present invention, a semiconductor integrated circuit includes scan chains implemented by registers disposed in a logic circuit, configured to shift in test patterns, to transfer the test patterns to the logic circuit, to receive test results of the logic circuit, and to shift out the test results, a test pattern generation unit configured to transform the test patterns as scanning test patterns for feeding into the scan chains, and a test result compression unit connected to the output stages of the scan chains, configured to compress the test results so as to generate the same number of compressed test result signatures as the number of the test results, and to transfer the resulting compressed test result signatures to the scan chains in a first order to allow one-to-one mapping.

According to a second aspect of the present invention, a computer implemented apparatus for designing an integrated circuit includes a net list generation unit configured to generate a net list for a test pattern generation unit configured to divide a test pattern into a plurality of scanning test patterns, scan chains implemented by registers disposed in a logic circuit, configured to shift in the scanning test patterns and to simultaneously transfer the scanning test patterns, and to receive test results from the logic circuit and to shift out the test results, the number of the scan chains is the same as the number of those test results, and a test result compression unit connected to the output stages of the scan chains to compress the test results so as to generate the same number of compressed test result signatures as the test results, and to transfer a resulting compressed test result signatures to the scan chains in a first order that allows one-to-one mapping, and a self-test circuit insertion unit configured to insert the net list for the test pattern generation unit, the scan chains, and the test result compression unit in the net list for the integrated circuit.

According to a third aspect of the present invention, a computer implemented apparatus for designing scan chains inplemented by registers in an integrated circuit includes a logical cone extraction unit configuted to extract a logic circuit that outputs a value according to changeable input values in the registers, and to generate a logical cone, which is a combination circuit that is included by the logic circuit, for each register, a dependency extraction unit configured to generate a group of the registers in the logical cone including the same logic circuit, and a scan chain configuration unit configured to generate a single scan chain using only the registers not belonging to the same group.

### BRIEF DESCRIPTION OF DRAWINGS

FIG. 1 is a block diagram showing a configuration of an integrated circuit in logic BIST mode with a logic BIST circuit based on the STUMPS method as a comparative example;

FIG. 2 is a block diagram showing a configuration of an integrated circuit in scan-test mode as a comparative example;

FIG. 3 is a block diagram showing a configuration of an integrated circuit in normal system mode as a comparative example;

FIG. 4 is a block diagram showing a configuration of an integrated circuit, according to a first embodiment of the present invention, in failure pattern determination mode;

FIG. 5 is a block diagram showing a configuration of the integrated circuit, according to the first embodiment of the present invention, in failure scan chain determination mode;

FIG. 6 is a block diagram showing a configuration of the integrated circuit, according to the first embodiment of the present invention, in failure block determination mode;

FIG. 7 is a block diagram showing a configuration of the integrated circuit, according to the first embodiment of the present invention, in failure register determination mode;

FIG. 8 is a block diagram showing a configuration of the integrated circuit, according to the first embodiment of the present invention, in normal system mode;

FIG. 9 is a flowchart for a method of identifying a failure location in the integrated circuit, according to the first embodiment of the present invention;

FIG. 10 is a block diagram showing a main part of the integrated circuit, according to the first embodiment of the present invention, in failure scan chain determination mode;

FIG. 11 shows an example of a test pattern generator circuit;

FIG. 12 shows an example of a circuit of a data compression unit in a scan chain compression unit;

FIG. 13 is a flowchart for a method of identifying a failure scan chain in the integrated circuit, according to the first embodiment of the present invention;

FIG. 14 is a flowchart for the method of identifying a failure scan chain in the integrated circuit, according to the first embodiment of the present invention;

FIG. 15 is a block diagram showing a main part of the integrated circuit, according to the first embodiment of the present invention, in failure scan chain determination mode;

FIG. 16 is a flowchart for a method of identifying a failure pattern and a failure scan chain in an integrated circuit, according to a first modified example of the first embodiment of the present invention;

FIG. 17 is a detailed flowchart for a method of identifying a failure pattern in the integrated circuit, according to the first modified example of the first embodiment of the present invention;

FIG. 18 is a detailed flowchart for a method of identifying a failure scan chain in the integrated circuit, according to the first modified example of the first embodiment of the present invention;

FIG. 19 shows an example of a circuit of a collective compression unit;

FIG. 20 is a block diagram showing a main part of an integrated circuit, according to a second modified example of the first embodiment of the present invention, in failure pattern determination mode;

FIG. 21 is a block diagram showing a main part of the integrated circuit, according to the second modified example of the first embodiment of the present invention, in failure scan chain determination mode;

FIG. 22 shows an example of a mode switching circuit and a circuit of a data compression unit;

FIG. 23 is a block diagram showing a main part of an integrated circuit, according to a second embodiment of the present invention, in failure block determination mode;

FIG. 24 is a flowchart for a method of identifying a failure block in the integrated circuit, according to the second embodiment of the present invention;

FIG. 25 is a flowchart for a method of identifying a failure block in the integrated circuit, according to the second embodiment of the present invention;

FIG. 26 is a flowchart for a method of identifying a failure block in the integrated circuit, according to the second embodiment of the present invention, and then outputting to a tester the results from testing that identified failure block;

FIG. 27 is a block diagram showing a main part of an integrated circuit, according to a first modified example of the second embodiment of the present invention, in failure block determination mode;

FIG. 28 is a block diagram showing a main part of an integrated circuit, according to a second modified example of the second embodiment of the present invention, in failure block determination mode;

FIG. 29 is a block diagram showing a main part of an integrated circuit, according to a third modified example of the second embodiment of the present invention, in failure pattern determination mode;

FIG. 30 is a block diagram showing a main part of the integrated circuit, according to the third modified example to the second embodiment of the present invention, in failure scan chain determination mode;

FIG. 31 is a block diagram showing a main part of the integrated circuit, according to the third modified example of the second embodiment of the present invention, in failure block determination mode;

FIG. 32 is a block diagram showing a main part of an integrated circuit, according to a fourth modified example of the second embodiment of the present invention, in failure block determination mode;

FIG. 33 is a flowchart for a method of identifying a failure block in an integrated circuit, according to the fourth modified example of the second embodiment of the present invention;

FIG. 34 is a block diagram showing a main part of an integrated circuit, according to a third embodiment of the present invention, in failure register determination mode;

FIG. 35 is a table of the output value of a one-hot counter.

FIG. 36 is a block diagram showing a main part of an integrated circuit, according to a first modified example of a third embodiment of the present invention, in failure register determination mode;

FIG. 37 is a block diagram showing a main part of an integrated circuit, according to a second modified example of the third embodiment of the present invention, in failure register determination mode;

FIG. 38 is a circuit explaining a method of identifying a failure-propagated flip-flop (F/F) in an integrated circuit, according to the second modified example of the third embodiment of the present invention;

FIG. 39 is a flowchart for a method of identifying a failure register in an integrated circuit, according to the second modified example of the third embodiment of the present invention;

FIG. 40 is a circuit explaining how a failure influences two flip-flops (F/Fs) belonging to a scan chain;

FIG. 41 is a circuit explaining how a failure influences two flip-flops (F/Fs) belonging to different scan chains, respectively;

FIG. 42 is a block diagram showing a configuration of a scan chain design aid apparatus, according to a fourth embodiment of the present invention;

FIG. 43 is a flowchart for a scan chain design aid method, according to the fourth embodiment of the present invention;

FIG. 44 is a block diagram showing a configuration of an integrated circuit design aid apparatus, according to a fifth embodiment of the present invention; and

FIG. 45 is a flowchart for an integrated circuit design aid method, according to the fifth embodiment of the present invention.

### DETAILED DESCRIPTION OF THE INVENTION

Various embodiments of the present invention will be described while referencing the accompanying drawings. It is to be noted that the same or similar reference numerals are applied to the same or similar parts and elements throughout the drawings, and the description of the same or similar parts and elements will be omitted or simplified.

### COMPARATIVE EXAMPLE

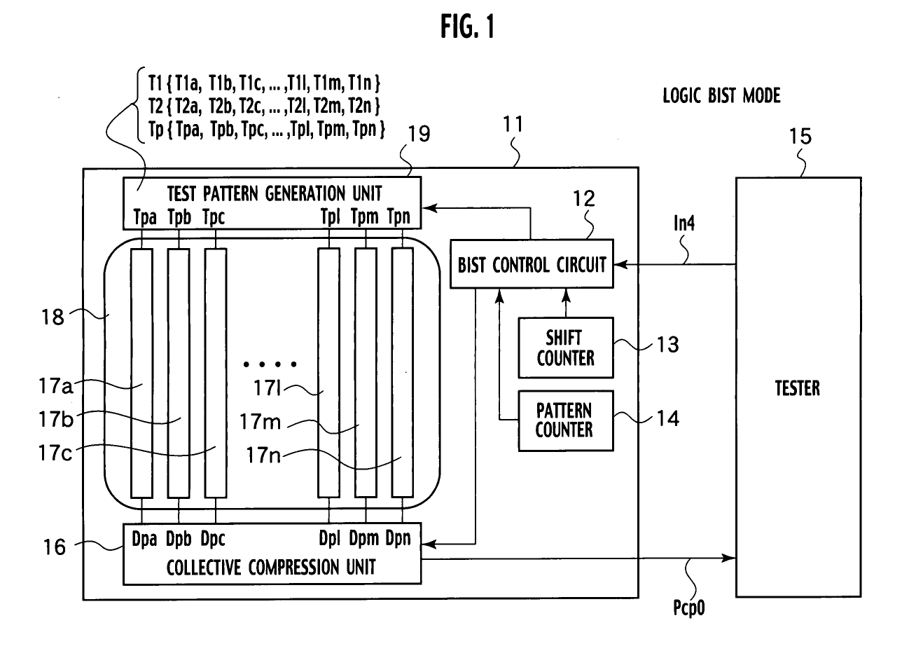

As shown in FIG. 1, a comparative example of an integrated circuit 11 includes multiple scan chains 17a to 17n, a test pattern generation unit 19, a collective compression unit 16, a BIST control circuit 12, a shift counter 13, and a pattern counter 14. The scan chains 17a to 17n are made up of memory devices, which configure a to-be-tested logic 18. The test pattern generation unit 19 is connected to the input terminals of the scan chains 17a to 17n. The collective compression unit 16 is connected to the output terminals of the scan chains 17a to 17n. The BIST control circuit 12 is connected to the test pattern generation unit 19 and the collective compression unit 16. The shift counter 13 is connected to the BIST control circuit 12. The pattern counter 14 is connected to the BIST control circuit 12. The BIST control circuit 12 and the collective compression unit 16 are connected to a tester 15 deployed on the outside of the integrated circuit 11.

Next, the logic BIST technique is described. The BIST control circuit 12 receives an external input signal In4, which is used to set a self-test mode, from the tester 15. Upon reception of the external input signal In4, the integrated circuit 11 enters the self-test (logic BIST) mode, to start self-testing. The test pattern generation unit 19 generates multiple test patterns T1 to Tp based on a signal, which is output from the BIST control circuit 12 in conformity with the pattern counter 14. Testing for each of the test patterns T1 to Tp is carried out. A test for each of the test patterns T1 to Tp is consecutively performed. The test pattern Tp is described as an example. The test pattern Tp includes multiple scanning test patterns Tpa to Tpn. The scan chains 17a to 17n scan in and store the respective scanning test patterns Tpa to Tpn, in conformity with the signal that is output from the BIST control circuit in conformity with the shift counter 13. The scan chains 17a to 17n output the test patterns Tpa to Tpn, respectively. The scan chains 17a to 17n activate the to-be-tested logic 18. The scan chains 17a˜17n capture activated test results Dpa to Dpn. The scan chains 17a to 17n scan out the test results Dpa to Dpn in conformity with the signal that is output from the BIST control circuit 12 in conformity with the shift counter 13. The collective compression unit 16 receives the test results Dpa to Dpn. The corrective compression unit 16 compresses the test results Dpa to Dpn into a signature DCpO having a length corresponding to the collective compression unit 16. The collective compression unit 16 outputs the signature DcpO to the tester 15 as the result of testing the to-be-tested target logic 18 and analyzing the tested results. The tester 15 determines whether the tested target logic 18 is normal based on the signature DcpO. By this logic BIST technique, a determination is made as to whether there is a failure in the target logic 18.

However, it is difficult to carry out failure analysis of the integrated circuit 11 of a failure using the logic BIST that collectively compresses the test results. The test results Dpa to Dpn are compressed in the integrated circuit 11 using the logic BIST method. This is because necessary information for failure analysis cannot be obtained from the compressed signature DCpO. To carry out failure analysis, a test pattern (failure pattern) Tp, which is used to detect a failure, and the resulting pattern from detecting failures Dpa to Dpn are necessary. Furthermore, to carry out failure analysis, scanning flip-flops, which are memory devices configuring the scan chains 17a to 17n and which have detected a failure, must be identified. Moreover, to carry out failure analysis, connection information on failure location, which allows transfer of an electrical signal representing the influence of a failure, to a failure scanning F/F, is necessary. Failure analysis requires a failure scanning F/F and information about a test pattern failure that uses a method other than the logic BIST mode of FIG. 1

Accordingly, with failure analysis being the final objective, using the logic BIST method, the test pattern generation unit 19 generates multiple test patterns T1 to Tp in conformity with the pattern counter 14, and the tester 15 determines whether there is a failure for each test pattern T1 to Tp. Determination whether there is a failure is made for each single pattern. An operation for a single pattern means shifting each of the scanning test patterns Tpa to Tpn into the scan chains 17a to 17n corresponding to each of the scanning test patterns Tpa to Tpn individually in serial order, and then outputting the signature DCpO to the tester 15 in series. Taking the test results Dpa to Dpn into the scan chains 17a to 17n in parallel is called ‘parallel capture’. Moreover, outputting the test results Dpa to Dpn from the scan chains 17a to 17n in series is called ‘serially shifting out’, whereas inputting the scanning test patterns Tpa to Tpn in series from the tester 15 or the test pattern generation unit 19 is called ‘serially shifting in’. Serially shifting out the test results Dna to Dnn for the nth test pattern Tn is carried out at the same time as serially shifting in the scanning test patterns Tn+1a to Tn+1n of the n+1th test pattern Tn+1. The collective compression unit 16 receives the test results Dpa to Dpn in parallel, and then outputs the signature DCpO, which is provided by collectively compressing the patterns. By comparing the signature DCpO with the corresponding expected value for each of pattern tests T1 to Tp, the tester 15 may identify which of the test patterns T1 to Tp shows a difference between the signature DCpO and the corresponding expected value. Based on comparison of the signature DCpO with a detected failure, one of the test patterns T1 to Tp for which a failure has been detected may be identified. That is, one of the test patterns T1 to Tp is a ‘failure pattern’.

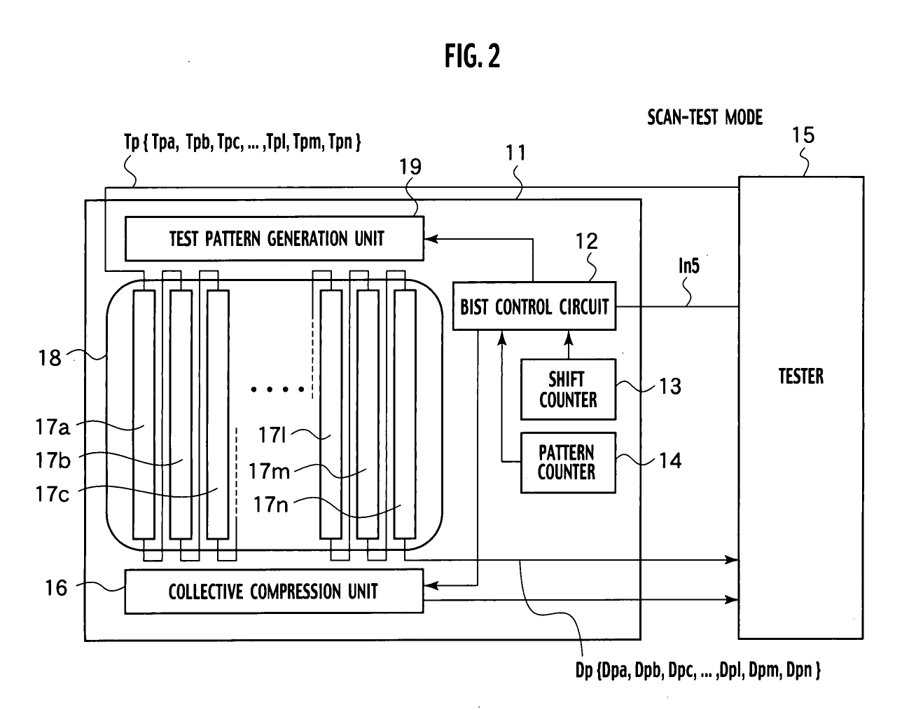

Next, a determination is made as to which scanning flip-flop has detected a failure. In order to make such a determination, the integrated circuit 11 shown in FIG. 1 is changed to the scan test mode as shown in FIG. 2. As shown in FIG. 2, the integrated circuit 11 is changed to the scan test mode in conformity with a control signal In5 sent from the tester 15. The BIST control circuit 12 uncouples the to-be-tested logic 18 from the test pattern generation unit 19 and the collective compression unit 16 in conformity with the control signal In5. The to-be-tested logic 18 is thus connected to the tester 15. More specifically, the scan chains 17a to 17n are connected to each other in series, and the input terminal of the first stage of the scan chain 17a and the output terminal of the last stage of the scan chain 17n are connected to the scanning channels of the tester 15, respectively.

A test pattern Tp for the failure pattern identified in the self-test mode is scanned in the integrated circuit 11 in the scan test mode shown in FIG. 2 from the tester 15, and the test results Dpa to Dpn are then scanned out. The tester 15 compares each of the test results Dpa to Dpn with the expected values there for, identifying a failure scanning F/F based on the order of the output test results Dpa to Dpn, which are all pieces of data compared and found to be different from the corresponding expected values.

In this way, with the integrated circuit 11 shown in FIGS. 1 and 2, the tested results have to be analyzed for detecting a failure pattern Tp. In addition, as shown in FIG. 2, multiple tests must be carried out by changing to scan test mode. Moreover, additionally preparing scan test patterns T1 to Tp for the tester 15, and designing a circuit for the scan test mode are necessary. Furthermore, it is conjectured that the failures, which can be detected using the logic BIST mode, cannot be detected in scan test mode, or the failures may not recur. The failures may not recur in conditions such as when the operation speed differ when using the logic BIST mode and scan test mode. This is a serious problem especially when carrying out a real operating speed test using the logic BIST mode. Therefore, identifying a failure scanning F/F without using the scan test mode is desirable.

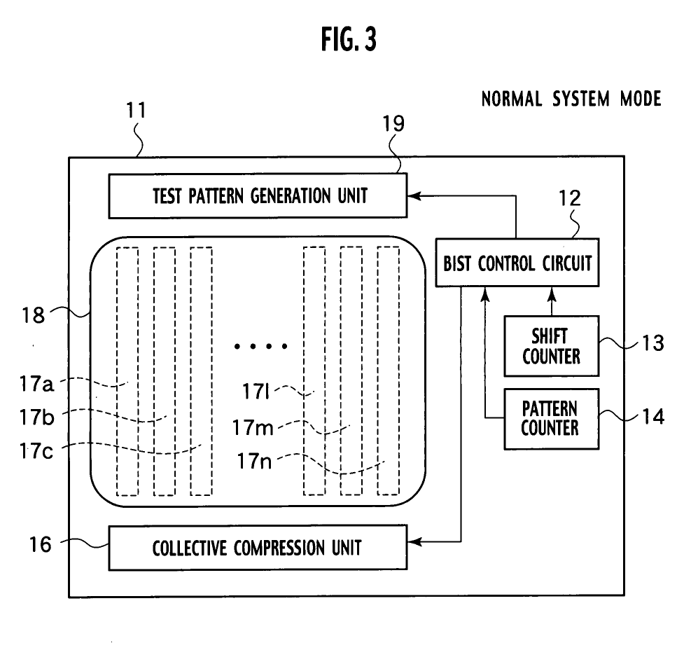

FIG. 3 shows a normal system mode of the semiconductor integrated circuit 11. The BIST circuits 12, 13, 14, 19, 16 are suspended in the normal system mode. The scan chains 17a to 17n does not function as the scan chains in the normal system mode. By the way, the failure pattern is the pattern that detects a failure. The failure pattern is the pattern tested in the time when the tester 25 detects a failure. The failure register is the register that detects a failure. The failure scan chain is the chain that contains the failure register.

(First Embodiment)

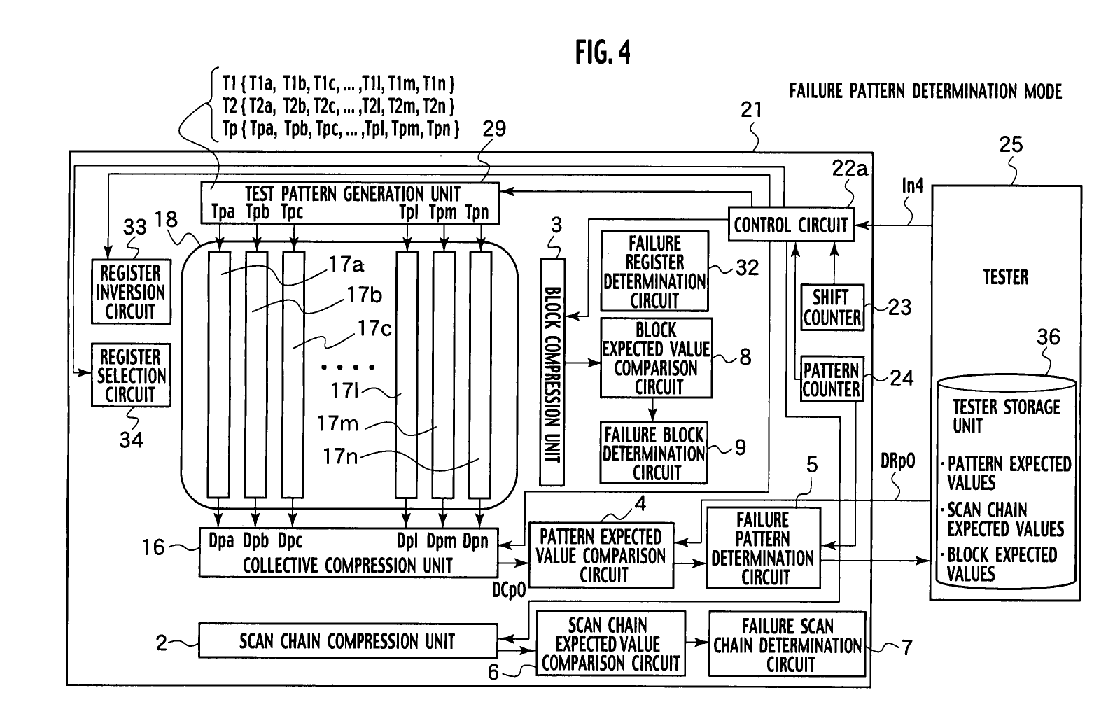

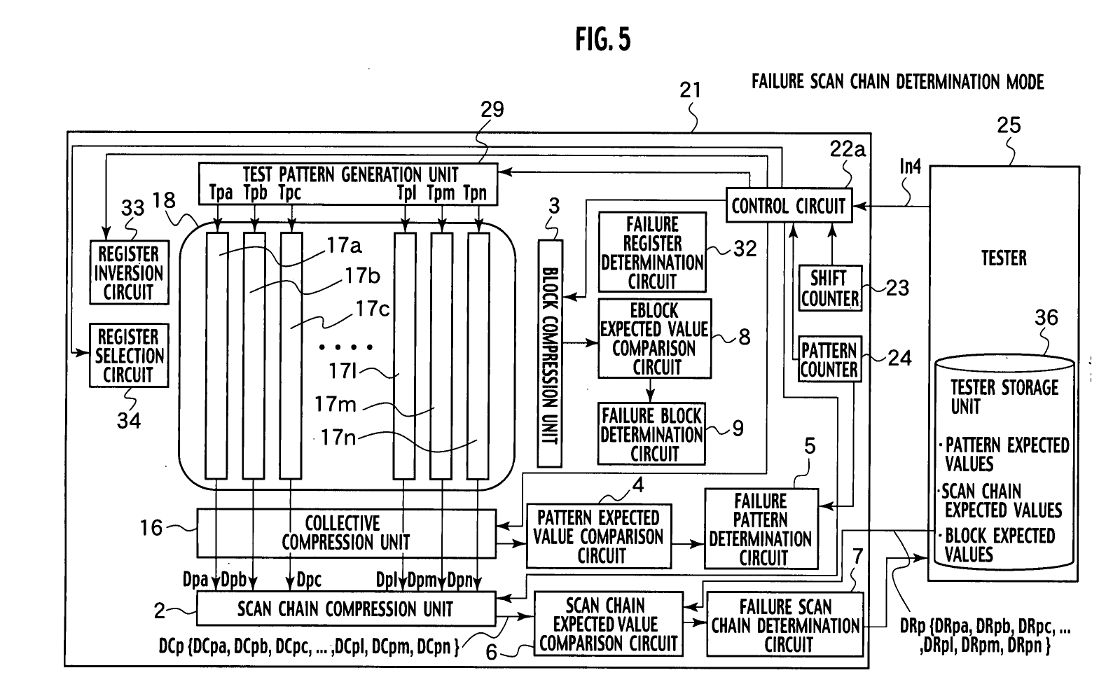

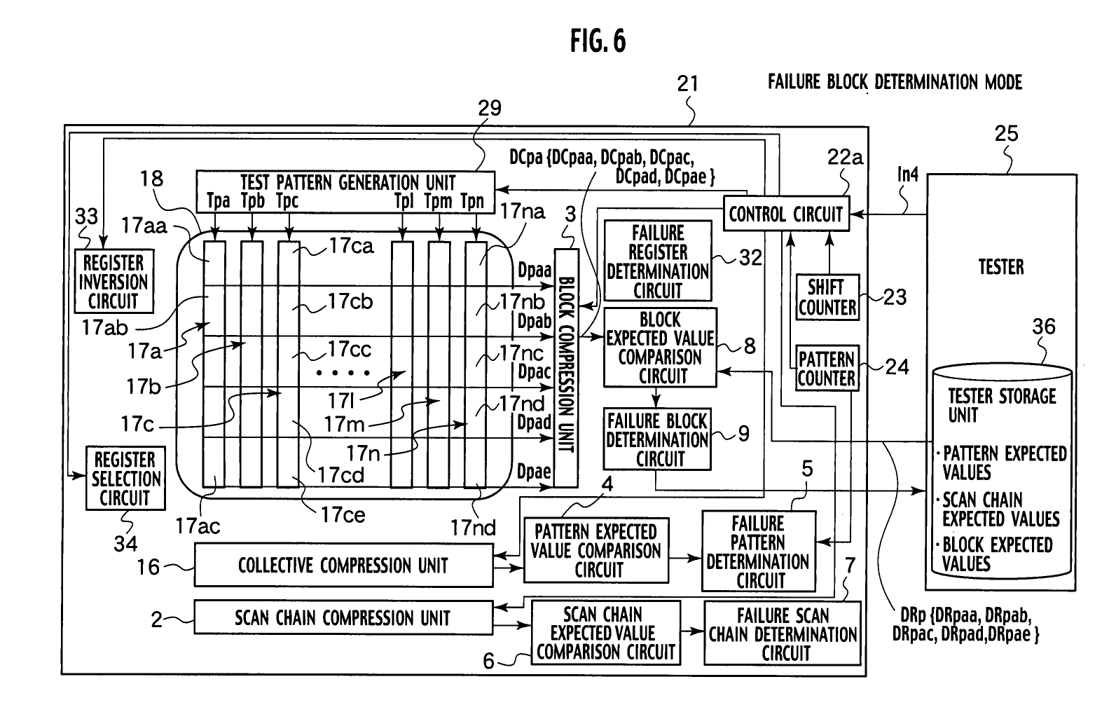

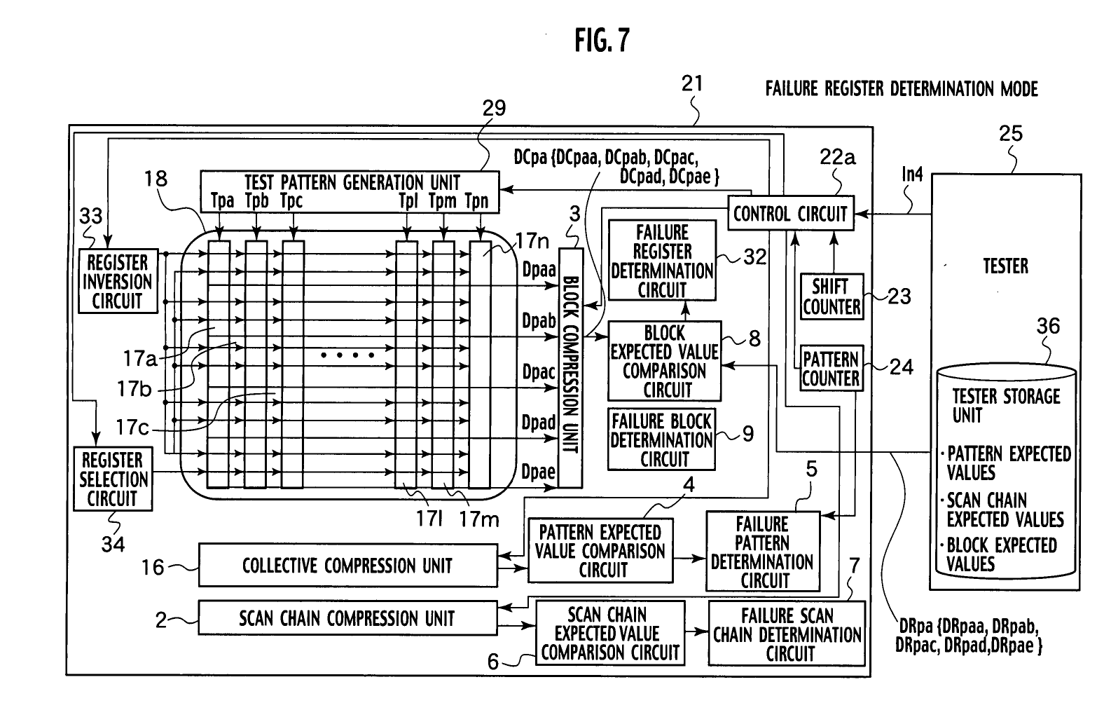

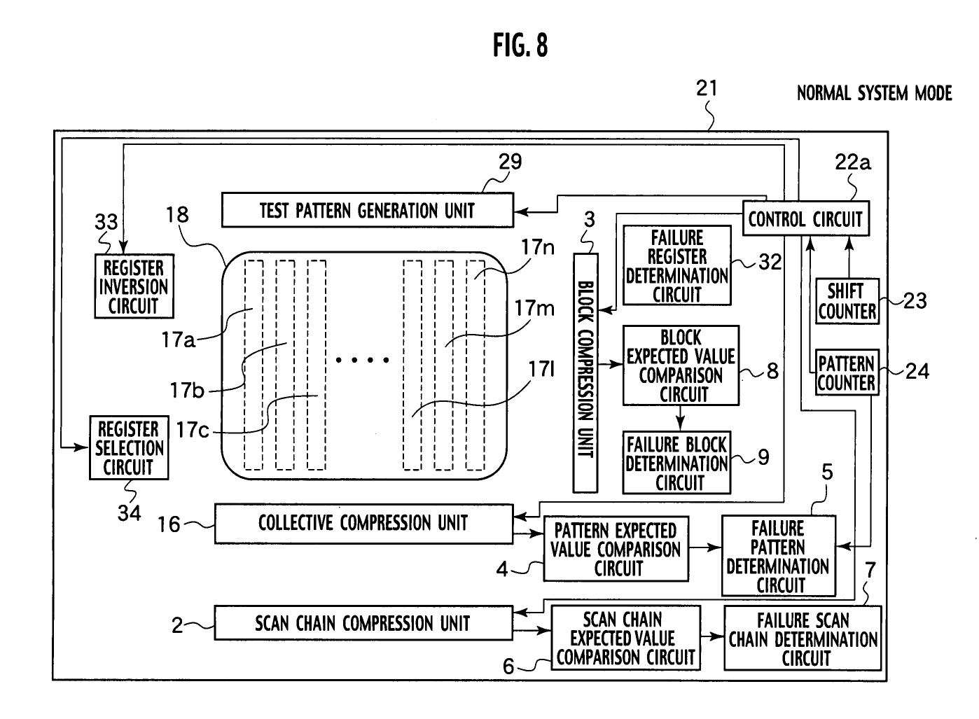

As shown in FIGS. 4 through 8, an integrated circuit 21, according to a first embodiment of the present invention, includes multiple shift registers (scan chains) 17a to 17n, a test pattern generation unit 29, a collective compression unit 16, a scan chain compression unit 2, a block compression unit 3, an expected pattern value comparison circuit 4, a failure pattern determination circuit 5, a scan chain expected value comparison circuit 6, a failure scan chain determination circuit 7, a block expected value comparison circuit 8, a failure block determination circuit 9, a failure register determination circuit 32, a register inversion circuit 33, a register selection circuit 34, a shift counter 23, a pattern counter 24, and a control circuit 22a. Note that the expected pattern value comparison circuit 4, the scan chain expected value comparison circuit 6 and the block expected value comparison circuit 8 may be included in the tester 25, in place of the integrated circuit 21. The failure pattern determination circuit 5, the failure scan chain determination circuit 7 and the failure register determination circuit 32 may be constituted by software of the tester 25 using the failure log. The collective compression unit 16 is not always necessary for the integrated circuit 21. The integrated circuit 21 includes at least one of a pair of the register inversion circuit 33 and the register selection circuit 34, the scan chain compression unit 2, and the block compression unit 3. The integrated circuit 21 can enter a failure pattern determination mode as shown in FIG. 4, a failure scan chain determination mode as shown in FIG. 5, a failure block determination mode as shown in FIG. 6, a failure register determination mode as shown in FIG. 7, or normal system mode as shown in FIG. 8. The tester 25 includes a tester storage unit 36. The tester storage unit 36 stores an expected pattern value, a scan chain expected value, and a block expected value. The tester storage unit 36 preserves the test results as the failure log.

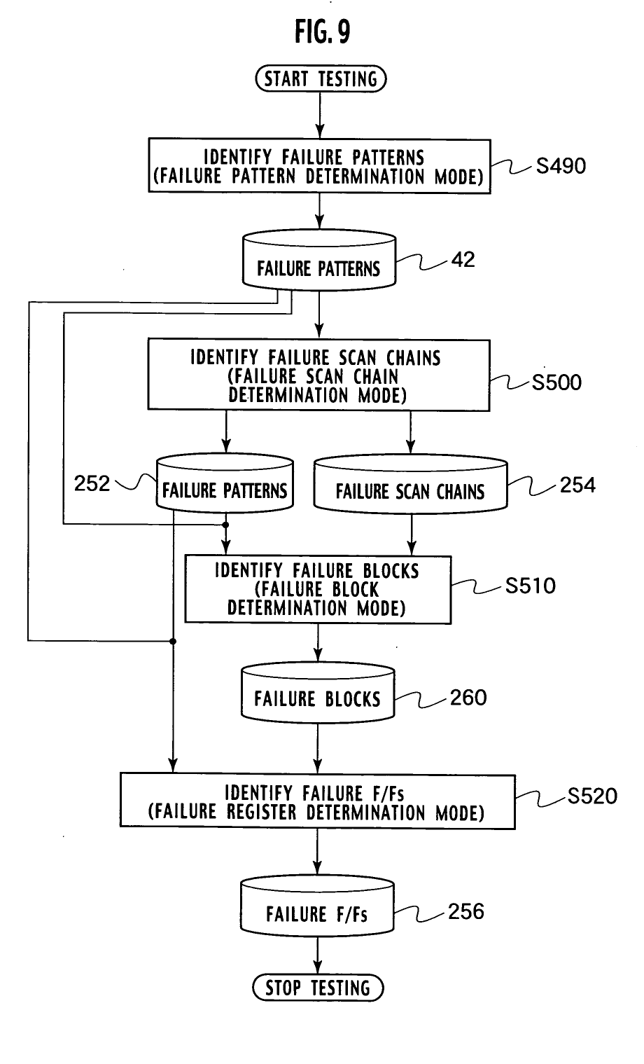

As shown in FIG. 9, according to a test method for the integrated circuit 21, to begin with, in step S490, the control circuit 22a sets the integrated circuit 21 to failure pattern determination mode as shown in FIG. 4 in conformity with the control signal In4 from the tester 25. The test pattern generation unit 29 generates multiple test patterns T1 to Tp based on the pattern counter 24. The tester 25 determines for each of the test patterns T1 to Tp whether there is a failure. There are two parts of the operations of the scanning test. One part of the operations is the shift operation that loads the test patterns to the scan chains and also unloads the test results in the scan chains. Another part of the operations is the capturing operation in which the flip-flops capture the test results. One test pattern is loaded, captured and unloaded as a unit set. Generally, the unload of the previous test patterns and the load of the present test pattern are carried out simultaneously. The unload of the present test pattern and the load of the next test patterns are carried out simultaneously. The scan chains 17a to 17n take in the scanning test patterns Tpa to Tpn in parallel for a single test pattern Tp. The scan chains 17a to 17n take in the test results Dpa to Dpn in parallel through parallel capturing. Each of the scanning test patterns Tpa to Tpn is shifted into the scan chains 17a to 17n corresponding to each of the scanning test patterns Tpa to Tpn in individual in serial order. The test results Dpa to Dpn from the scan chains 17a to 17n are individually output to the collective compression unit 16 in serial order. The test results Dna to Dnn for the nth test pattern Tn are the serial shifted out at the same time as serially shifting in the scanning test patterns Tn+1a to Tn+1n for the (n+1)th test pattern Tn+1. The collective compression unit 16 receives the test results Dpa to Dpn from the outputs of all of the scan chains in parallel, and then outputs the signature DCpO, which is obtained by collectively compressing the test results Dpa to Dpn. The expected pattern value comparison circuit 4 compares the signature DCpO with the corresponding expected value DRp0 for each of the test patterns T1 to Tp. The expected pattern value comparison circuit 4 identifies which of the test patterns T1 to Tp shows the signature DCpO differing from the corresponding expected value DRp0. The failure pattern determination circuit 5 identifies a test pattern of T1 to Tp for which a failure has been detected based on the time (step) when the signature DcpO that disagrees with the expected value is detected by the failure pattern determination circuit 5. The number of the step when the signature DCpO disagrees with the expected value DRp0 is counted as the count number by the pattern counter 24. This identified test pattern Tp is a failure pattern, and is output to the tester 25.

Next, in step S500, the control circuit 22 sets the integrated circuit 21 to the failure scan chain determination mode as shown in FIG. 5 in conformity with the control signal In4 from the tester 25. The test pattern generation unit 29 generates a failure pattern Tp. The test pattern generation unit 29 set up the test patterns Tpa to Tpn of the failure pattern Tp to the scan chains 17a to 17n on the basis of pattern counter 24. For this, the test pattern generation unit 29 generates test patterns at the times of the product of the counting number of the pattern counter 24 and the shift length. And, the test pattern generation unit 29 sets up the failure pattern Tp as an initial value. Or, the control circuit 22a inserts the initial value corresponding to the failure pattern Tp into the test pattern generation unit 29 from the tester 25. The scan chains 17a to 17n take in the test results Dpa to Dpn in parallel through parallel capturing. The test results Dpa to Dpn, from the scan chains 17a to 17n, are individually, serially output to the scan chain compression unit 2. The scan chain compression unit 2 receives the test results Dpa to Dpn in parallel. The scan chain compression unit 2 compresses all of the test results Dpa to Dpn, generates compressed test result signatures DCpa to DCpn. The test result Dpa is compressed as the compressed test result signatures DCpa. The test result Dpn is compressed as the compressed test result signatures DCpn. The scan chain compression unit 2 serially outputs the compressed test result signatures DCpa to DCpn in order. The order is by which the scan chain 17a˜17n is determined based on the comparative result of the expected values. This order allows the compressed test result signatures DCpa to DCpn to correspond to the scan chains 17a to 17n on a one-to-one mapping basis. The scan chain expected value comparison circuit 6 compares the compressed test result signatures DCpa to DCpn with their expected values DRpa to DRpn in the order in which they are written. The scan chain expected value comparison circuit 6 determines the order of one of the compressed test result signature values DCpa to DCpn that differs from the corresponding one of the expected values DRpa to DRpn. The failure scan chain determination circuit 7 identifies a failure-detecting scan chain from the scan chains 17a to 17n based on the compressed test result signatures DCpa to DCpn for which a failure has been detected. That detecting scan chain 17a is a failure scan chain. The failure scan chain determination circuit 7 outputs an identification signal for the scan chain 17a to the tester 25. Note that omitting step S490 and detecting the failure pattern 217 in step S500 is possible.

In step S510, the control circuit 22a sets the integrated circuit 21 to failure block determination mode as shown in FIG. 6 in conformity with the control signal In4 from the tester 25. The test pattern generation unit 29 generates a failure pattern Tp in accordance with the pattern counter 24. The scan chains 17a to 17n take in the scanning test patterns Tpa to Tpn in parallel for the failure pattern Tp. The scan chains 17a to 17n take the test results Dpa to Dpn in parallel through parallel capturing. In the case of the failure scan chain being the scan chain 17a, for example, the block compression unit 3 selectively receives in conformity with a control signal from the control circuit 22a, the block test results Dpaa to Dpae, which are obtained by dividing the test result Dpa by blocks 17aa to 17ae. The Scan chains 17a to 17n are divided into blocks of 17aa to 17ae, 17ba to 17be, 17ca to 17ce, 17da to 17de, and 17ea to 17ee. The blocks 17aa to 17ae output the corresponding block test results Dpaa to Dpae. The block compression unit 3 serially receives each the block test results Dpaa to Dpae. The block compression unit 3 compresses each of the block test results Dpaa to Dpae, and generates the compressed test result signatures DCpaa to DCpae. The block compression unit 3 serially outputs the compressed test result signatures DCpaa to DCpae in order. The order allows the compressed test result signature values DCpaa to DCpae to correspond to the respective blocks 17aa to 17ae, one to one. The block expected value comparison circuit 8 compares the compressed test result signatures DCpaa to DCpae with the expected values DRpaa to DRpae thereof in the written order. The block expected value comparison circuit 8 identifies the order of one of the compressed test result signatures DCpaa to DCpae that differs from the corresponding one of the expected values DRpaa to DRpae. The failure block determination circuit 9 identifies the failure detected blocks 17aa to 17ae based on the failure-detected compressed test result signatures DCpaa to DCpae. For example, the identified scan chain 17aa is a failure block, and an identification signal for the block 17aa is then output to the tester 25. Consequently, a failure block 260 is identified. By the way, The failure block is the block that contains the failure register.

In step S520, the control circuit 22a sets the integrated circuit 21 to failure register determination mode as shown in FIG. 7 in conformity with the control signal In4 from the tester 25. The case of the failure block being the block 17aa, for example, is explained next. Since the block 17aa is a failure block, the outputted block test result Dpaa differs from the expected pattern. The block test result Dpaa is a set of data patterns stored in multiple flip-flops. In the failure block, at least one flip-flop stores the data that is different from an expected data of a normal circuit. This flip-flop is called a failure flip-flop. Therefore, inverting the data stored in the failure flip-flop results in a perfect match of the output block test result Dpaa to the expected pattern. On the other hand, a failure flip-flop denotes a flip-flop stored with data which, when inverted, is then output as the outputted and compressed block test result signature DCpaa, and matches the expected pattern.

The test pattern generation unit 29 generates a failure pattern Tp based on the pattern counter 24. Each of the scanning test patterns Tpa to Tpn is individually serially shifted into the scan chains 17a to 17n corresponding to each of the scanning test patterns Tpa to Tpn of the failure pattern Tp. The scan chains 17a to 17n take in the test results Dpa to Dpn in parallel by parallel capturing. The blocks 17aa to 17ae capture the corresponding block test results Dpaa to Dpae. The register selection circuit 34 selects a single flip-flop from the block 17aa in conformity with the control signal from the control circuit 22a. The register inversion circuit 33 inverts the data stored in the selected flip-flop in conformity with the control signal from the control circuit 22a. The block compression unit 3 selectively receives the block test results Dpaa to Dpae in parallel in conformity with the control signal from the control circuit 22a. The block compression unit 3 compresses each of the block test results Dpaa to Dpae into the compressed test result signatures DCpaa to DCpae. The block compression unit 3 serially outputs the compressed test result signatures DCpaa to DCpae in order. This order allows the compressed test result signatures DCpaa to DCpae to correspond to the blocks 17aa to 17ae on a one-to-one mapping basis. The block expected value comparison circuit 8 compares the compressed test result signatures DCpaa to DCpae with the respective expected values DRpaa to DRpae thereof in the written order. The block expected value comparison circuit 8 determines whether the expected values DRpaa to DRpae match the respective compressed test result signatures DCpaa to DCpae. Capturing by use of failure patterns is repeated while changing selection of a flip-flop until the expected values DRpaa to DRpae match the compressed test result signatures DCpaa to DCpae. The failure register determination circuit 52 outputs the identification number of the flip-flop selected when the expected values DRpaa to DRpae have matched the compressed test result signature DCpaa to DCpae. In this way, a failure flip-flop 256 is identified.

FIG. 8 shows the normal system mode of the semiconductor integrated circuit 21. The BIST circuits 2-9, 16, 22a, 23, 24, 29 and 32-34 are suspended in the normal system mode. The scan chains 17a to 17n do not function as the scan chains in the normal system mode.

The description up to this point has disclosed the entire configuration of the integrated circuit 21 according to the first embodiment. Hereinafter, the integrated circuit 21 in failure scan chain determination mode according to the first embodiment is described. Moreover, detailed description is given as to how to identify failure scan chains with the integrated circuit 21 according to the first embodiment.

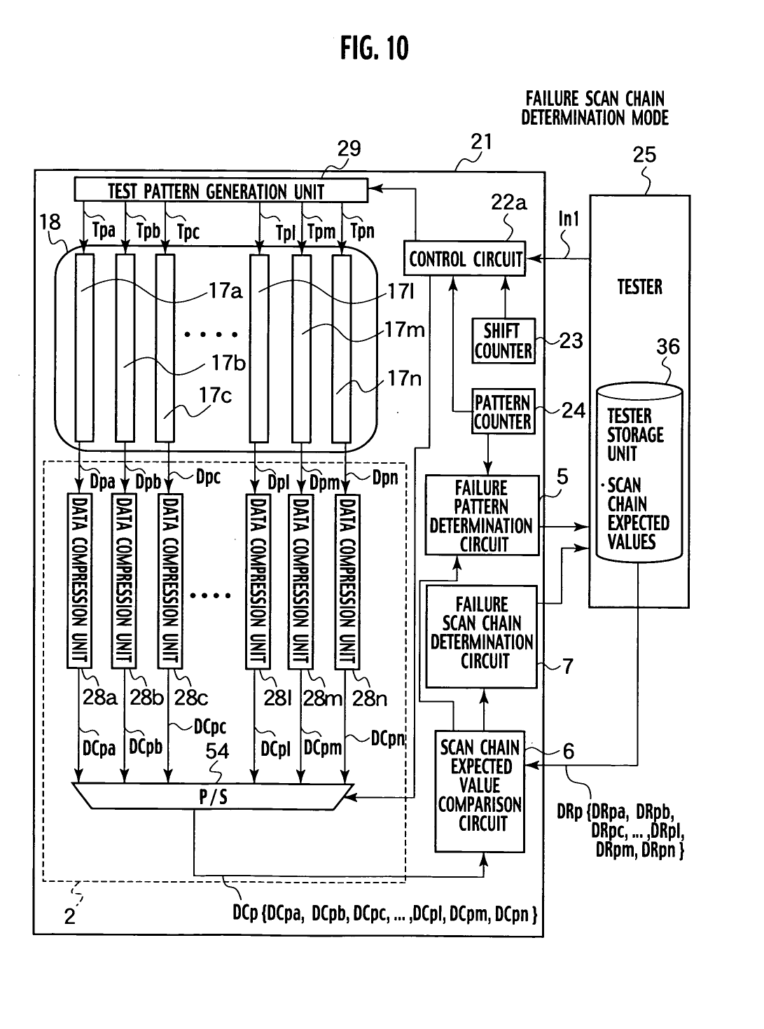

In the integrated circuit 21, according to the first embodiment of the present invention as shown in FIG. 10, only circuits working in failure scan chain determination mode are described as compared with FIG. 5. Moreover, details of the scan chain compression unit 2 are shown. The scan chain compression unit 2 includes multiple data compression units 28a to 28n and a parallel to serial converter P/S.

The data compression units 28a to 28n are connected to the respective output terminals of the scan chains 17a to 17n, which are shift registers. The data compression units 28a to 28n receive the test results Dpa to Dpn, and then output the compressed test result signatures DCpa to DCpn. The number of the scan chains 17a to 17n, the data compression units 28a to 28n, the test patterns Tpa to Tpn, the test results Dpa to Dpn, and the compressed test result signatures DCpa to DCpn are the same.

The parallel to serial converter P/S is connected to all of the data compression units 28a to 28n. The parallel to serial converter P/S receives the compressed test result signatures DCpa to DCpn in parallel, and then serially outputs the compressed test result signatures DCpa to DCpn in order to the scan chain expected value comparison circuit 6. The order of the compressed test result signatures DCpa to DCpn corresponds to that of the scan chains 17a to 17n.

The control circuit 22a is connected to the shift counter 23, the pattern counter 24, the test pattern generation unit 29, and the parallel to serial converter P/S. The control circuit 22a, the scan chain expected value comparison circuit 6, and the failure scan chain determination circuit 7 are respectively connected to the tester 25 located exterior to the integrated circuit 21. Therefore, the scan chain compression unit 2 can select each of the scan chains 17a to 17n. The scan chains 17a to 17n make up the to-be-tested logic 18. Each of the scan chains 17a to 17n has flip-flops connected to each other in the form of a shift register. The flip-flop is an example of a register, which is a memory device in the logic circuit 18 and can be any type of memory device as long as a shift register can be made up thereof. The scan chains 17a to 17n and an example of a shift register.

The tester 25 sends an external input signal In1, which is used to set the control circuit 22a to failure scan chain determination mode. The control circuit 22a receives the external input signal In1, and sets the integrated circuit 21 including the to-be-tested logic 18 to failure scan chain determination mode. While the scan chains 17a to 17n are serially operating in failure scan chain determination mode, the flip-flops in the scan chains 17a to 17n are connected to the test pattern generation unit 29 and the data compression units 28a to 28n, which is different then when in normal system mode. After initialization of the test pattern generation unit 29, inputting a predetermined number of clock cycles for a self-test allows execution of the self-test. The test pattern generation unit 29 and the parallel to serial converter P/S may be supplied with a signal In1 and a clock signal directly from the external input signal In1 or via the control circuit 22a.

During the self-test, the test pattern generation unit 29 automatically generates the scanning test patterns Tpa to Tpn of the test pattern Tp, which are serially input to scan chains 17a to 17n. In other words, the test pattern generation unit 29 generates the scanning test patterns Tpa to Tpn, and sends the scanning test patterns to the scan chains 17a to 17n. The scan chains 17a to 17n receive the scanning test patterns Tpa to Tpn, take in the test results Dpa to Dpn from the to-be-tested logic circuit 18 in parallel, and send the test results Dpa to Dpn to the data compression unit 28a to 28n, respectively. The data compression units 28a to 28n compress the input data of the test results Dpa to Dpn into a specific bit length of data (signature), and then generate compressed test result signatures DCpa to DCpn. The parallel to serial converter 54 inputs the compressed test result signatures DCpa to DCpn in parallel and then serially outputs the compressed test result signatures DCpa to DCpn. The scan chain expected value comparison circuit 6 compares the serial signal DCp (DCpa to DCpn) for the compressed test result signatures DCpa to DCpn with the serial signal DRp (DRpa to DRpn) for the expected values DRpa to DRpn for the compressed test result signatures stored in the tester storage unit 36. The failure scan chain determination circuit 7 determines, based on the comparison results, whether the to-be-tested logic 18 has a failure. The failure scan chain determination circuit 7 sends that determined result to the tester 15. Note that the shift counter 23 manages the count for serially operating scan chains. The pattern counter 24 selects each of the test patterns T1 to Tp.

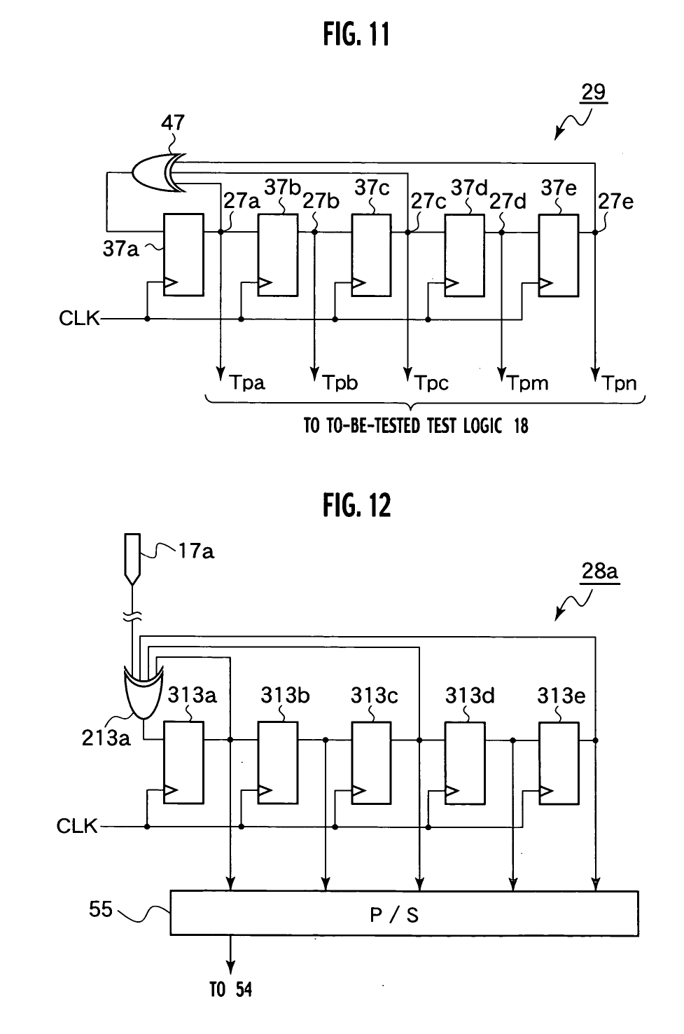

As shown in FIG. 11, test pattern generation unit 29 is a random pattern generation unit (a pseudo-random pattern generation unit). This is because the to-be-tested logic circuit 18 generally operates randomly. According to the first embodiment, a linear feedback shift register (LFSR), for example, is used as a random pattern generation unit. The LFSR illustrated in FIG. 11 is a 5-bit LFSR; however, an LFSR with any number of bits can be used alternatively. The LFSR includes five registers 37a to 37e, which are connected to each other in series, and an exclusive logic circuit 47, which is connected to the output terminal of the last stage of the register 37e and the output terminals (feedback points) of the registers 37a [symbol] 37c of the register 37a to 37e. A clock signal CLK is supplied to the clock terminals of the registers 37a to 37e. The registers 37a to 37e carries out a shift operation in synchronization with the clock signal CLK. The exclusive logic circuit 47 calculates the output of specific registers (a feedback point) 37a, 37c and the output of the last stage of the register 37e, and then supplies the resulting values to the input terminal of the first register 37a.

To use the LFSR as the test pattern generation unit 29, initialization is necessary. With the initialization, all of the bits of the registers 37a to 37e are set to an appropriate value other than zeros in all of the bits. The initialization is either to set the registers 37a to 37e to the initial value stored in the integrated circuit 21 or to set the registers 37a to 37e to the initial value stored in the tester 25. When supplying the clock signal CLK to the registers 37a to 37e in the initialized LFSR, the values of the registers 37a to 37e are subjected to calculation by the exclusive logic circuit 47 and are then shifted. As a result, the values of the registers 37a to 37e randomly change. The randomly changing values of the registers 37a to 37e are supplied as test patterns T1 to Tp to the scan chains 17a to 17n of the to-be-tested logic 18.

On the other hand, the test results Dpa to Dpn for the scan chains 17a to 17n are compressed by the data compression units 28a to 28n, respectively. According to the first embodiment, a circuit shown in FIG. 12 is used as an example for the data compression units 28a to 28n.

As shown in FIG. 12, the data compression unit 28a includes five registers 313a to 313e, an exclusive logic circuit 213a, and a parallel to serial converter 55. The data compression unit 28a illustrated in FIG. 12 is a 5-bit data generater; however, the data compression unit 28a with any number of bits can be used alternatively. These five registers 313a to 313e are connected to each other in series. The outputs of the registers 313a, 313c, and 313e are coupled to the input terminal of the exclusive logic circuit 213a. Moreover, the test result Dpa from the scan chain 17a in the to-be-tested logic 18 is supplied to the input terminal of the exclusive logic circuit 213a. The output of the exclusive logic circuit 213a is coupled to the input terminal of the first register 313a.

The clock signal CLK is supplied to the clock terminals of the registers 313a to 313e, and the registers 313a to 313e carry out a shift operation in synchronization with the clock signal CLK. The values of the registers 313a to 313d are supplied to input terminals of the registers 313b to 313e, respectively. The resulting value calculated by the exclusive logic circuit 213a is supplied to the input terminal of the first register 313a. The test result Dpa from the scan chain 17a in the to-be-tested block 18 is provided to the exclusive logic circuit 213a.

The clock signal CLK is supplied to the registers 313a to 313e, and the data compression unit 28a takes in and compresses the test result Dpa from the scan chain 17a in the to-be-tested block 18. The data ultimately left in the registers 313a to 313e becomes the test result DCpa. The data ultimately left in the registers 313a to 313e is input to the parallel to serial converter 55 in parallel, and then serially output, finally generating the test result DCpa. The expected value DRpa for the test result DCpa is calculated in advance, and then stored in the tester storage unit 36.

With the self-test in failure scan chain determination mode as shown in FIG. 10, it is not necessary to prepare the test patterns T1 to Tp in the tester storage unit 36 of the tester 25 deployed outside of the integrated circuit 21. Thus the cost of the tester 25 can be reduced, and, all operations can be carried out within the integrated circuit 21 in synchronization with a clock signal. Therefore, usage of a high frequency clock signal allows a higher speed self-test than the test operation frequency by the tester 25. This allows implementation of a self-test on a real time operation basis. Since only a small number of external input/output signals for test In1 is required for the self-test, multiple to-be-tested logics 18 can be tested in parallel. This allows drastic reduction in the total testing time. Moreover, since the self-test cannot be influenced by the number of scanning inputs and outputs with the tester 25, configuration of a greater number of scan chains 17a to 17n than that for general scanning designs may be possible. The greater the number of scan chains 17a to 17n, the shorter the length of each scan chain, and the number of registers per scan chain becomes smaller. Thus, the testing time can be reduced.

As described above, since the data compression units 28a to 28n are connected to the respective output terminals of the scan chains 17a to 17n, the expected signatures DRpa to DRpn can be provided for each of the scan chains 17a to 17n. Therefore, only comparing the scan chains 17a to 17n with the corresponding expected signatures DRpa to DRpn allows identification of a failure-influenced scan chain of the scan chains 17a to 17n. Therefore, it is easy to identify a failure-influenced scan chain of the scan chains 17a to 17n. Comparison of the expected signatures DRpa to DRpn may be carried out by the scan chain expected value comparison circuit 6 prepared in the integrated circuit 21, or within the tester 25. In any case, the memory of the tester 25 may be merely stored with the expected signatures DRpa to DRpn for each of the scan chains l7a to 17n. In other words, since the tester storage unit 36 of the tester 25 requires only the expected signatures DRpa to DRpn, the cost of the tester storage unit 36 of the tester 25 is reduced. Since the test patterns T1 to Tp to be used in failure scanning determination mode are the same patterns to be used in failure pattern determination mode, a problem with recurring failures is eliminated. Moreover, the integrated circuit 21 can be tested for actual speed tests. Since the test pattern generation unit 29 of the integrated circuit 21 and that of the integrated circuit 11 of the comparative example shown in FIGS. 1 through 3 are the same, and the shift counter 23 and the pattern counter 24 are also the same, substantially no area penalty occurs. The integrated circuit 21 in failure scan chain determination mode shown in FIG. 10 employs the failure pattern determination circuit 5, identifying not only a failure scan chain but also a failure pattern. In this way, the integrated circuit 21 outputs an identification signal for a failure scan chain, including a flip-flop, that has been influenced by a failure, through a self-test. This allows easy analysis of failures.

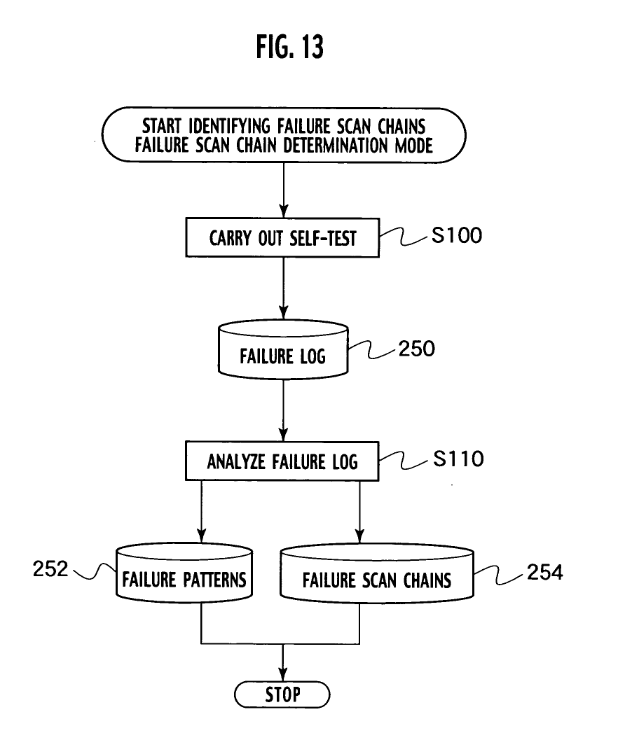

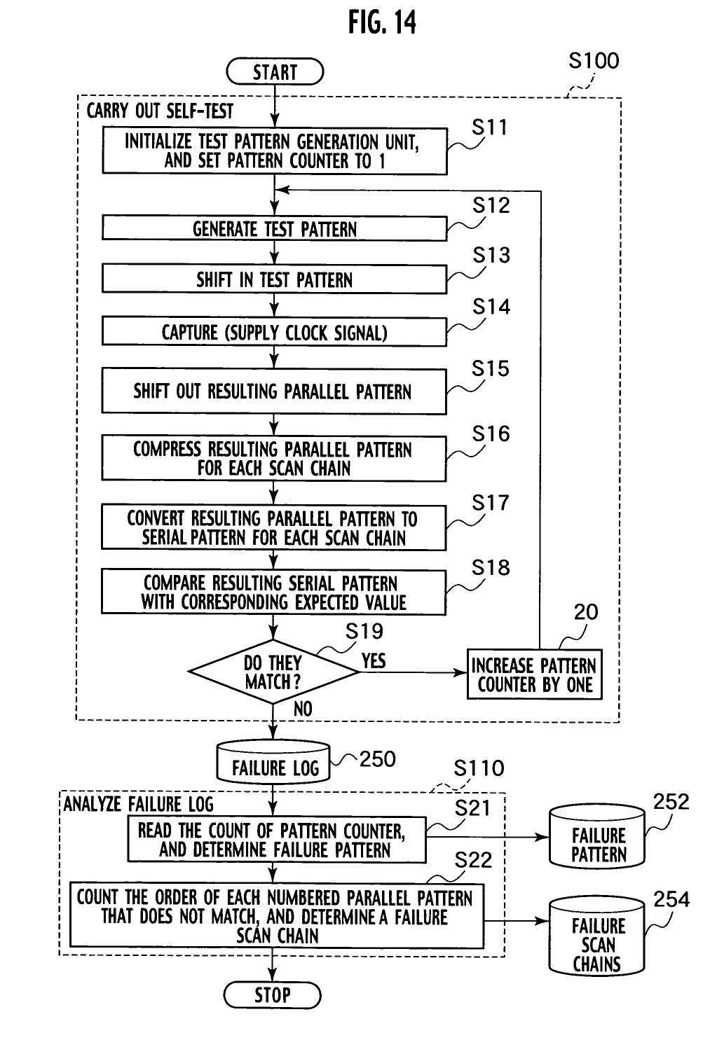

According to a method of identifying a failure scan chain of the integrated circuit 21 that has been influenced by a failure, in the failure scan chain determination mode shown in FIG. 10, a self-test as shown in FIGS. 13 and 14 is carried out in step S100. More specifically, in step S11, the control circuit 22a initializes the test pattern generation unit 29. The control circuit 22a sets the pattern counter 24 to 1. In step S12, the test pattern generation unit 29 generates a test pattern T1. In step S13, based on the shift counter 23, the scan chains 17a to 17n shift in the scanning test patterns T1a to T1n of the test pattern T1. In step S14, the scan chains 17a to 17n output the scanning test patterns T1a to T1n to the to-be-tested logic 18. The scan chains 17a to 17n receive the test results D1a to D1n from the to-be-tested logic 18. The scan chains 17a to 17n capture the test results D1a to D1n in synchronization with the clock signal. In step S15, the scan chains 17a to 17n shift out the respective test results D1a to D1n, which are the resulting parallel patterns, to the data compression units 28a to 28n. In step S16, the data compression units 28a to 28n compress the test results D1a to D1n for each of the scan chains 17a to 17n. In other words, the data compression units 28a to 28n generate compressed test result signatures DC1a to DC1n, which result from compressing the test results D1a to D1n. In step S17, the parallel to serial converter 54 receives the compressed test result signatures DC1a to DC1n in parallel, and then serially outputs them. The parallel to serial converter 54 outputs a compressed test result signature DC1 (DC1a to DC1n), which is the resulting serial pattern. In step S18, the scan chain expected value comparison circuit 6 compares the compressed test result signature DC1 (DC1a to DC1n) with the compressed test result signature expected value DR1 (DR1a to DR1n) thereof stored in the tester storage unit 36. In step S19, if the compressed test result signature DC1 (DC1a to DC1n) is equal to the expected value DR1 (DR1a to DR1n), this means that no failure is detected, and this process proceeds to step S20. Otherwise, if the compressed test result signature DC1 (DC1a to DC1n) and the expected value DR1 (DR1a to DR1n) are not equal to each other, this means that a failure is detected, and a failure log 250 is generated as the result from the comparison in step S18.

In step S20, the control circuit 22a increases the pattern counter 24 by one. As a result, the pattern counter 24 is stored with a value of two. This process proceeds to step S12 in which the test pattern generation unit 29 then generates a test pattern T2. In this manner, as long as a failure is not detected, the control circuit 22a repeatedly tests by using different test patterns T1 to Tp. Consequently, as the result of the self-test, a failure log 250 is obtained.

Instep S110, the failure log 250 is analyzed. As a result, information of a failure pattern 217 and a failure scan chain 254 is obtained. In step S21, the failure pattern determination circuit 5 reads the count of the pattern counter 24. The failure pattern determination circuit 5 outputs the count of the pattern counter 24 as an identification signal of the failure pattern (as the failure log) to the tester 25. The failure pattern 217 is determined based on the count. In step S22, the failure scan chain determination circuit 7 counts the order of one of the resulting parallel patterns DC1a to DC1n that does not match the corresponding expected value, in the order of the resulting parallel patterns DC1a to DC1n of the resulting serial pattern DC1 (DC1a to DC1n) for the compressed test result signature. The failure scan chain determination circuit 7 outputs to the tester 25 the resulting count for that order as an identification number of the failure scan chain (as the failure log). This process allows identification of one of the resulting parallel patterns (DC1a to DC1n) that does not match the corresponding expected value, and identification of the failure scan chain 254.

As described above, according to the integrated circuit 21 of the first embodiment, a failure scan chain having a detected failure can be easily identified.

(A First Modified Example of the First Embodiment)

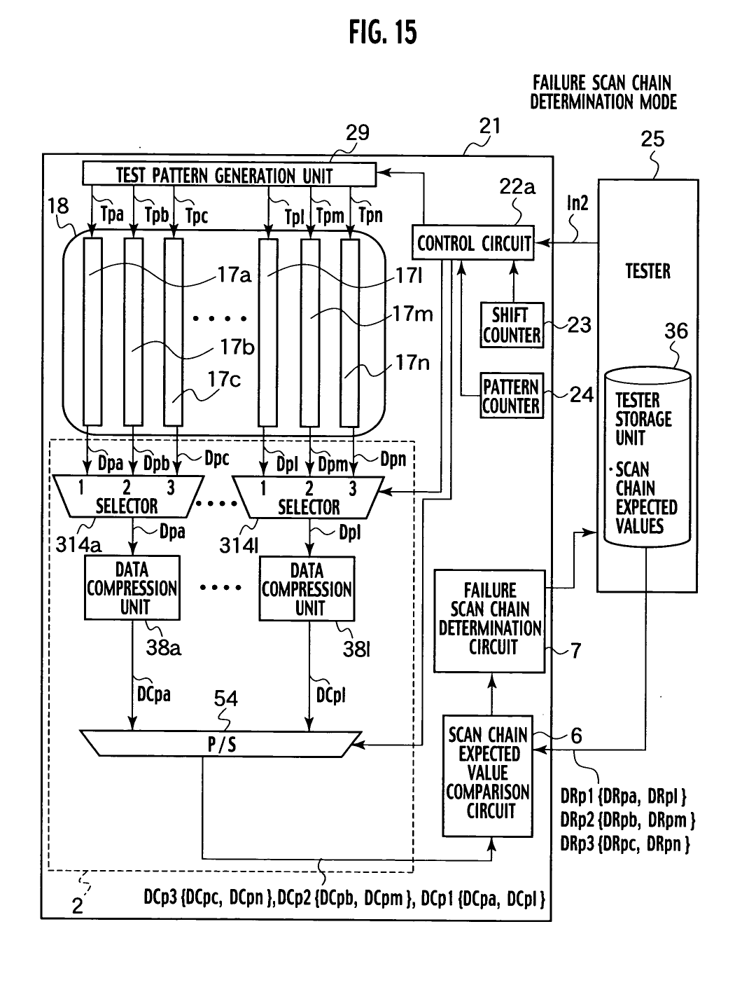

As shown in FIG. 15, an integrated circuit 31 in failure scan chain determination mode, according to the first modified example of the first embodiment of the present invention, has a structure of a scan chain compression unit 2 different from that of the integrated circuit 21 of the first embodiment shown in FIG. 10. The scan chain compression unit 2, according to the first modified example of the first embodiment, is capable of selecting each of the scan chains 17a to 17n.

The scan chain compression unit 2 includes selectors 314a to 314l, data compression units 38a to 381, and a parallel to serial converter 54. The selectors 314a to 314l are connected to the respective output terminals of the scan chains 17a to 17n. It is assumed here that a failure pattern is a test pattern Tp. The selectors 314a to 314l receive the test results Dpa to Dpn for scanning test patterns Tpa to Tpn of the test pattern Tp. The selectors 314a to 314l select and output each of the test results Dpa to Dpn in order. The selectors 314a to 314i select and output the test results Dpa and Dpl in a certain order. That order can allow identification of each of the scan chains 17a to 17n. The data compression units 38a to 381 are connected to the respective output terminals of the selectors 314a to 314l. The data compression units 38a to 381 receive the selected test results such as Dpa and Dpl, and outputs them. The number of the selectors 314a to 314l and that of the data compression units 38a to 381 are smaller than the number of the test results Dpa to Dpn, respectively. The parallel to serial converter 54 is connected to the output terminals of the data compression units 38a to 381. The parallel to serial converter 54 receives the compressed test result signatures DCpa and DCpl in parallel, and serially outputs them in order. This order can allow identification of each of the scan chains 17a to 17n.

Multiple scan chains 17a to 17c share usage of the data compression unit 38a. The number of those shared scan chains is not limited to three. A control circuit 22b is connected to the selectors 314a to 314l.

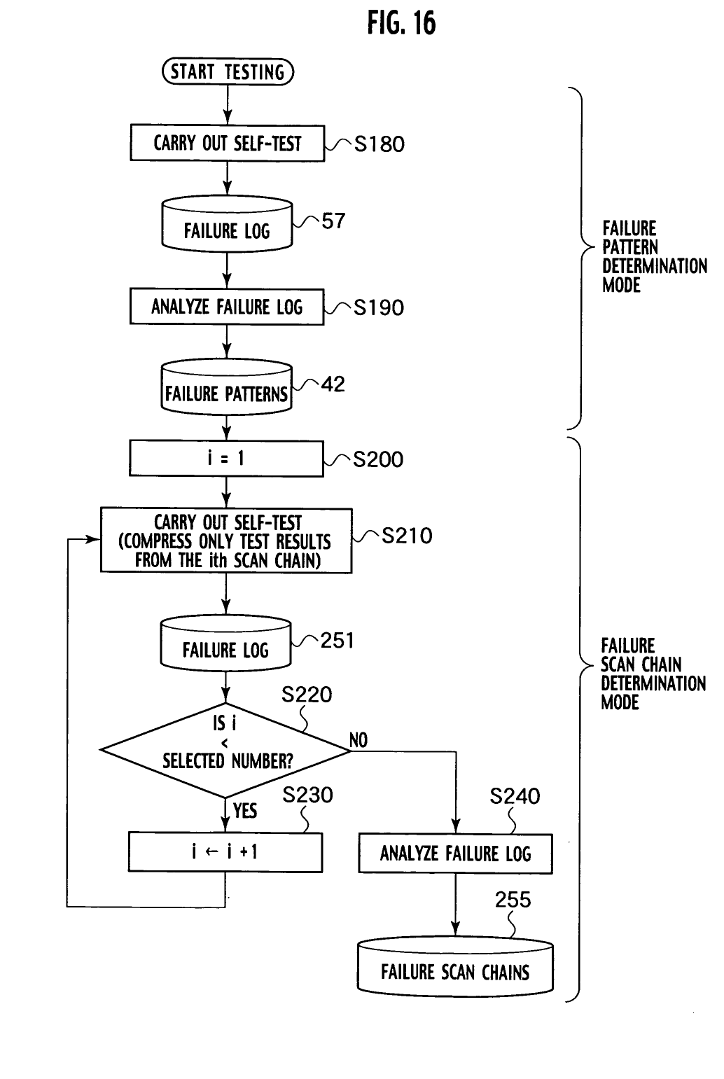

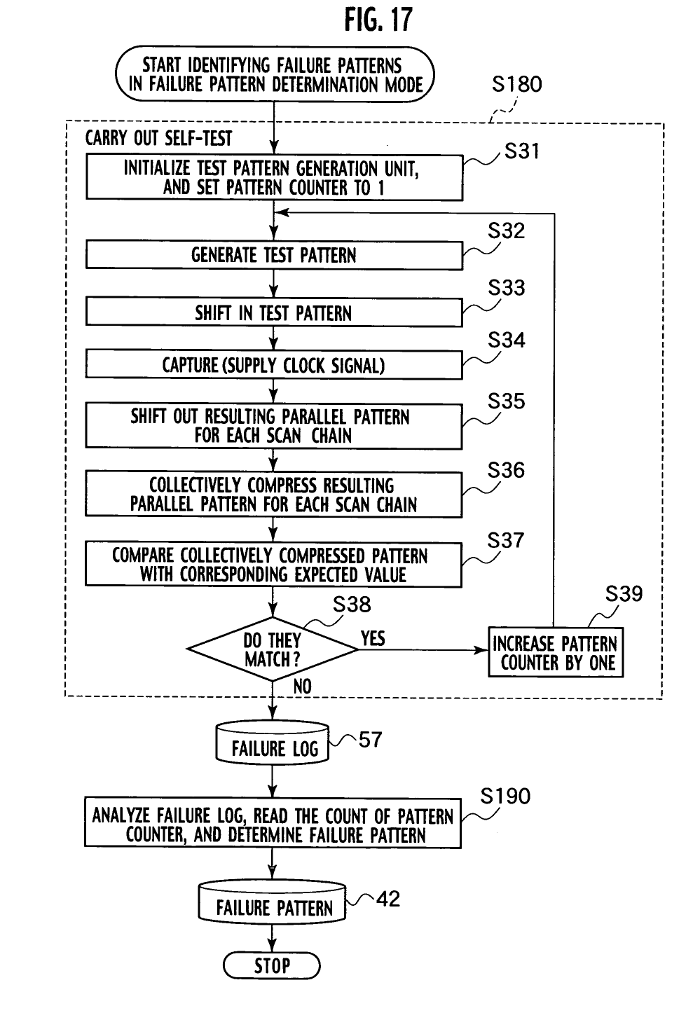

A failure analysis method using the integrated circuit 31 in FIG. 15 is explained next. This is explained along with the failure pattern determination mode shown in FIG. 4. As shown in FIGS. 16 to 18, to begin with, a self-test is carried out in step S180. More specifically, the control circuit 22b initializes the test pattern generation unit 29 in step S31. The control circuit 22b sets the pattern counter 24 to 1. In step S32, the test pattern generation unit 29 generates a test pattern T1. In step S33, the scan chains 17a to 17n shift in the shift resister test patterns T1a to T1n of the test pattern T1 in conformity with the shift counter 23. In step S34, the scan chains 17a to 17n output the shift resister test patterns Tla to T1n to the to-be-tested logic 18 in synchronization with a clock signal. The to-be-tested logic 18 generates the test results D1a to D1n. The scan chains 17a to 17n receive the test results D1a to D1n from the to-be-tested logic 18. In step S35, the scan chains 17a to 17n shift out the test results D1a to Dln, which are the resulting parallel pattern, to the collective compression unit 16. In step S36, the collective compression unit 16 collectively compresses the test results D1a to D1n. The collective compression unit 16 generates the compressed test result signature DC10. The compressed test result signature DC10 cannot be classified according to pieces of data relevant to the test results D1a to D1n.

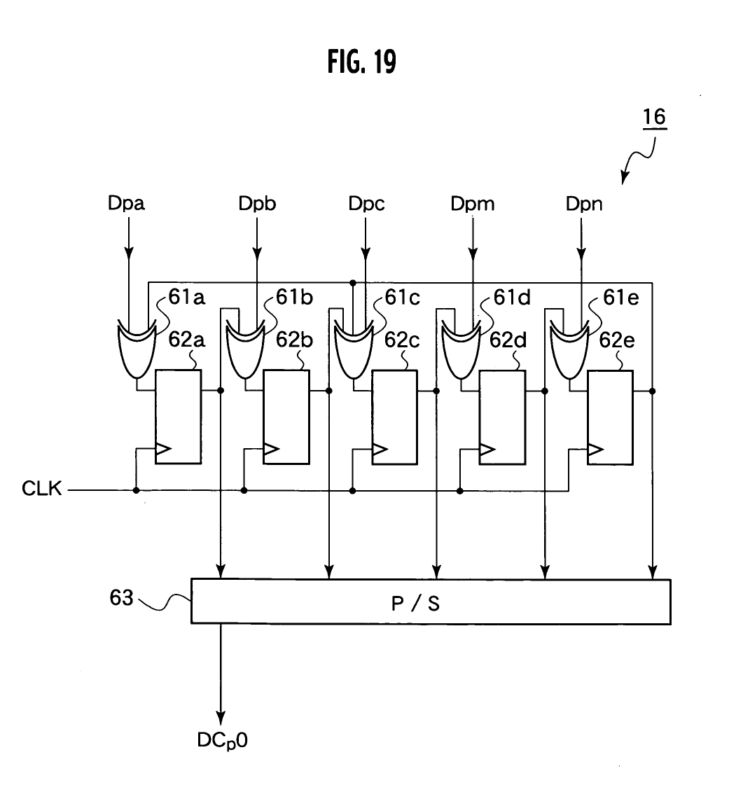

FIG. 19 shows an exemplary circuit of the collective compression unit 16. The collective compression unit 16 includes five registers 62a to 62e, five exclusive logic circuits 61a to 61e, and a parallel to serial converter 63. Those five exclusive logic circuits 61a to 61e are connected to the five registers 62a to 62e, respectively. The outputs of the exclusive logic circuits 61a to 61e are coupled to the input terminals of the registers 62a to 62e. The outputs of the registers 62a to 62e are coupled to the input terminals of the exclusive logic circuit 61b to 61e and 61a, respectively. The output of the register 62e is coupled to the input terminals of the exclusive logic circuits 61a and 61c. The test results D1a to D1n are input to the exclusive logic circuits 61a to 61e. The outputs of the registers 62a to 62e are coupled to the parallel to serial converter 63. After the test results D1a to D1n have been input, the data of the compressed test result signature DC10 are stored in the registers 62a to 62e, respectively. The parallel to serial converter 63 receives the data of the compressed test result signature DC10 in parallel, and then outputs the data in a certain order.

In step S37, the expected pattern value comparison circuit 4 compares the compressed test result signature DC10 with the corresponding expected value DR10 stored in the tester storage unit 36. In step S38, if it is determined that the compressed test result signature DC10 matches the corresponding expected value DR10, this means that a failure is not detected, and this process proceeds to step S39. Otherwise, if the compressed test result signature DC10 and the corresponding expected value DR10 do not match, this means that a failure has been detected, and a failure log 57 is generated as a result of the comparison in step S37.

In step S39, the control circuit 22b increases the pattern counter 24 by one. As a result, the pattern counter 24 is stored with a value of two. This process proceeds to step S32 in which the test pattern generation unit 29 generates a test pattern T2. In this way, as long as a failure is not detected, different test patterns T1 to Tp are repeatedly generated. Consequently, the failure log 57 is obtained as a result of that self-test.

In step S190, the failure log 57 is analyzed. As a result, failure pattern 42 information is obtained. The failure pattern determination circuit 5 reads the count of the pattern counter 24. The failure pattern determination circuit 5 outputs the count of the pattern counter 24 as an identification number of the failure pattern (as the failure log) to the tester 25. A failure pattern 42 is determined based on the count.

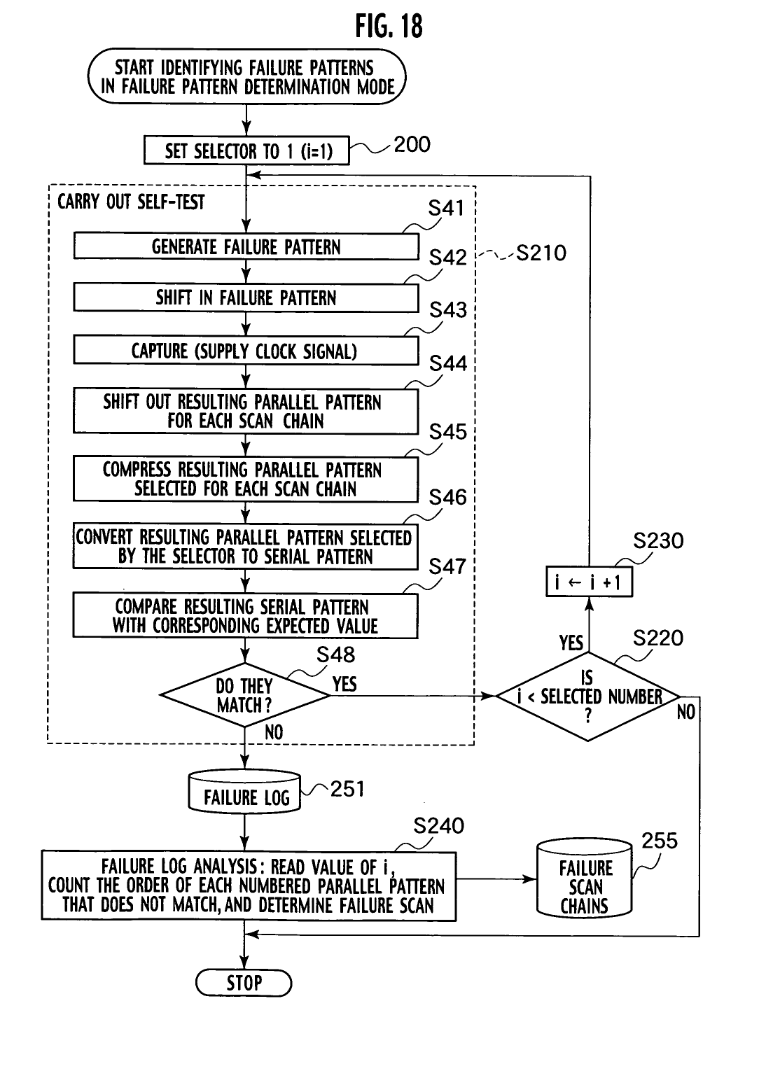

Next, in step S200, the control circuit 22b sets identification data i for each of the input terminals of the selectors 314a to 314l to the value of 1. The control circuit 22b selects input terminals 1 of the selectors 314a to 314l. In step S210, a self-test is carried out. More specifically, in step S41 shown in FIG. 18, the control circuit 22a makes the test pattern generation unit 29 generate a test pattern Tp, which is the failure pattern 42. In step S42, the scan chains 17a to 17n shift in the shift resister test patterns Tpa to Tpn of the test pattern Tp in conformity with the shift counter 23. In step S43, the scan chains 17a to 17n output the shift resister test patterns Tpa to Tpn to the to-be-tested logic 18 in synchronization with a clock signal. The to-be-tested logic 18 generate the test results Dpa to Dpn. The scan chains 17a to 17n capture the test results Dpa to Dpn from the to-be-tested logic 18. In step S44, the scan chains 17a to 17n shift out the test results Dpa to Dpn, which are the resulting parallel pattern, to the data compression units 28a to 28n. In step S45, the selectors 314a to 314l select and output the test results Dpa and Dpl, which are then input to the input terminals 1. The data compression unit 38a compresses the test result Dpa, generating the compressed test result signature DCpa. The data compression unit 381 compresses the test result Dpl, generating the compressed test result signature DCpl. In step S46, the parallel to serial converter 54 receives the compressed test result signatures DCpa to DCpl in parallel, and serially outputs the compressed test result signatures DCpa to DCpl. The parallel to serial converter 54 outputs the compressed test result signature DCp1 (DCpa and DCpl), which is the resulting serial pattern. In step S47, the scan chain expected value comparison circuit 6 compares the compressed test result signature DCp1 (DCpa and DCpl) with the corresponding expected value DRp1 (DRpa and DRpl) stored in the tester storage unit 36. In step S48, if it is determined that the compressed test result signature DCp1 (DCpa and DCpl) matches the corresponding expected value DRp1 (DRpa and DRpl), this means that a failure is not detected, and this process proceeds to step S220. Otherwise, if the compressed test result signature DCp1 (DCpa and DCpl) and the corresponding expected value DRp1 (DRpa and DRpl) do not match, this means that a failure is detected, and a failure log 251 is generated as the result the comparison in the step S47.

In step S220, it is determined whether all of the input terminals 1 to 3 of the selectors 314a to 314l have been selected. If all of the input terminals 1 to 3 have been selected, this loop process is over. Otherwise, if input terminals remain to be selected, this process proceeds to step S230. In step S230, the control circuit 22b increases the identification data i at the input terminals of the selectors 314a to 314i by one. The control circuit 22b stores the identification data i. The control circuit 22b selects input terminals 2 of the selectors 314a to 314i. Steps S41 to S48 are then executed, and the compressed test result signature DCp2 (DCpb and DCpm) is compared with the corresponding expected value DRp2 (DRpb [symbol] DRpm). Similarly, the compressed test result signature DCp3 (DCpc and DCpn) is compared with the corresponding expected value DRp3 (DRpc [symbol] DRpn). The test pattern generation unit 29 generates a test pattern T2. Consequently, the failure log 251 is obtained as a result of that self-test.

In step S240, the failure log 251 is analyzed. As a result, information of a failure scan chain 255 is obtained. The failure scan chain determination circuit 7 counts the order of one of the numbered parallel pattern DCpa, DCpl that does not match the corresponding expected value in order of those parallel patterns DCpa and DCpl of the serial result pattern DCpl for the compressed test result signature. The failure scan chain determination circuit 7 outputs the counted order to the tester 25 as an identification signal for the failure scan chain. The control circuit 22b outputs the identification data i for the input terminals of the selectors 314a to 314l to the tester 25. This allows identification of one of the resulting parallel patterns DCpa to DCpn that does not match the corresponding expected value. And the failure scan chain 255 can be identified.

By carrying out such a sequential operation, a scan chain having a propagated failure can be found even if multiple scan chains 17a to 17c share a single data compression unit 38a. In other words, even in the case of sharing the data compression unit 38a, the expected signatures DCpa to DCpn are prepared for each of the scan chains 17a to 17c. Compared to the integrated circuit 21 in FIG. 10, the integrated circuit 31 in FIG. 15 can reduce area penalties of the integrated circuit 31. Note that compared to the integrated circuit 21 in FIG. 10, the integrated circuit 31 in FIG. 15 requires a sufficient failure analysis time, which is three times the number of the sharing scan chains in the case of the first modified example of the first embodiment. The number of the selected scan chains 17a and 171 is equal to that of the selectors 314a and 314l, and also to that of the data compression units 38a and 381. That failure analysis time is a trade-off for the area penalties.

As described above, it is easy to identify a failure-detected failure scan chain according to the integrated circuit 31 of the first modified example of the first embodiment.

(Second Modified Example of the First Embodiment)

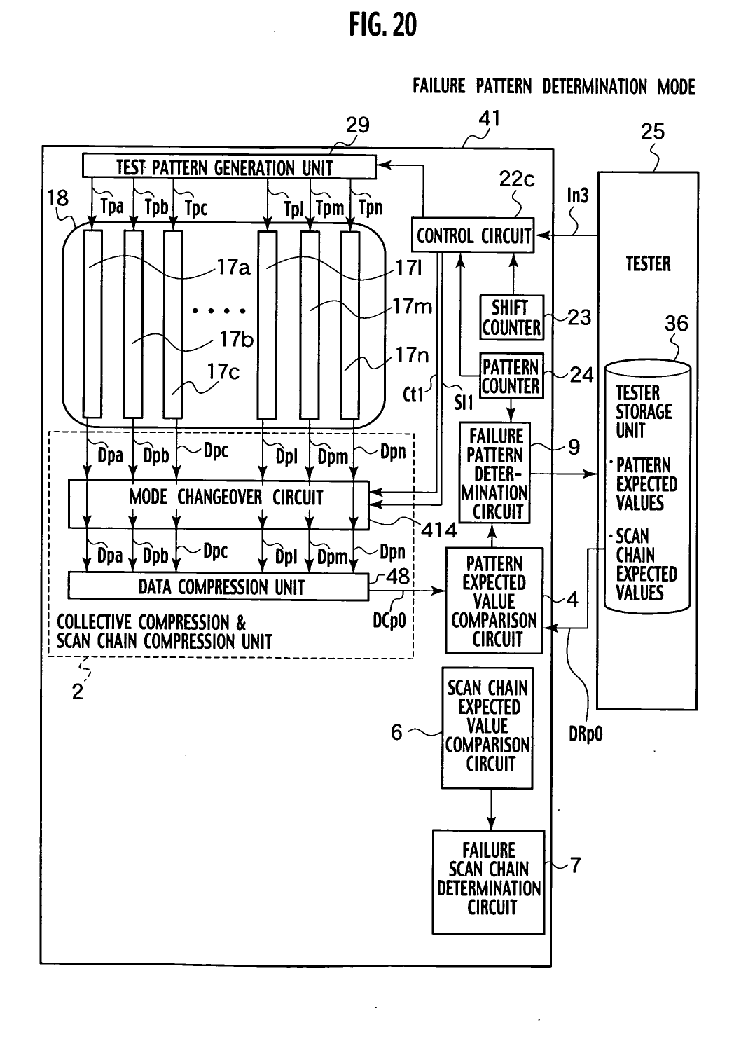

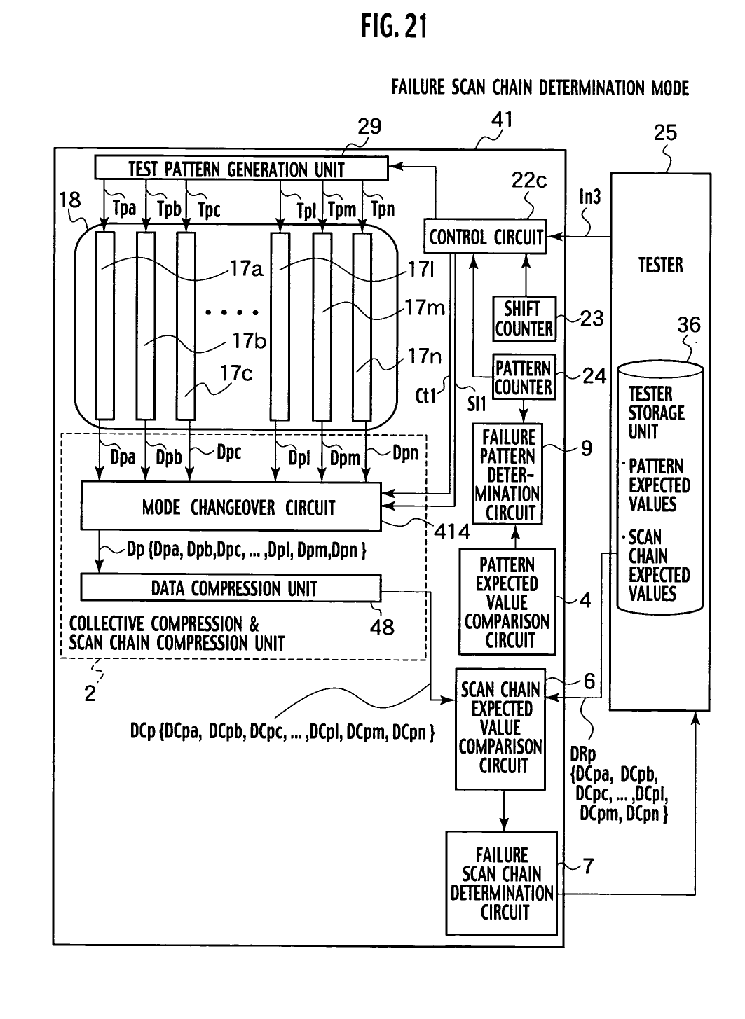

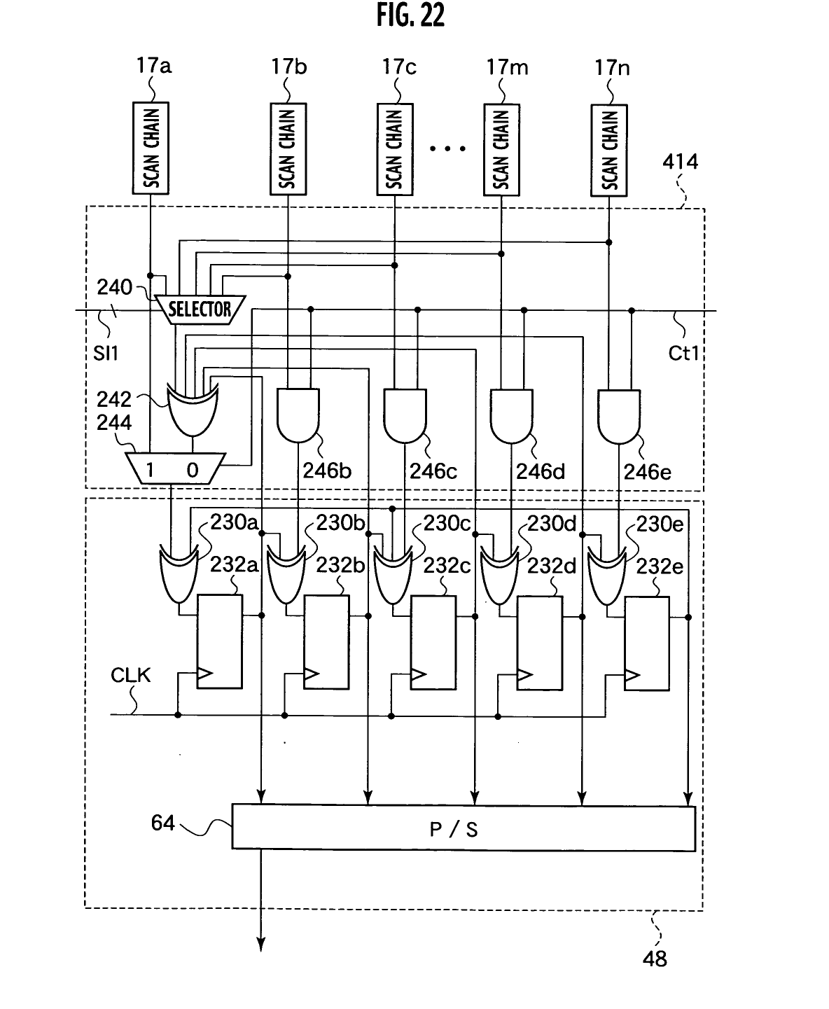

As shown in FIGS. 20 and 21, in an integrated circuit 41 in failure pattern determination mode and failure scan chain determination mode according to a second modified example of the first embodiment of the present invention, the collective compression unit 16 is omitted and the structure of the scan chain compression unit 2 is different compared to the integrated circuit 21 of the first embodiment shown in FIGS. 4, 5, and 10. Even the scan chain compression unit 2, according to the second modified example of the first embodiment, is capable of identifying a failure pattern and a failure scan chain. The scan chain compression unit 2 in failure pattern determination mode, according to the second modified example of the first embodiment, functions as the collective compression unit 16 of the first embodiment, and in failure scan chain determination mode, it functions as the scan chain compression unit 2 of the first embodiment. The scan chain compression unit 2 includes a mode changeover circuit 414 and a data compression unit 48.

The mode changeover circuit 414 is connected to the output stage of the scan chains 17a to 17n. The mode changeover circuit 414 in failure pattern determination mode receives the test results Dpa to Dpn in parallel, and outputs them as they are in parallel. In failure scanning determination mode, the mode changeover circuit 414 receives in parallel the test results Dpa to Dpn, which are the resulting parallel pattern for the failure pattern Tp, and then serially outputs the test result Dp (Dpa to Dpn), which is the resulting serial pattern, to the scan chains 17a to 17n in a certain order that allows one-to-one mapping.

The data compression unit 48 is connected to the mode changeover circuit 414. The data compression unit 48 in failure pattern determination mode receives the test results Dpa to Dpn in parallel, collectively compresses the test results Dpa to Dpn so as to generate a single test result compressed pattern DCpO. In failure scanning determination mode, the data compression unit 48 compresses each element pattern of the test result Dp (Dpa to Dpn) in order, generating the compressed test result signature DCp (DCpa to DCpn).

According to the second modified example of the first embodiment, the mode changeover circuit 414 is connected between the data compression unit 48 and the scan chains 17a to 17n. The mode changeover circuit 414 is capable of changing over the connection between the data compression unit 48 and the scan chains 17a to 17n. More specifically, the mode changeover circuit 414 in failure scan chain determination mode is capable of selecting each of the scan chains 17a to 17n, and then connecting the data compression unit 48 to the selected one of the scan chains 17a to 17n. More specifically, the mode changeover circuit 414 in failure pattern determination mode is capable of selecting all of the scan chains 17a to 17n at the same time, and then connecting the data compression unit 48 to all of the scan chains 17a to 17n. In other words, the scan chain compression unit 2 is structured such that the data compression unit 48 is shared by all of the scan chains 17a to 17n.

In failure pattern determination mode, the mode changeover circuit 414 is capable of connecting the data compression unit 48 to the scan chains 17a to 17n, or doing so after carrying out space compression. In the case of determining a failure in the integrated circuit 41 as a result of a test in failure pattern determination mode, a failure analysis is made in failure scan chain determination mode. The control circuit 22c in the to-be-analyzed integrated circuit 41 receives a control signal In3 from the tester 25, and changes over the integrated circuit 41 from being in failure pattern determination mode shown in FIG. 20 to failure scan chain determination mode shown in FIG. 21. Once changed to failure scan chain determination mode, the control circuit 22c sends designation signals S11 and Ct1 to the mode changeover circuit 414. The mode changeover circuit 414, which has received the instruction signals S11 and Ct1 from the control circuit 22c, selects and connects the data compression unit 48 and the scan chains 17a to 17n in conformity with those instructions. As a result, the configurations of the mode changeover circuit 414 and the data compression unit 48 are the same as those of the selectors 314a and 314l and the data compression units 38a and 381 shown in FIG. 15. Therefore, identifying a failure scan chain is possible using a similar method to the failure analysis method shown in the flowchart of FIG. 16.

As shown in FIG. 22, the mode changeover circuit 414 includes a selector 240, which is connected to the scan chains 17a to 17n, an exclusive logic circuit 242, logical multiplication circuits 246b to 246e, and a selector 244, which is connected to the scan chain 17a and the exclusive logic circuit 242. The outputs of the scan chains 17a to 17n are coupled to the input terminal of the selector 240. The outputs of the scan chains 17a to 17n are coupled to the input terminals of the logic multiplication circuits 246b to 246e, respectively. The output of the selector 240 is coupled to the input terminal of the exclusive logic circuit 242. The outputs of the exclusive logic circuit 242 and the scan chain 17a are coupled to the input terminal of the selector 244. The operation of the selector 244 is controlled in conformity with the mode control signal Ct1. The mode control signal Ct1 is sent to the input terminals of the logical multiplication circuits 246b to 246e.

The data compression unit 48 includes five registers 232a to 232e, five exclusive logic circuits 230a to 230e, and a parallel to serial converter 64. The output of the exclusive logic circuit 230a is coupled to the input terminal of the register 232a. The output of the register 232a is coupled to one of the input terminals of the exclusive logic circuit 230b. In the same way, the exclusive logic circuits 230b to 230e are connected to the registers 232b to 232e. The output of the last stage of the register 232a is coupled to one of the input terminals of the exclusive logic circuit 230a. The output of the selector 244 in the mode changeover circuit 414 is coupled to the other input terminal of the exclusive logic circuit 230a. The outputs of the logical multiplication circuits 246b to 246e in the mode changeover circuit 414 are coupled to the other input terminals of the exclusive logic circuits 230b to 230e, respectively. The output of the last stage of the register 232e is also coupled to one of the input terminals of the exclusive logic circuit 230c. The outputs of the registers 232a to 232d are coupled to the input terminals of the exclusive logic circuit 242 in the mode changeover circuit 414, respectively. The outputs of the register 232a to 232d are coupled to the input terminals of the parallel to serial converter 64.

The selector 240 selects one of the scan chains 17a to 17n in conformity with the scan chain selection signal S11. The selector 240 connects the selected one of the scan chains 17a to 17n to one of the input terminals of the exclusive logic circuit 242. The selector 244 selects either the output of the scan chain 17a or output of the exclusive logic circuit 242 in conformity with the mode control signal Ct1.

The selector 244 in failure pattern determination mode when the mode control signal Ct1 is 1 couples the output of the scan chain 17a to the input terminal of the exclusive logic circuit 230a. The input terminals of the exclusive logic circuits 230a to 230e are connected to the output terminals of the scan chains 17a to 17n, respectively. The data compression unit 48 has the same MISR as the collective compression unit 16 in FIG. 19. Therefore, the data compression unit 48 takes in the test result from the scan chains 17a to 17n in parallel, and compresses the data of the test results Dpa to Dpn. Consequently, the output data ultimately remaining in the registers 232a to 232e is converted to the compressed test result signature DCpO by the parallel to serial converter 64. The scan chain selection signal S11 in failure pattern determination mode does not adversely influence the circuit operation.

In failure scan chain determination mode when the mode control signal Ct1 is zero, the selector 244 couples the output of the exclusive-OR logic circuit 242 with the input terminal of the exclusive-OR logic circuit 230a. The input terminals of the exclusive-OR logic circuits 230a to 230e are not connected to the output terminals of the scan chains 17a to 17n. The output of the exclusive-OR 242, which receives the outputs of the registers 232a to 232d, is input to the exclusive-OR logic circuit 230a. The output of the register 232e is also input to the exclusive-OR logic circuit 230a. In other words, the data compression unit 48 has the same LFSR as that of the data compression unit 28a in FIG. 12. Therefore, the exclusive-OR logic circuit 230a takes in an exclusive-OR 242 of the data from the scan chains 17a to 17n selected by the selector 240 and data output from each of the registers 232a to 232d. It should be noted that each of the scan chains 17a to 17n, which take in the data of the test results Dpa to Dpn, is selected in conformity with the scan chain selection signal S11 by the selector 240 in a certain order. This order allows identification of each of the scan chains 17a to 17n. The numbering in that order corresponds to the scan chains 17a to 17n on a one-to-one mapping basis.

It should be noted that FIG. 22 shows an example of a case where there is no space compactor for simplicity of explanation; however, even with a space compactor, the basic operation is the same. In the failure scan chain determination mode, space compactor is in a through mode.

In this way, the mode changeover circuit 414 is capable of changing over the data compression unit 48 between failure pattern determination mode and failure scan chain determination mode. This allows multiple scan chains 17a to 17n to share the single data compression unit 48. Thus, a failure-propagated failure scan chain can be easily detected. In other words, in the case of sharing the data compression unit 48, the expected signatures DCpa to DCpn are prepared for each of the scan chains 17a to 17n. Compared to the integrated circuit 21 in FIG. 10 in which the data compression units 28a to 28n are connected to the respective scan chains 17a to 17n, the integrated circuit 41 can reduce the area penalties.

As described above, according to the integrated circuit 41 of the second modified example of the first embodiment, a failure-detected failure scan chain can be easily distinguished.

(Second Embodiment)

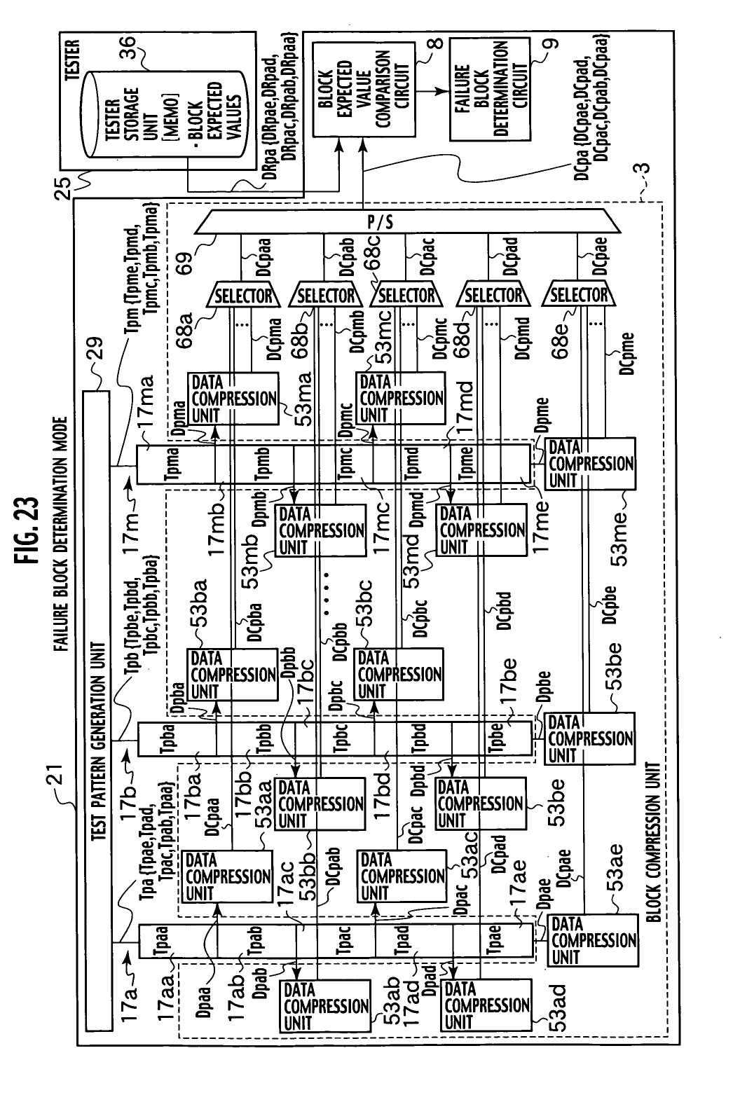

The integrated circuit 21, according to the second embodiment shown in FIG. 23, is considered to be a part of the integrated circuit 21 of the first embodiment. The outline of the integrated circuit 21 of the second embodiment can be considered to be the same as that of the integrated circuit 21 of the first embodiment shown in FIGS. 4 through 8. With the second embodiment, the structure of the integrated circuit 21 in failure block determination mode is described. Moreover, a failure block identification method is described in detail using the integrated circuit 21.

By comparison to the integrated circuit 21 in failure block determination mode shown in FIG. 6, of the integrated circuit 21 in failure block determination mode shown in FIG. 23, only a circuit functioning in failure block determination mode is described. The block compression unit 3 is also described in detail.

The test pattern generation unit 29 is initialized for a test pattern Tp, which is a failure pattern, again generating scanning test patterns Tpa to Tpm.

The scan chains 17a to 17m, which served as shift registers, shift in the scanning test patterns Tpa to Tpm. The scan chains 17a to 17m simultaneously output multiple scanning test patterns Tpa to Tpm to the logic circuit 18. The scan chains 17a to 17m capture multiple test results Dpa to Dpm from the logic circuit 18. The scan chains 17a to 17m are partitioned, generating multiple blocks 17aa to 17ae, 17ba to 17be, . . . , and 17ma to 17me. The last stages of the blocks 17aa to 17ae, 17ba to 17be, . . . , 17ma to 17me shift out the block test results Dpaa to Dpae, Dpba to Dpbe, . . . , Dpma to Dpme, which result from dividing the test results Dpa to Dpm.

The block compression unit 3 includes multiple data compression units 53aa to 53ae, 53ba to 53be, . . . , and 53ma to 53me, selectors 68a to 68e, and a parallel to serial converter 69.

The data compression units 53aa to 53ae, 53ba to 53be, . . . , and 53ma to 53me are connected to the respective output terminals of the last stages of the blocks 17aa to 17ae, 17ba to 17be, . . . , and 17ma to 17me. The data compression units 53aa to 53ae, 53ba to 53be, . . . , and 53ma to 53me receive the block test results Dpaa to Dpae, Dpba to Dpbe, . . . , and Dpma to Dpme. The data compression units 53aa to 53ae, 53ba to 53be, . . . , 53ma to 53me compress the block test results Dpaa to Dpae, Dpba to Dpbe, . . . , and Dpma to Dpme, generating the resulting block compressed test result signatures DCpaa to DCpae, DCpba to DCpbe, . . . , and DCpma to DCpme. The block test results Dpaa to Dpae, Dpba to Dpbe, . . . , and Dpma to Dpme correspond to the compressed block test results DCpaa to DCpae, DCpba to DCpbe, . . . , and DCpma to DCpme, respectively, and are of the same number.

The selectors 68a to 68e select, for example, the compressed block test results DCpaa to DCpae for the failure scan chains. The parallel to serial converter 69 outputs the selected compressed block test results DCpaa to DCpae to the blocks 17aa to 17ae in the failure scan chains 17a in a certain order that allows one-to-one mapping.

According to the second embodiment, each of the scan chains 17a to 17m is divided into five-component blocks: blocks 17aa to 17ae, 17ba to 17be, . . . , and 17ma to 17me. The groups of the data compression units: 53aa to 53ae, 53ba to 53be, . . . , and 53ma to 53me, each including five different units, are connected to them, respectively. The number of units included in each group is not limited to five as such, and an arbitrary multiple number can form a group. The number of divided blocks configuring a group is not limited to five, and may be one to four, or six or greater. It is desirable that the number of divided blocks configuring a group be equal or almost equal to the number of the scan chains. It should be noted that the data compression units 53ae to 53me, which are connected to the blocks 17ae to 17me of the last stages of each scan chains 17a to 17m, may employ the data compression units 28a to 28m in FIG. 10 as they are.

The tester 25 can identify a failure block to which failure-propagated failure flip-flops belong, by just preparing expected signatures DCpaa to DCpae, DCpba to DCpbe, . . . , and DCpma to DCpme for the blocks 17aa to 17ae, 17ba to 17be, . . . , and 17ma to 17me, respectively. Only data captured in the identified failure block is returned as test result data to the tester 25. In this way, even if the tester 25 has a small capacity of failure memory, a self-test can be executed and a failure log can be analyzed.

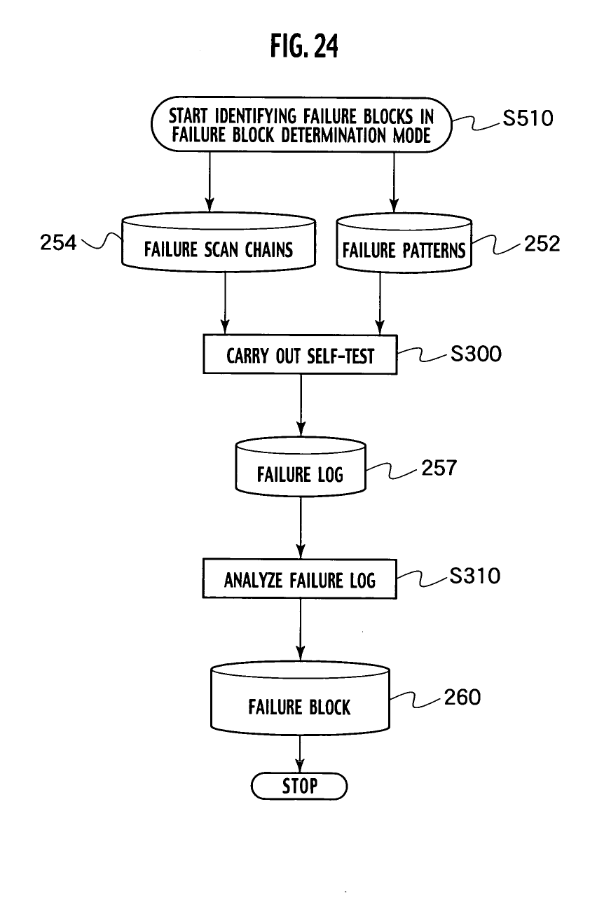

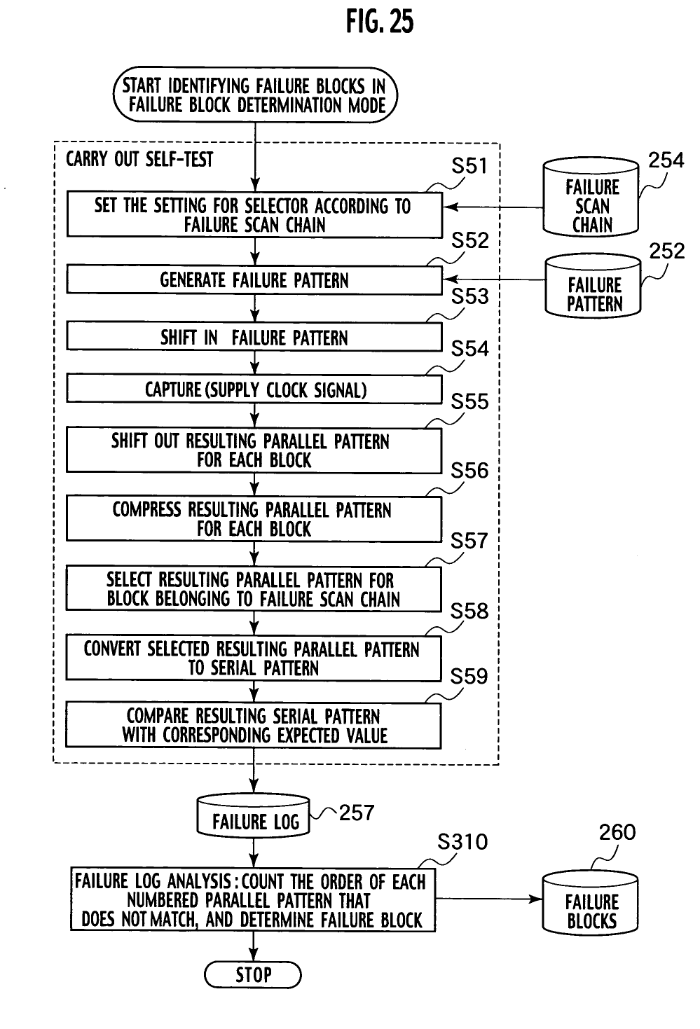

A method of identifying a failure block in failure scan chains using the integrated circuit 21 in FIG. 23 is described next. As shown in FIGS. 24 and 25, to begin with, in step S300, a self-test is executed based on the failure pattern 217 and information of the failure scan chain 254. More specifically, in step S51 of FIG. 25, the control circuit 22a sets the selectors 68a to 68e so that they output what has been input to the failure scan chain 17a. In step S52, the test pattern generation unit 29 generates a failure pattern Tp. In step S53, the scan chains 17a to 17m shift in the failure pattern Tp. In step S54, capturing is carried out. In step S55, the blocks 17aa to 17ae, 17ba to 17be, . . . , and 17ma to 17me shift out the block test results Dpaa to Dpae, Dpba to Dpbe, . . . , and Dpma to Dpme, which are the resulting parallel patterns. In step S56, the data compression units 53aa to 53ae, 53ba to 53be, . . . , and 53ma to 53me compress the block test results Dpaa to Dpae, Dpba to Dpbe, . . . , and Dpma to Dpme, generating the resulting compressed block test results DCpaa to DCpae, DCpba to DCpbe, . . . , and DCpma to DCpme. In step S57, the selectors 68a to 68e select, for example, the compressed block test results DCpaa to DCpae for the failure scan chains. In step S58, the parallel to serial converter 69 outputs the selected compressed block test results DCpaa to DCpae to the blocks 17aa to 17ae in the failure scan chain 17a in a certain order that allows one-to-one mapping. The parallel to serial converter 69 generates the compressed block test result DCpa (DCpaa to DCpae), which is the resulting serial pattern. In step S59, the block expected value comparison circuit 8 compares the compressed block test result DCpa (DCpaa to DCpae) with the expected value DRpa (DRpaa to DRpae) of the compressed block test result. This comparison is based on the failure pattern 217 and the failure scan chain 254, and there are pairs that do not match between components DCpaa to DCpae of the compressed block test result DCpa and components DRpaa to DRpae of the expected value DRpa of the compressed block test result. Comparison results of pairs that do not match are written in the failure log 257. In step S310, the numbering of each mismatched pair in the order of comparing the components DCpaa to DCpae of the compressed block test result DCpa is counted. This allows identification of the failure block 260.

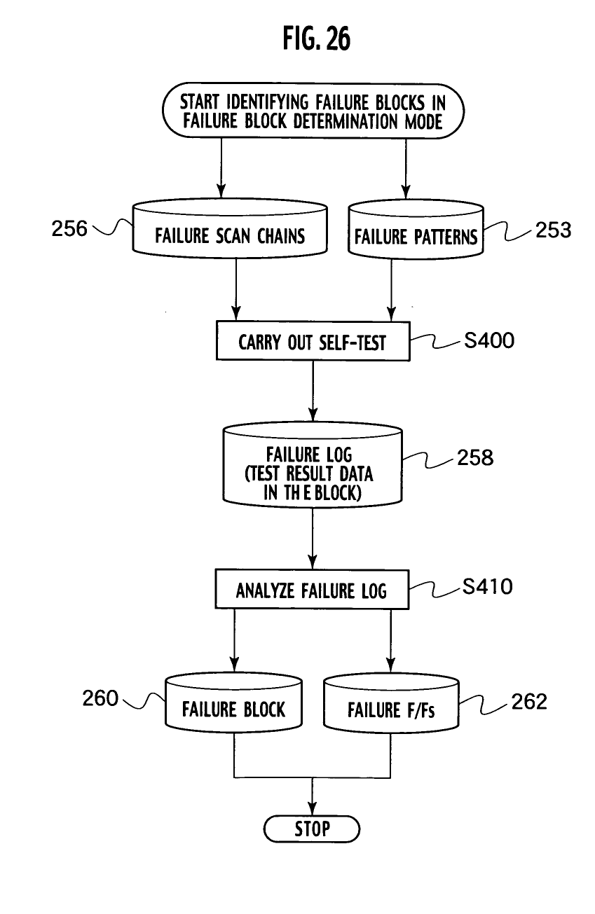

Next, the procedure for the integrated circuit 21 in FIG. 23 to identify a failure block in the failure scan chains and then output the test result in the failure block to the tester 25 is described. As shown in FIG. 26, to begin with, in step S400, a self-test is carried out based on the failure pattern 253 and the information of the failure scan chain 256, which is similar to the flowchart of FIG. 24. As a result, the failure log 258 is obtained. The failure log 258 includes the data resulting from testing failure blocks. This is because, if there is no match found by comparing signatures, the test result data output from blocks is output to the tester 25. In step S410, the failure log 258 is then analyzed, and the failure block 260 and a failure-propagated failure flip-flop 262 are identified.

As described above, according to the integrated circuit 21 of the second embodiment, a failure position can be easily located.

(First Modified Example of the Second Embodiment)

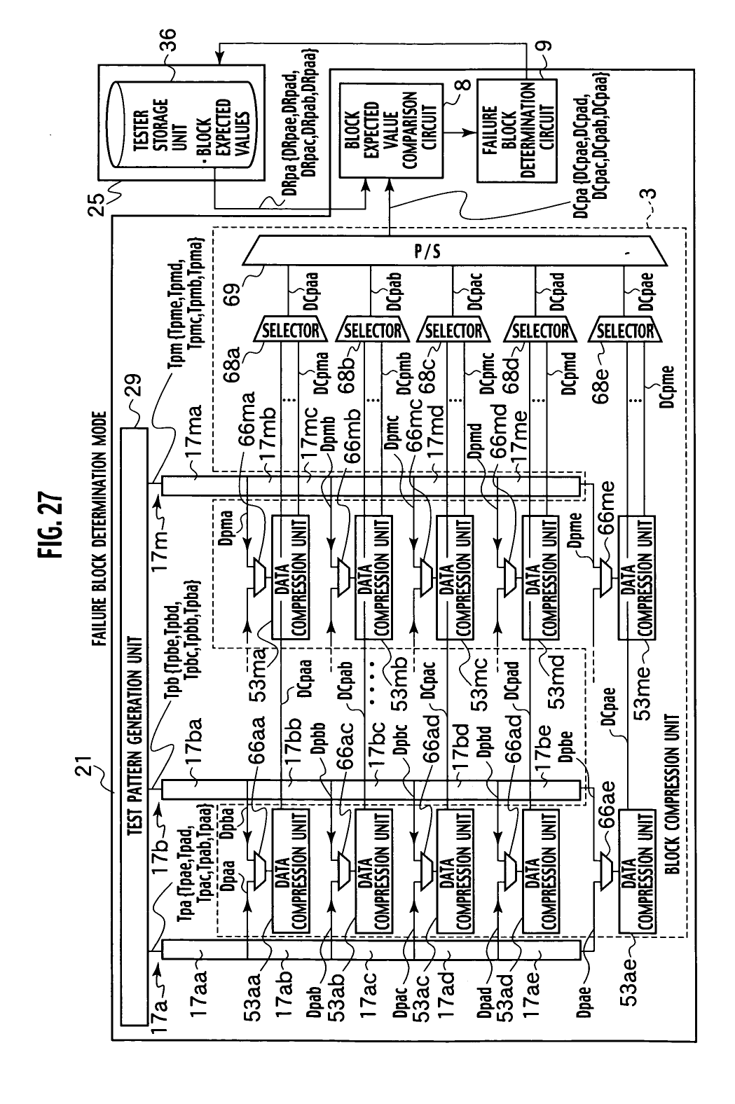

As shown in FIG. 27, the integrated circuit 21 in failure block determination mode, according to a first modified example of the second embodiment of the invention, is structured such that the structure of the block compression unit 3 is different from the integrated circuit 21 of the second embodiment in FIG. 23. Even the block compression unit 3, according to the first modified example of the second embodiment of the invention, is capable of selecting each of the blocks 17aa to 17ae, 17ba to 17be, . . . , and 17ma to 17me.

The block compression unit 3 includes selectors 66aa to 66ae, . . . , and 66ma to 66me, the data compression units 53aa to 53ae, . . . , and 53ma to 53me, the selectors 68a to 68e, and the parallel to serial converter 69.

The selectors 66aa to 66ae, . . . , and 66ma to 66me are connected to the last stages of the blocks 17aa to 17ae, 17ba to 17be, . . . , and 17ma to 17me. The selectors 66aa to 66ae, . . . , and 66ma to 66me output the block test results Dpaa to Dpae output from the failure scan chain 17a, which is a failure shift register.

The data compression units 53aa to 53ae, . . . , and 53ma to 53me are connected to the selectors 66aa to 66ae, . . . , 66ma to 66me. The data compression units 53aa to 53ae, . . . , and 53ma to 53me receive the block test results Dpaa to Dpae, and output the compressed block test results DCpaa to DCpae. The number of the data compression units 53aa to 53ae, . . . , and 53ma to 53me is smaller than that of the blocks 17aa to 17ae, 17ba to 17be, . . . , and 17ma to 17me.

The selectors 68a to 68e are connected to the data compression units 53aa to 53ae, . . . , 53ma to 53me. The selectors 68a to 68e output the compressed block test results DCpaa to DCpae for the failure scan chain 17a, which is a failure shift register.

The parallel to serial converter 69 receives the compressed block test results DCpaa to DCpae in parallel, and then serially outputs the compressed block test results DCpaa to DCpae in order. The parallel to serial converter 69 generates the compressed block test result DCpa (DCpaa to DCpae), which includes the compressed block test results DCpaa to DCpae as components. It should be noted that the serially outputting order should be an order that allows identification of the blocks 17aa to 17ae.

The number of the input terminals of the selectors 66aa to 66ae, . . . , and 66ma to 66me, and the number of the input terminals of the selectors 68a to 68e should be a plurality, and preferably equal.

The control circuit 22a controls the selectors 66aa to 66ae, . . . , and 66ma to 66me and the selectors 68a to 68e to select each of the blocks 17aa to 17ae, 17ba to 17be, . . . , and 17ma to 17me. The selectors 66aa to 66ae, . . . , and 66ma to 66me are connected between the data compression units 53aa to 53ae, . . . , 53ma to 53me and the multiple blocks 17aa to 17ae, 17ba to 17be, . . . , and 17ma to 17me. The multiple blocks 17aa to 17ae, 17ba to 17be, . . . , and 17ma to 17me share the data compression units 53aa to 53ae, and 53ma to 53me. FIG. 27 shows a case where two adjacent blocks 17aa and 17ba share the data compression unit 53aa.

The multiple blocks 17aa and 17ba share the data compression unit 53aa, thereby reducing the number of area penalties. The selector 66aa selects each block and sequentially compares signatures, thereby determining whether there is a propagated failure in each block.

It should be noted that failure scan chain determination mode may be omitted and processing in failure block determination mode may be performed using failure patterns by the integrated circuit 21 in FIG. 27. Analysis time in this case increases as the number of blocks 17aa and 17ba sharing the data compression unit 66a increases. This analysis time relates to the area penalties in a trade-off relationship. The number of the blocks 17aa and 17ba sharing the compression unit 66a is not limited to two, and may be three or more.

As described above, according to the integrated circuit 21 of the first modified example of the second embodiment, a failure block can be easily identified.

(Second Modified Example of the Second Embodiment)

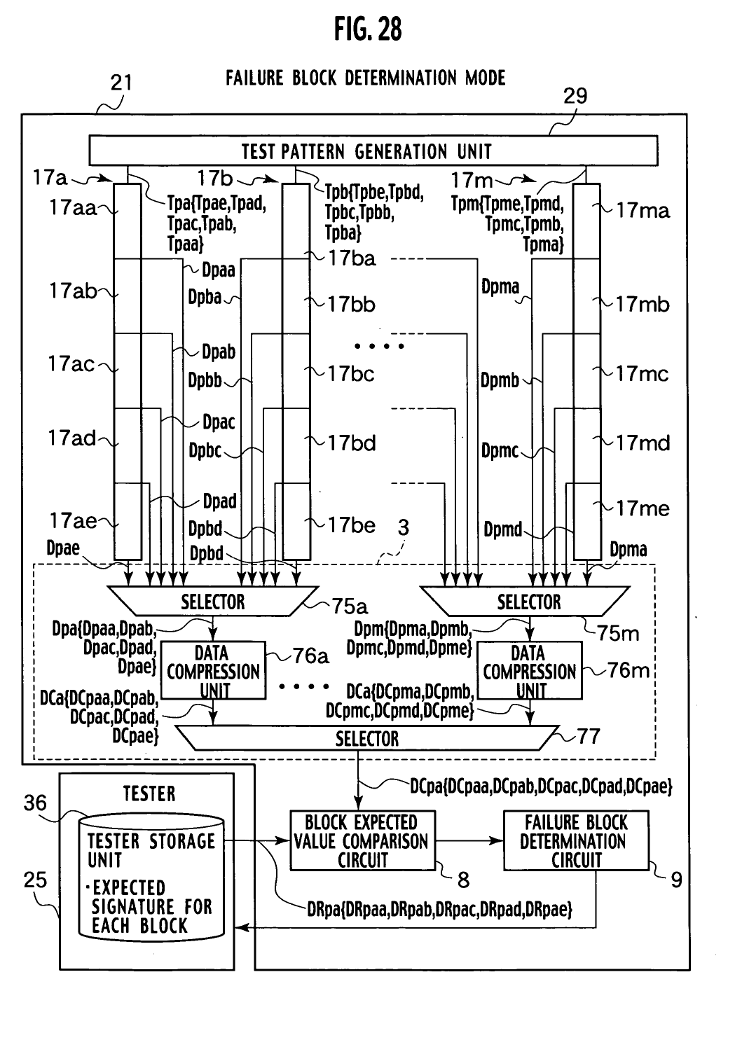

As shown in FIG. 28, the integrated circuit 21 according to a second modified example of the second embodiment in failure block determination mode is structured such that the structure of the block compression unit 3 is different from that of the integrated circuit 21 of the second embodiment in FIG. 23. Even the block compression unit 3, according to the second modified example of the second embodiment, may be capable of selecting each of the blocks 17aa to 17ae, 17ba to 17be, . . . , and 17ma to 17me.

The block compression unit 3 includes selectors 75a to 75m, data compression units 76a to 76m, and a selector 77. All of the blocks 17aa to 17ae and 17ba to 17be belonging to the two adjacent scan chains 17a and 17b share the data compression unit 76a.

The selectors 75a to 75m are connected to the last stages of the blocks 17aa to 17ae, 17ba to 17be, . . . , and 17ma to 17me. The selectors 75a to 75m receive the block test results Dpaa to Dpae output from the failure scan chain 17a, which is a failure shift register. A self-test is conducted repeatedly. The selectors 75a to 75m select and output the block test results Dpaa to Dpae one by one for each self-test in order. This outputting order allows identification of the blocks 17aa to 17ae. The selectors 75a to 75m consequently output the block test result Dpa (Dpaa to Dpae), which is obtained by serially arranging the block test results Dpaa to Dpae.

The data compression units 76a to 76m are connected to the selectors 75a to 75m. The data compression units 76a to 76m receive the block test result Dpa (Dpaa to Dpae), and then output the compressed block test result DCpa (DCpaa to DCpae). The compressed block test result DCpa is arranged such that the components DCpaa to DCpae can be separated. The number of the data compression units 76a to 76m is smaller than that of the blocks 17aa to 17ae, 17ba to 17be, . . . , and 17ma to 17me.

The selector 77 is connected to the data compression units 76a to 76m. The selector 77 outputs the compressed block test result DCpa (DCpaa to DCpae) for the failure scan chain 17a.

The data compression unit 53aa in FIG. 27 is shared by two blocks 17aa and 17ba. On the other hand, the data compression unit 76a in FIG. 28 is shared by ten blocks 17aa to 17ae and 17ba to 17be. This arrangement accordingly allows drastic reduction in area penalty. Data from each of the blocks 17aa to 17ae and 17ba to 17be is selected by the selector 75a and input to the data compression unit 76a, which then generates signatures.

It should be noted that the case of all of the blocks 17aa to 17ae and 17ba to 17be belonging to the two scan chains 17a and 17b sharing the data compression unit 76a is described, and alternatively all of the blocks belonging to more than three scan chains may share the data compression unit 76a.

As described above, the integrated circuit 21, according to the second modified example of the second embodiment, is capable of easily identifying failure blocks.

(Third Modified Example of the Second Embodiment)

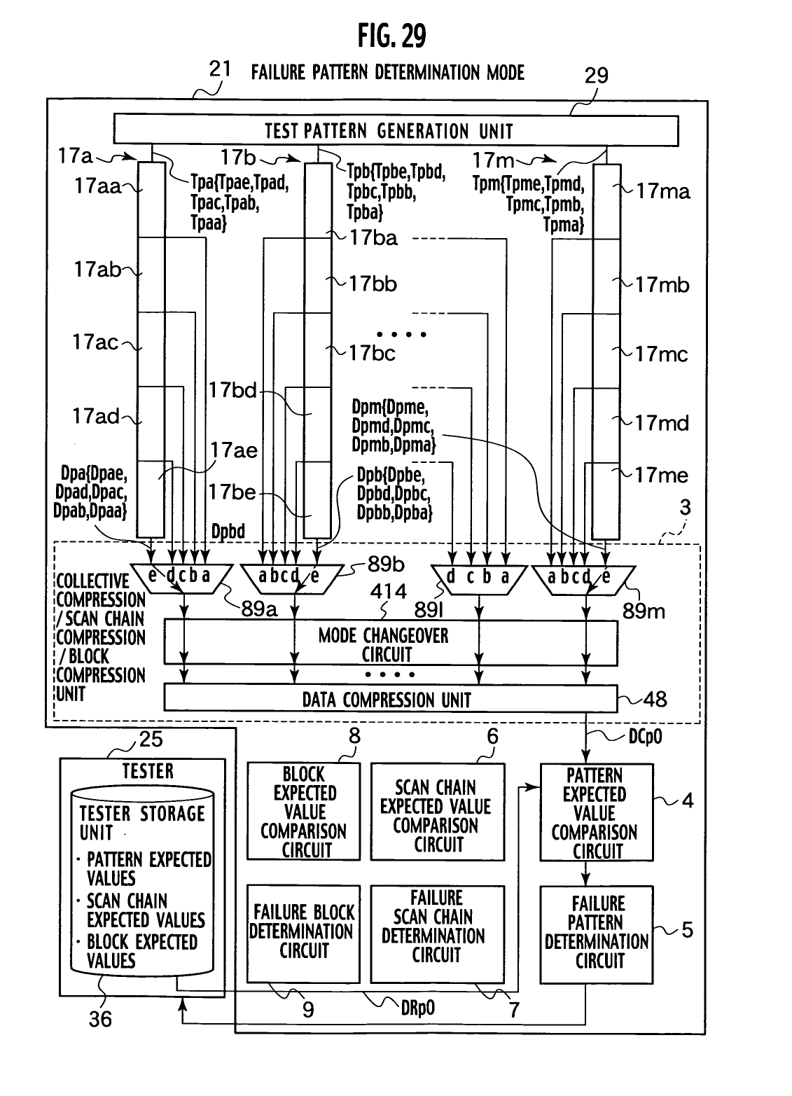

As shown in FIGS. 29 to 31, the integrated circuit 21 in failure pattern determination mode, failure scan chain determination mode, and failure block determination mode, according to a third modified example of the second embodiment, is structured such that the collective compression unit 16 and the scan chain compression unit 2 are omitted, and the structure of the block compression unit 3 is different compared to the integrated circuit 21 of the first embodiment in FIGS. 4, 5, and 6. Even the block compression unit 3, according to the third modified example of the second embodiment, is capable of identifying failure patterns, failure scan chains, and failure blocks. The block compression unit 3, according to the third modified example of the second embodiment, functions as the collective compression unit 16 of the first embodiment in failure pattern determination mode, functions as the scan chain compression unit 2 of the first embodiment in failure scan chain determination mode, and functions as the block compression unit 3 of the first embodiment in failure block determination mode. The block compression unit 3 includes selectors 89a to 89m, a mode changeover circuit 414, and a data compression unit 48.

To begin with, failure pattern determination mode in FIG. 29 is described.

The test pattern generation unit 29 shift-inputs the test patterns T1 to Tp namely, the scanning test patterns T1a to T1m, and Tpa to Tpm for the scan chains 17a to 17m into the scan chains 17a to 17m individually. The scan chains 17a to 17m, which are shift registers, shift in the scanning test patterns T1a to T1m, . . . , and Tpa to Tpm. The scan chains 17a to 17m output the scanning test patterns T1a to T1m, . . . , and Tpa to Tpm to the logic circuit 18. The scan chains 17a to 17m receive the test results Dpa to Dpm from the logic circuit 18. The scan chains 17a to 17m shift out the test results Dpa to Dpm from their last stages, respectively.

The block compression unit 3, which is a test result compression unit, receives the test results Dpa to Dpm in parallel, and collectively compresses the test results Dpa to Dpm into a single compressed test result signature DCpO. The block compression unit 3 includes the selectors 89a to 89m, the mode changeover circuit 414, and the data compression unit 48. The selectors 89a to 89m select the terminals e connected to the last stages of the scan chains 17a to 17m. The selectors 89a to 89m receive and then output the test results Dpa to Dpm. The mode changeover circuit 414 is connected to the selectors 89a to 89m. The mode changeover circuit 414 receives and then outputs the test results Dpa to Dpm in parallel. The data compression unit 48 is connected to the mode changeover circuit 414. The data compression unit 48 receives the test results Dpa to Dpm in parallel, and collectively compresses the test results Dpa to Dpm. The data compression unit 48 generates a single compressed test result signature DCpO. Subsequent operations of the expected pattern value comparison circuit 4 and the failure pattern determination circuit 5 is the same as that in the first embodiment, and they are capable of identifying a test pattern Tp as a failure pattern, for example.

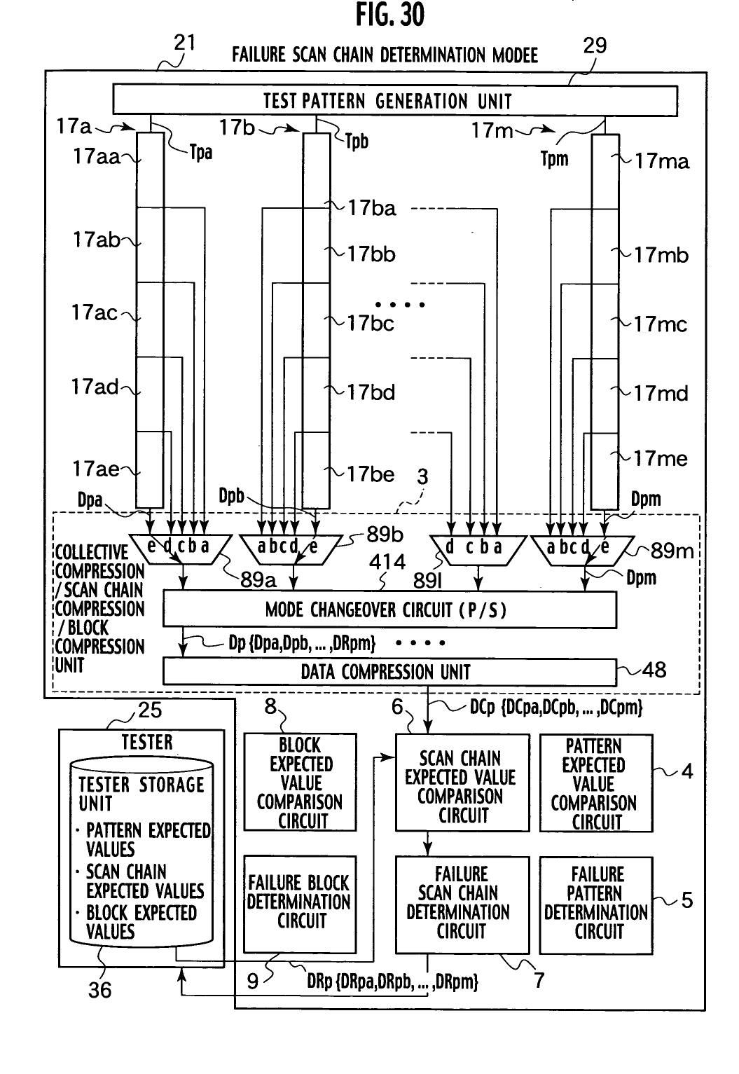

Next, failure scan chain determination mode in FIG. 30, which is failure shift register determination mode, is described.

The test pattern generation unit 29 divides the test pattern Tp, which is a failure pattern, generating the resulting scanning test patterns Tpa to Tpm. The scan chains 17a to 17m shift in the scanning test patterns Tpa to Tpm. The scan chains 17a to 17m output the scanning test patterns Tpa to Tpm to the logic circuit 18. The scan chains 17a to 17m receive the test results Dpa to Dpm from the logic circuit 18. The scan chains 17a to 17m shift out the test results Dpa to Dpm from the last stages of the scan chains 17a to 17m in parallel.

The block compression unit 3 compresses the test results Dpa to Dpm in order, and then output the compressed test result signatures DCpa to DCpm in order. The block compression unit 3 includes the selectors 89a to 89m, the mode changeover circuit 414, and the data compression unit 48. The selectors 89a to 89m output the test results Dpa to Dpm. The mode changeover circuit 414 is connected to the selectors 89a to 89m. The mode changeover circuit 414 receives the test results Dpa to Dpm in parallel, and then serially outputs the test results Dpa to Dpm in order. The mode changeover circuit 414 outputs the test result Dp (Dpa to Dpm), which is arrayed with the test results Dpa to Dpm as components thereof. The data compression unit 48 is connected to the mode changeover circuit 414. The data compression unit 48 compresses the components Dpa to Dpm of the test result Dp (Dpa to Dpm) in order. The compressed test result signature DCp (DCpa to DCpm), which is arrayed with the components DCpa to DCpm in that order, is output. Subsequent operations of the scan chain expected value comparison circuit 6 and the failure scan chain determination circuit 7 are the same as those in the first embodiment, and are capable of identifying the scan chain 17a as a failure scan chain, for example.

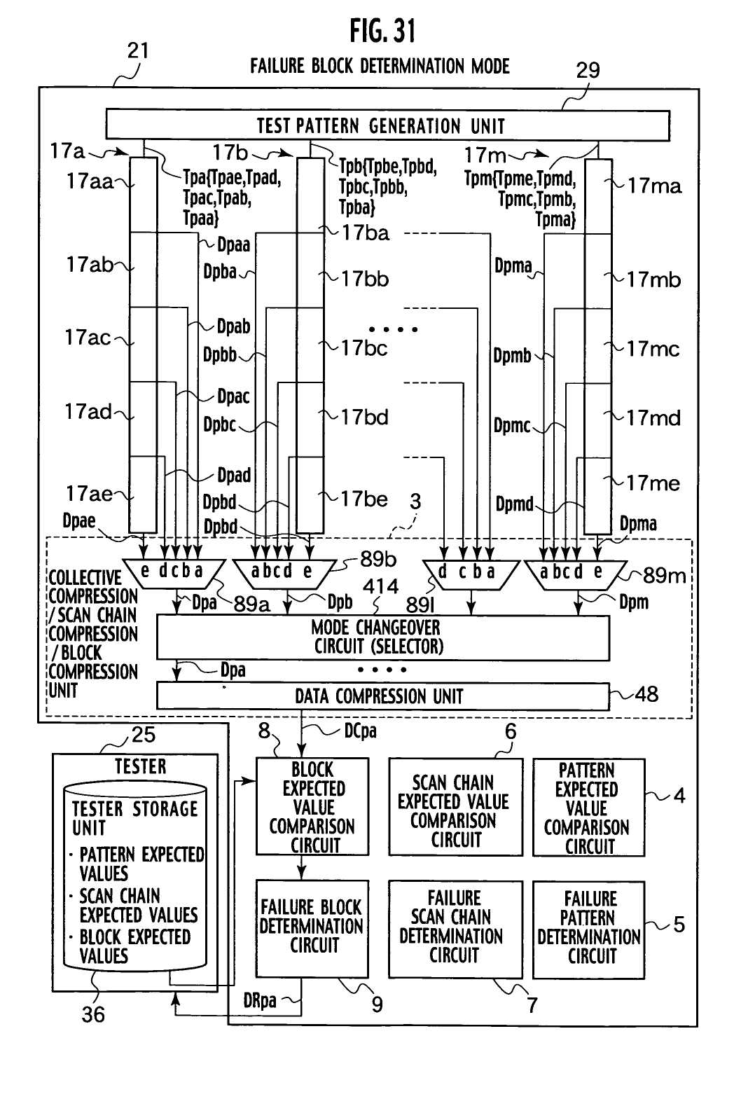

Finally, failure block determination mode of FIG. 31 is described.

The test pattern generation unit 29 generates the test pattern Tp, which is a failure pattern, namely, the scanning test patterns Tpa to Tpm for the scan chains 17a to 17m individually. The scan chains 17a to 17m shift in the scanning test patterns Tpa to Tpm, and then output them to the logic circuit 18 at the same time. The scan chains 17a to 17m receive multiple test results Dpa to Dpm from the logic circuit 18. The scan chains 17a to 17m are each divided into the multiple blocks 17aa to 17ae and 17ba to 17be. The blocks 17aa to 17ae and 17ba to 17be shift out the block test results Dpaa to Dpae, . . . , and Dpma to Dpme, which are obtained by dividing the test results Dpa to Dpm, from the last stages. The block compression unit 3 includes the selectors 89a to 89m, the mode changeover circuit 414, and the data compression unit 48. The selectors 89a to 89m select and output each of the block test results Dpaa to Dpae, . . . , and Dpma to Dpme in order. For this selection, a self-test using the failure pattern Tp is carried out the same number of times as the number of scan chain-divided blocks. As a result, the selectors 89a to 89m output the block test result Dpa (Dpaa to Dpae) and the like, which is serially arrayed with the block test results Dpaa to Dpae and the like. The mode changeover circuit 414 is connected to the selectors 89a to 89m. The mode changeover circuit 414 selects from the selectors 89a to 89m the selector 89a to be connected to the scan chain 17a based on the failure scan chain being the scan chain 17a. The mode changeover circuit 414 outputs the block test result Dpa (Dpaa to Dpae), which is output from the failure scan chain. The data compression unit 48 is connected to the mode changeover circuit 414. The data compression unit 48 compresses each of the components Dpaa to Dpae of the block test result Dpa (Dpaa to Dpae) in order. The data compression unit 48 outputs the compressed block test result DCpa (DCpaa to DCpae). The compressed block test result DCpa is arrayed such that the components DCpaa to DCpae can be separated. The order of the arrayed components of the block test result Dpa and the order of the arrayed components of the compressed block test result DCpa both correspond to the blocks 17aa to 17ae on a one-to-one mapping basis. Subsequent operations of the block expected value comparison circuit 8 and the failure block determination circuit 9 are the same as those in the second embodiment, and they are capable of identifying the block 17aa as a failure block, for example.

By deploying the mode changeover circuit 414 in between the data compression unit 48 and multiple selectors 89a to 89m, the data compression unit 48 in failure pattern determination mode also functions as the collective compression unit 16. This allows drastic reduction in area penalty. With the selectors 89a to 89m and the mode changeover circuit 414 in failure pattern determination mode, all of the scan chains 17a to 17m are connected to the data compression unit 48 directly or after space compression (space compaction). In contrast, with the selectors 89a to 89m and the mode changeover circuit 414 in failure block determination mode, the blocks 17aa to 17ae, which are identified as blocks included in the failure scan chain 17a, are connected to the data compression unit 48. Therefore, the data compression unit 48 is capable of generating signatures DCpaa to DCpae for each of the blocks 17aa to 17ae, 17ba to 17be, . . . , and 17ma to 17me. The structure of the mode changeover circuit 414 is the same as, for example, that of the mode changeover circuit 414 in FIG. 22.

As described above, the integrated circuit 21, according to the third modified example of the second embodiment, is capable of easily identifying failure patterns, failure scan chains, and failure blocks.

(Fourth Modified Example of the Second Embodiment)

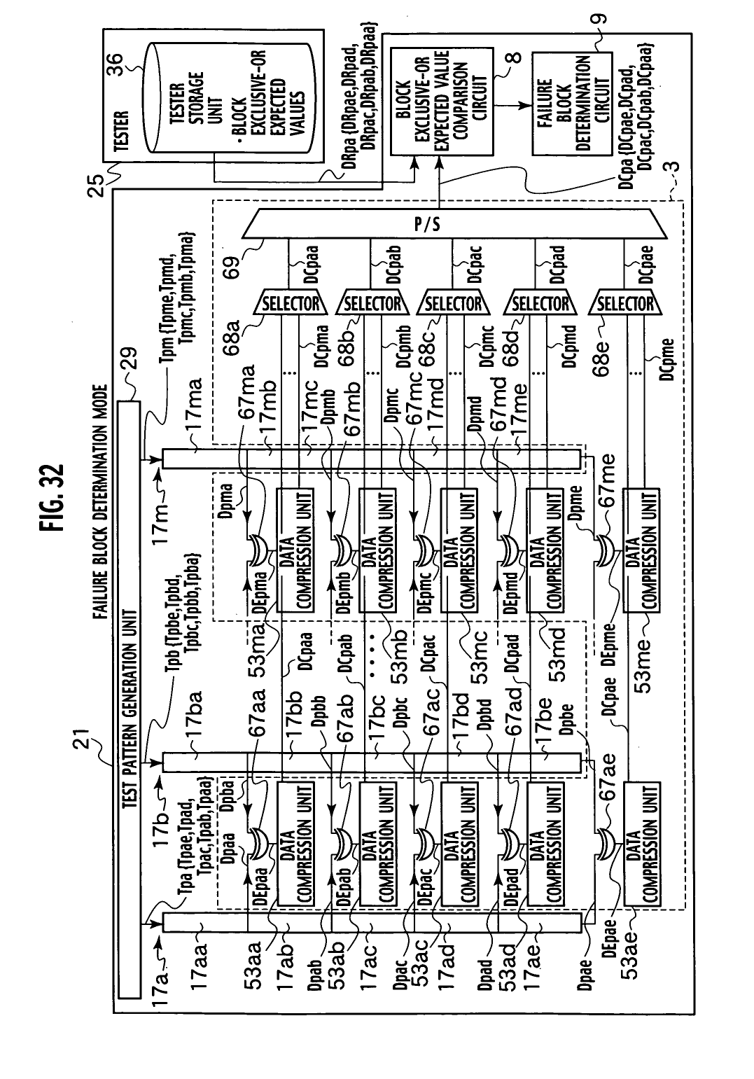

The integrated circuit 21 in failure block determination mode according to a fourth modified example of the second embodiment as shown in FIG. 32 is compared with the integrated circuit 21 according to the first modified example of the second embodiment in FIG. 27. The selectors 66aa to 66ae, . . . , and 66ma to 66me in the block compression unit 3 are replaced with exclusive-OR units 67aa to 67ae, . . . , and 67ma to 67me. The block compression unit 3, according to the fourth modified example of the second embodiment, can select each group including some of the blocks 17aa to 17ae, 17ba to 17be, . . . , and 17ma to 17me.

The block compression unit 3 includes the exclusive-OR units 67aa to 67ae, . . . , and 67ma to 67me, the data compression units 53aa to 53ae, . . . , and 53ma to 53me, the selectors 68a to 68e, and the parallel to serial converter 69.

The exclusive-OR units 67aa to 67ae are connected to the last stages of the blocks 17aa to 17ae and 17ba to 17be. The exclusive-OR units 67ma to 67me are connected to the last stages of the blocks 17ma to 17me and the like. The exclusive-OR units 67aa to 67ae, . . . , and 67ma to 67me receive the block test results Dpaa to Dpae, Dpba to Dpbe, . . . , and Dpma to Dpme, which are output from the blocks 17aa to 17ae, 17ba to 17be, . . . , and 17ma to 17me of multiple scan chains 17a to 17m including the failure scan chain 17a. The exclusive-OR units 67aa to 67ae, . . . , and 67ma to 67me output exclusive-OR results DEpaa to DEpae, . . . , and DEpma to DEpme from the block test results Dpaa to Dpae, Dpba to Dpbe, . . . , and Dpma to Dpme.

The data compression units 53aa to 53ae, . . . , and 53ma to 53me are connected to the exclusive-OR units 67aa to 67ae, . . . , and 67ma to 67me. The data compression units 53aa to 53ae, . . . , 53ma to 53me receive the exclusive-OR results DEpaa to DEpae, . . . , and DEpma to DEpme, and output compressed block test results DCpaa to DCpae, . . . , and DCpma to DCpme.

The selectors 68a to 68e are connected to the data compression units 53aa to 53ae, . . . , and 53ma to 53me. The selectors 68a to 68e output the compressed block test results DCpaa to DCpae relevant to failure scan chain 17a, which is a failure shift register. Alternatively, the selectors 68a to 68e select and output each of the compressed block test results DCpaa to DCpae, . . . , and DCpma to DCpme in order. In this case, a self-test using failure patterns is carried out the same number of times as the number of data compression units 53aa to 53ae, . . . , and 53ma to 53me connected to the respective selectors 68a to 68e.

The parallel to serial converter 69 receives the compressed block test results DCpaa to DCpae in parallel, and serially outputs them in order. The parallel to serial converter 69 generates the compressed block test result DCpa (DCpaa to DCpae), which includes the compressed block test results DCpaa to DCpae as components. Note that the serially outputting order allows the exclusive-OR units 67aa to 67ae and/or the data compression units 53aa to 53ae to be able to carry out identification. Subsequent operations of the block exclusive-OR expected value comparison circuit 8 and the failure block determination circuit 9 are basically the same as those in the second embodiment. The different from the second embodiment is that the block exclusive-OR expected value comparison circuit 8 compares block exclusive-OR expected values rather than the block expected values. In addition, the failure block determination circuit 9, for example, identifies the exclusive-OR unit 67aa and/or the data compression unit 53aa, which has processed failure data. Moreover, the failure block determination circuit 9 identifies the block 17aa or 17ba as a failure block. Based on a failure scan chain being the scan chain 17a, the failure block determination circuit 9 selects a failure block from the blocks 17aa to 17ae included in the scan chain 17a. Ultimately, the failure block determination circuit 9 identifies the block 17aa as a failure block.

In the integrated circuit 21 shown in FIG. 27, two blocks 17aa and 17ba share the data compression unit 53aa via the selector 66aa. This is called a ‘selector system’. Compared to this selector system, in the integrated circuit 21 in FIG. 32, two blocks 17aa and 17ba share the data compression unit 53aa via the exclusive-OR logic circuit 67aa. Therefore, multiple blocks 17aa and 17ba in multiple scan chains 17a and 17b can be used as a unit range for identifying a failure-propagated flip-flop. For example, even in the case where a failure pattern is identified but a failure scan chain is not identified, or if the so-called failure scan chain determination mode is omitted so that a failure scan chain cannot be identified to be either the scan chain 17a or 17b, identification of the block 17aa or the block 17ba which has a propagated failure is possible.

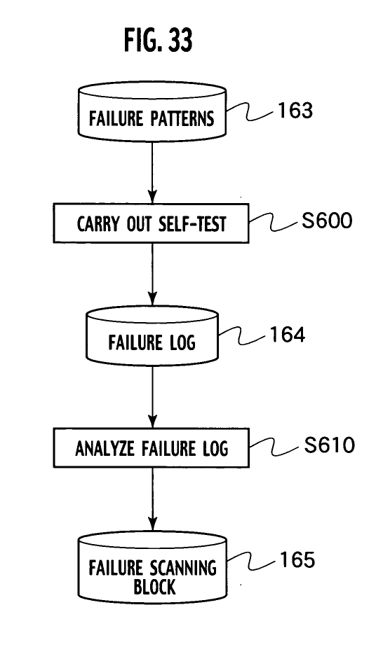

Procedures for the integrated circuit 21 in FIG. 32 to identify a failure-propagated failure block within the failure scan chains and then output the intra-block test results to the tester 25 is described while referencing FIG. 33. To begin with, in step S600, a self-test is carried out for a failure pattern 163. As a result, a failure log 164 is obtained. The failure log 164 includes intra-block test result data. In step S610, the failure log 164 is then analyzed, and the failure block 165 is identified.

As described above, the integrated circuit 21, according to the fourth modified example of the second embodiment, is capable of easily identifying failure blocks.

(Third Embodiment)

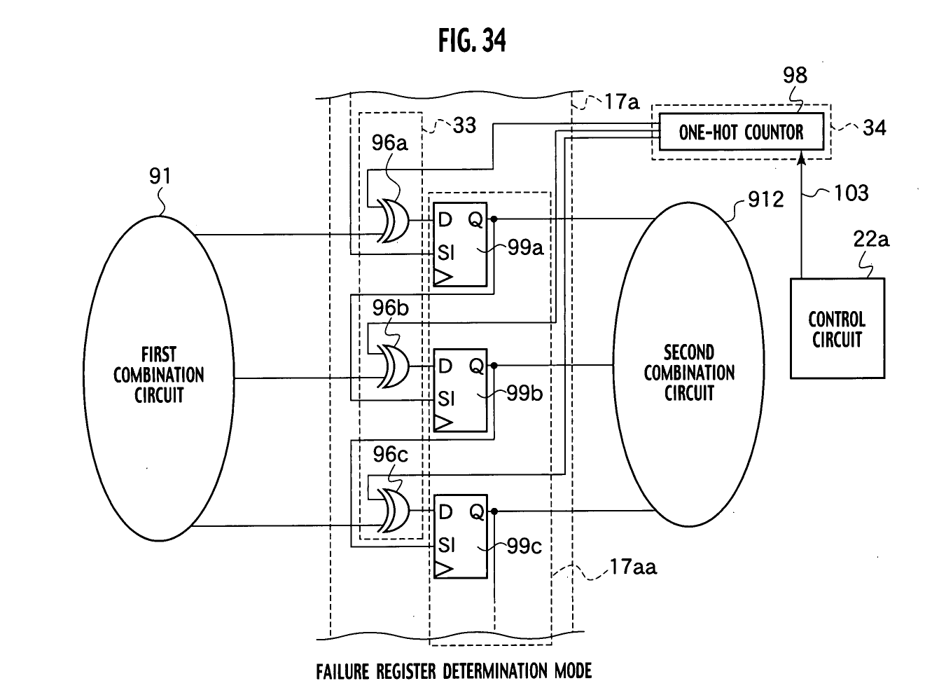

An integrated circuit of a third embodiment shown in FIG. 34 is considered to be a part of the integrated circuit 21 of the first embodiment. The outline of the integrated circuit 21 according to the third embodiment can be considered as the same as that of the integrated circuit 21 of the first embodiment in FIGS. 4 through 8. The structure of the integrated circuit 21 of the third embodiment in failure register determination mode in FIGS. 7 and 34 is described in detail. Moreover, a failure register identification method using the integrated circuit 21 is described in detail.

Compared to the integrated circuit 21 in failure register determination mode in FIG. 7, the block 17aa, a register selection circuit 34, the logic circuit 18, and a register inversion circuit 33 of the integrated circuit 21 in failure register determination mode in FIG. 34 are described in detail. More specifically, the logic circuit 18 includes not only the scan chain 17a and the like but also combination circuits 91, and 912.

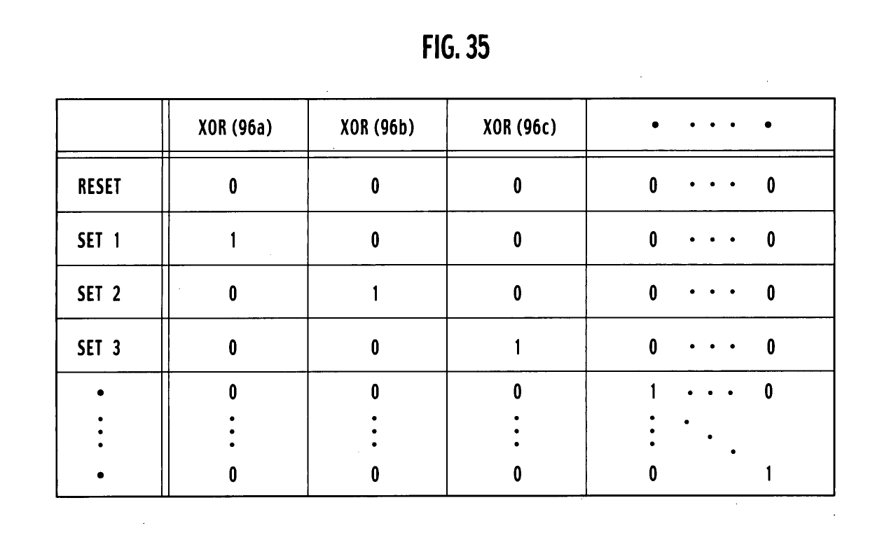

The register selection circuit 34 selects flip-flops 99a to 99c, which are registers making up the block 17aa, one by one in a certain order. The register selection circuit 34 includes a one hot counter 98. As shown in FIG. 35, one hot counter 98 outputs the output data to exclusive-OR circuit 96a to 96c. The control circuit 22a can select the exclusive-OR circuit 96a to 96c that inputs the output data that is 1 by control signal 103. The number of exclusive-OR circuit 96a to 96c that is selected in the third embodiment is one element. The control circuit 22a may select plural exclusive-OR circuits 96a to 96c according to the first combination circuit 91. The control circuit 22a gradually selects data set set 1 to set 3 of output data, and the exclusive OR circuit 96a to 96c can be selected in sequence.

The register inversion circuit 33 includes exclusive-OR logic circuits 96a to 96c. The register inversion circuit 33 inverts the logic value of the block test results Dpaa to Dpae that is inputted to the selected exclusive-OR circuit 96a to 96c, and makes one of the flip-flops 99a to 99c store the inverted logic value. The register inversion circuit 33 does not invert the logic values of the block test results Dpaa to Dpae that are inputted to the non-selected exclusive-OR circuits 96a to 96c and makes the other of the flip-flops 99a to 99c store the logic values as they are. The block 17aa generates the inverted block test result.

The block compression unit 3 receives the inverted block test result, and then compresses it into an inverted compressed block test result.

The block expected value comparison circuit 8 compares the inverted compressed block test result with the corresponding expected value. The block expected value comparison circuit 8 detects an inverted compressed block test result that matches the corresponding expected value.

The failure register determination circuit 32 counts the comparing order of the inverted compressed block test result that matches the corresponding expected value. This order is the order that the flip-flops 99a to 99c have been selected. Therefore, this order allows identification of a failure flip-flop from within the flip-flops 99a to 99c.

As described above, the integrated circuit of the third embodiment can easily identify failure flip-flops.

(First Modified Example of the Third Embodiment)

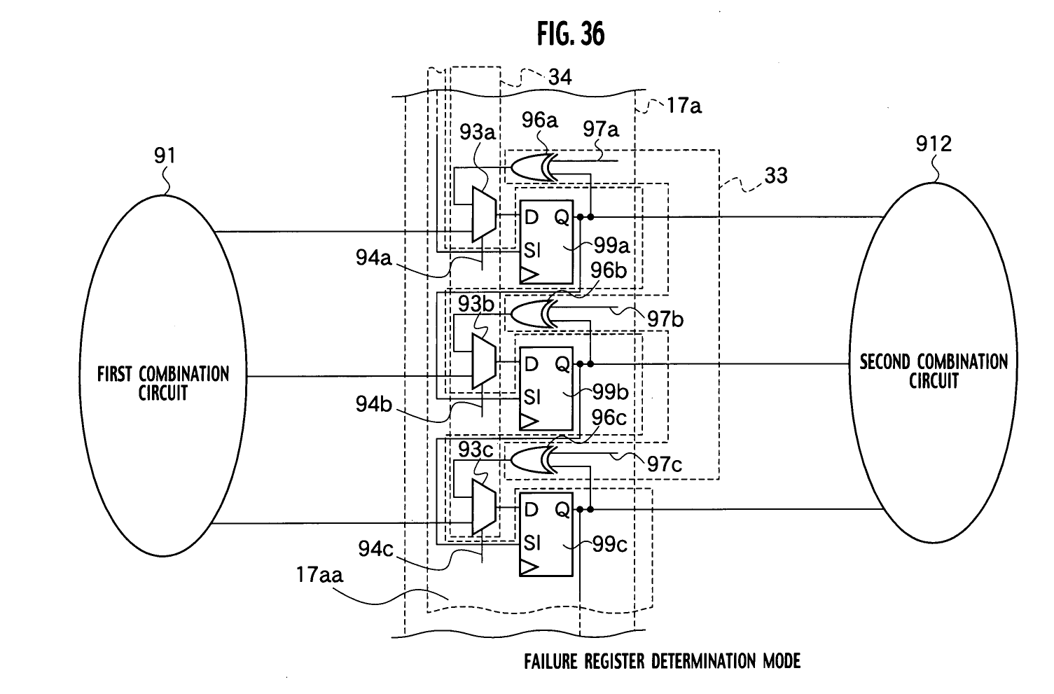

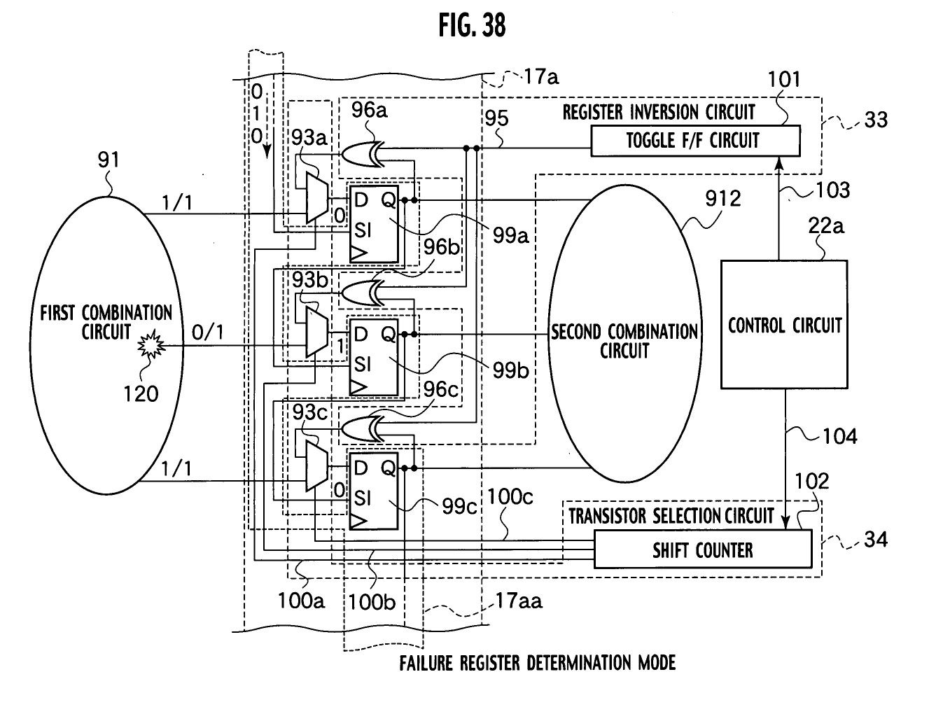

An integrated circuit of the first modified example of the third embodiment shown in FIG. 38 is considered to be a part of the integrated circuit 21 of the first embodiment. The outline of the integrated circuit 21 according to the first modified example of the third embodiment can be considered as the same as that of the integrated circuit 21 of the first embodiment in FIGS. 4 through 8. The structure of the integrated circuit 21 of the first modified example of the third embodiment in failure register determination mode in FIGS. 7 and 36 is described in detail. Moreover, a failure register identification method using the integrated circuit 21 is described in detail.

Compared to the integrated circuit 21 in failure register determination mode in FIG. 7, the block 17aa, a register selection circuit 34, the logic circuit 18, and a register inversion circuit 33 of the integrated circuit 21 in failure register determination mode in FIG. 38 are described in detail. More specifically, the logic circuit 18 includes not only the scan chain 17a and the like but also combination circuits 91, and 912.

The register selection circuit 34 includes the selectors (MUXs) 93a to 93c. The register selection circuit 34 selects in specified order, each of the selector 94a to 94c that connects to the flip-flop 99a to 99c that is the register that composes the block 17aa.

The register inversion circuit 33 includes exclusive-OR logic circuits 96a to 96c. At first, the register inversion circuit 33 inputs the logic value of the block test pattern Tpaa to Tpae via the exclusive-OR circuit 96a to 96c from one of the flip-flops 99a to 99c to the selected selector 94a˜94c, and makes the one of the flip-flops 99a to 99c store the logic value again. The non-selected selectors 94a to 94c through the block test results Dpaa to Dpae and the others of the flip-flops 99a to 99c capture the logic values. The block 17aa generates the first non-inverted block test result.

At sesond, the register inversion circuit 33 inputs the logic value of the block test pattern Tpaa to Tpae inverted by the exclusive-OR circuit 96a to 96c from the one of the flip-flops 99a to 99c to the selected selector 94a to 94c, and makes the one of the flip-flops 99a to 99c store the inverted logic value. The non-selected selectors 94a to 94c through the block test results Dpaa to Dpae and the others of the flip-flops 99a to 99c capture the logic values. The block 17aa generates the second inverted block test result.

The block compression unit 3 receives the first and second inverted block test results, and then compresses the first and second inverted block test results into the first and second inverted compressed block test results.

The block expected value comparison circuit 8 compares the first and second inverted compressed block test result with the corresponding expected value. The block expected value comparison circuit 8 detects the first and second inverted compressed block test result that matches the corresponding expected value.

The failure register determination circuit 32 counts the comparing order of the first and second inverted compressed block test result that matches the corresponding expected value. This order is the order that the flip-flops 99a to 99c have been selected. Therefore, this order allows identification of a failure flip-flop from within the flip-flops 99a to 99c.

As shown in FIG. 36, the flip-flops 99a to 99c are serially connected to each other forming a shift register. The flip-flops 99a to 99c make up the block 17aa and also the scan chain 17a. The outputs of the flip-flops 99a to 99c are connected to respective ones of the input terminals of the exclusive-OR logic circuits (XOR circuits) 96a to 96c, respectively. The outputs of the XOR circuits 96a to 96c are connected to one of the input terminals of the selectors (MUXs) 93a to 93c, respectively. The other input terminals of the exclusive-OR logic circuits (XOR circuits) 96a to 96c are supplied with control signals 97a to 97c, respectively. The other input terminals of the MUXs 93a to 93c are connected to the first combination circuit 91. The outputs of the flip-flops 99a to 99c are connected to the second combination circuit 912. Each of the MUXs 93a to 93c selects one of the inputs in conformity with select signals 94a to 94c. In FIG. 36, the XOR circuits 96a to 96c and the MUXs 93a to 93c are provided to the respective flip-flops 99a to 99c.

If the select signals 94a to 94c are equal to a logic value of 1, the MUXs 93a to 93c receive data from the first combination circuit 91, and then outputs the data to the flip-flops 99a to 99c. Otherwise, if the select signals 94a to 94c are equal to a logic value of 0, the MUXs 93a to 93c receive the outputs of the XOR circuits 96a to 96c, and then send the outputs to the flip-flops 99a to 99c.

If the control signals 97a to 97c are equal to a logic value of 1, the XOR circuits 96a to 96c send the inverted values of the logic values stored in the flip-flops 99a to 99c to the MUXs 93a to 93c. At this time, if the flip-flops 99a to 99c receive a clock signal, their logic values are inverted. This inversion allows generation of inverted block test results. If the control signals 97a to 97c are equal to a logic value of 0, the XOR circuits 96a to 96c send to the MUX 93a to 93c the logic values Tpaa to Tpae stored in the flip-flops 99a to 99c as they are. At this time, if the flip-flops 99a to 99c receive a clock signal, those logic values are held by the flip-flops 99a to 99c. With this circuit configuration, the select signals 94a to 94c and the control signals 97a to 97b decide the operation (holding, inverting, taking in) of each of the flip-flops 99a to 99c.

According to the first modified example of the third embodiment, failure-propagated flip-flops 99a to 99c can be identified within the integrated circuit 21. The failure storage unit of the tester 25 stores the numbering of the matching data in a line, which includes multiple data that do not match the expected values of the compressed block test result, as information of failure-propagated flip-flops. Therefore, the necessary capacity of the failure storage unit can be smaller.

As described above, the integrated circuit of the first modified example of the third embodiment can easily identify failure flip-flops.

(Second Modified Example of the Third Embodiment)

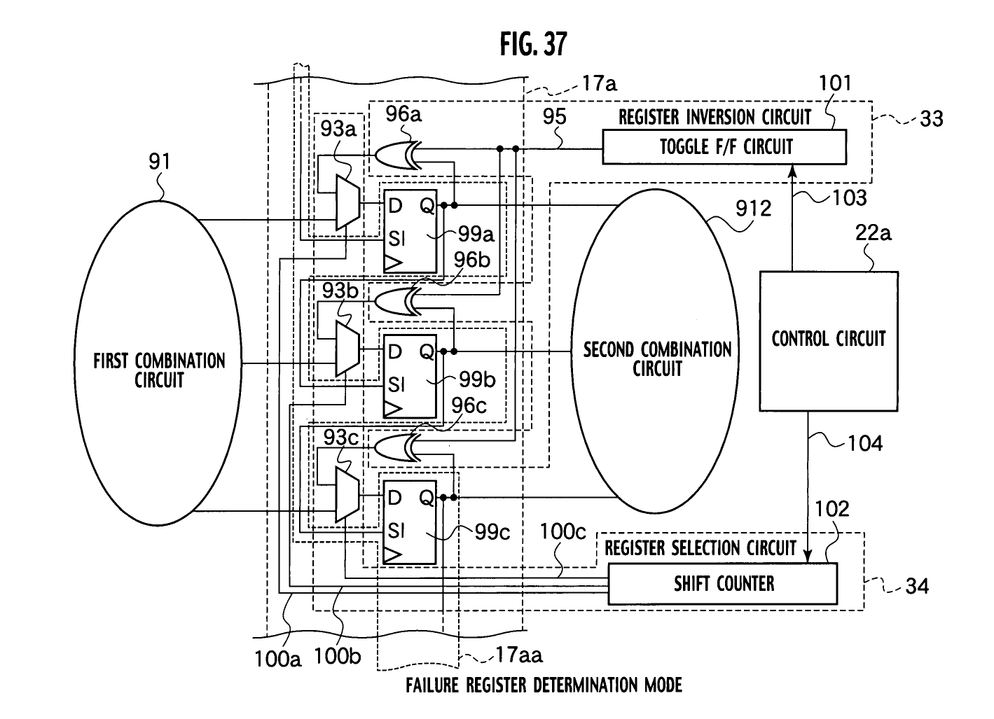

An integrated circuit shown in FIG. 37, according to the second modified example of the third embodiment, is considered to be a part of the integrated circuit 21 of the first embodiment. The outline of the integrated circuit 21, according to the second modified example of the third embodiment, can be considered the same as that of the integrated circuit 21 of the first embodiment in FIGS. 4 to 8 and also that of the integrated circuit 21 of the first modified example of the third embodiment in FIG. 36. The structure of the integrated circuit 21 of the second modified example of the third embodiment in failure register determination mode in FIGS. 7, 36, and 37 is described in detail. Moreover, a failure register identification method using the integrated circuit 21 is described in detail.

Compared to the integrated circuit 21 in failure register determination mode in FIG. 36, the register selection circuit 34 and the register inversion circuit 33 of the integrated circuit 21 in failure register determination mode in FIG. 37 are described in detail.

The register selection circuit 34 includes a shift counter 102. The shift counter 102 selects each of the flip-flops 99a to 99c in a certain order. The shift counter 102 may be the shift counter 23 in FIGS. 4 through 8. The shift counter 23 is replaced with the shift counter 102, which counts the number of shift operations for shifting the scanning test patterns Tpa to Tpn into the scan chains 17a to 17n.

The register inversion circuit 33 further includes a toggle flip-flop (F/F) circuit 101. The toggle F/F circuit 101 controls a hold/inversion of the logic values of the block test results Dpaa to Dpae stored in the flip-flops 99a to 99c.

As shown in FIG. 37, according to the second modified example of the third embodiment, a single block (e.g., block 17aa) shown in FIGS. 23 and 27 through 32 includes multiple flip-flops 99a to 99c. The multiple flip-flops 99a to 99c make up the block 17aa and also the scan chain 17a. The outputs of the flip-flops 99a to 99c are coupled to respective ones of the input terminals of the exclusive-OR logic circuits (XOR circuits) 96a to 96c. The outputs of the XOR circuits 96a to 96c are coupled to respective ones of the input terminals of the selectors (MUX) 93a to 93c. The other ones of the input terminals of the MUXs 93a to 93c are connected to the first combination circuit 91. The other ones of the input terminals of the MUXs 93a to 93c are connected to the first combination circuit 91. The outputs of the flip-flops 99a to 99c are connected to the second combination circuit 912.

The MUXs 93a to 93c are connected to the shift counter 102. The toggle F/F circuit 101 and the shift counter 102 are connected to a control circuit 59 via control lines 103 and 104.

The toggle F/F circuit 101 provides a control signal 95 to the other input terminals of the XOR circuits 96a to 96c. The shift counter 102 controls the MUXs 93a to 93c using select signals 100a to 100c. The MUXs 93a to 93c select respective one of the inputs in conformity with the select signals 94a to 94c. The control circuit 59 controls the operation of the toggle F/F circuit 101 and the shift counter 102.

If the count of the shift counter 102 is 0, the flip-flop 99a is selected in conformity with the select signal 100a. When the count of the shift counter 102 increases by one, the flip-flop 99b is selected in conformity with the select signal 10b. When the count of the shift counter 102 further increases by one, the flip-flop 99c is selected in conformity with the select signal 100c. In this way, the shift counter 102 selects one by one the flip-flops 99a to 99c belonging to the shift register from start to end. The toggle F/F circuit 101 is capable of inverting between 0 and 1 for every clock signal reception.

Usage of the scan chain 17a shown in FIG. 37 for the scan chains 17a to 17n in FIGS. 10, 15, and 20 allows identification of a failure-propagated flip-flop. Note here that the number of failure-propagated flip-flops within the searching range is assumed to be one at most. When the length of the scan chains is comparatively long, satisfying this condition is generally difficult. To solve this problem, the block 17aa, which is obtained by dividing the scan chain 17a in FIGS. 23, 27, and 32, is used. This allows identification of failure flip-flops when a failure influences at most one flip-flop within the specific block 17aa.

The shift counter 102 in FIG. 37 may also be used as the shift counter 23 in FIGS. 4 through 8.

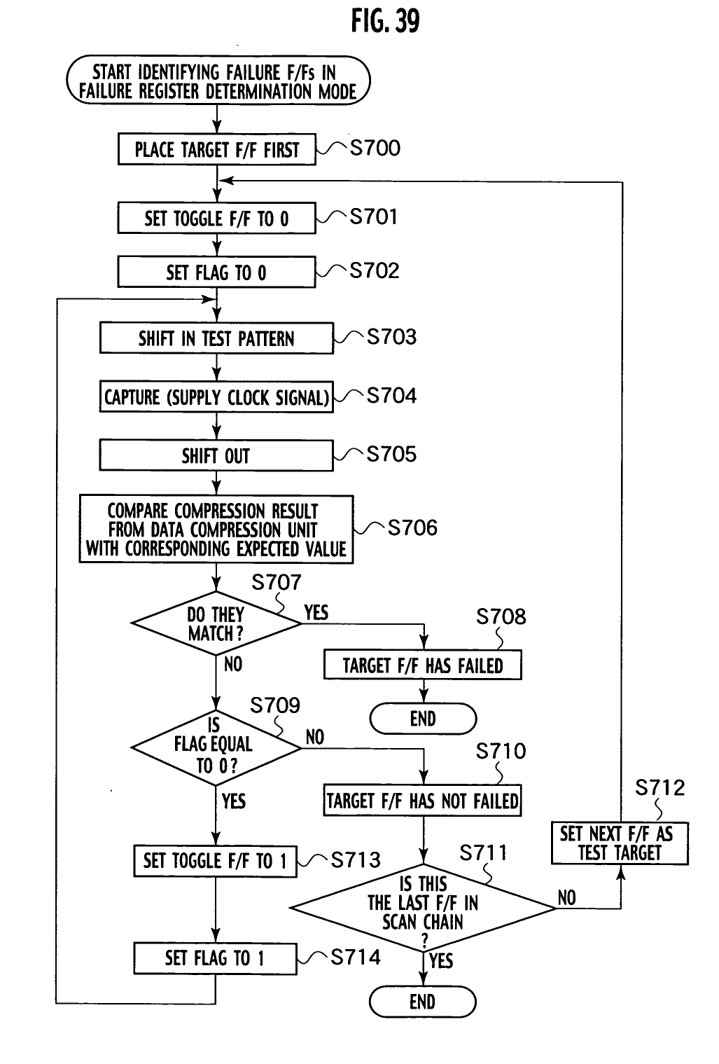

Referencing FIGS. 38 and 39, a procedure for identifying a failure-propagated flip-flop with the circuit structure shown in FIG. 37 is described. It is assumed here that three flip-flops 99a, 99b, and 99c belong to a failure block, and a failure 120 influences the flip-flop 99b. The logic values [Tpaa Tpab Tpac] to be scanned into the flip-flops 99a, 99b, and 99c in the scan chain 17a are [010]. As a result, a logic value of 0 is registered in the flip-flop 99a, a logic value of 1 in the flip-flop 99b, and a logic value of 0 in the flip-flop 99c. When there is no failure (i.e., the first combination circuit 91 is found to be normal), the logic values that the flip-flops 99a, 99b, and 99c take in from the first combination circuit 91 are [101]. Otherwise, when the failure 120 occurs, the flip-flop 99b takes in 1 rather than 0. This behavior is represented by ‘0/1’ in FIG. 38. In this way, when there is the failure 120 (i.e., the first combination circuit 91 is found to be abnormal), the flip-flops 99a, 99b, and 99c take in [101], respectively. In this case, since the signature for this block 17aa does not match the corresponding expected value, which is found through comparison, it is apparent that the failure 120 has propagated to at least one of the flip-flops 99a, 99b, and 99c.

Next, a method of identifying a failure 120-propagated flip-flop is described.

(a) To begin with, in step S700 of FIG. 39, the control circuit 59 sets the shift counter 102 to a logic value of 0. In step S701, the control circuit 22a sets the toggle F/F circuit 101 to a logic value of 0. As a result, the select signal 100a becomes a logic value of 0. The select signals 100b and 100c become a logic value of 1. The control signal 95 becomes a logic value of 0. In step S702, the control circuit 22a sets a flag to 0.

(b) In step S703, signals of [010] are scanned and shifted into three flip-flops 99a, 99b, and 99c using the scan chain 17a.

(c) In step S704, a clock signal is supplied, and a signal is taken in from the first combination circuit 91. The flip-flops 99b and 99c take in signals [11] from the first combination circuit 91 via the MUXs 93b and 93c. The flip-flop 99a holds its own logic value of 0 via the XOR circuit 96a. As a result, since there is the failure 120, signals [011] are registered in the flip-flops 99a, 99b, and 99c, respectively.

(d) In step S705, the block compression unit 8 shifts out logic values [011] of the flip-flops 99a, 99b, and 99c, and compresses them. In step S706, the block expected value comparison circuit 8 compares the signature (compression results) with the corresponding expected value. In step S707, if the failure register determination circuit 32 determines that the signature matches the corresponding expected value, this process proceeds to step S708. Otherwise, if it does not match, this process proceeds to step S709. In step S708, the failure register determination circuit 32 determines that the failure 120 has propagated to the flip-flop 99a. This is because only the flip-flop 99a does not take in a signal from the first combination circuit 91, and holds its own logic value, which suppresses the influence of the failure 120.

(e) In step S709, whether or not the flag is 0 is determined. If the flag is 0, this process proceeds to step S713. If the flag is not 0, this process proceeds to step S710. If the toggle F/F circuit 101 maintains 0, the flag is also 0. In step 713, the control circuit 59 inverts the logic value in the toggle F/F circuit 101 into 1. In step 714, the control circuit 59 sets the flag to 1. As a result, the control signal 95 becomes a logic value of 1. Since the state of the shift counter 102 does not change, neither do the select signals 100a to 100c. Afterwards, this process returns to step S703, and steps S703 to 709 are carried out. More specifically, in this state, using the scan chain 17a, a failure pattern [010] is scanned and shifted into three flip-flops 99a, 99b, and 99c, and a clock signal is supplied. It should be noted that since the control signal 95 is 1, the flip-flop 99a inverts the scanned and shifted-in logic value 0 and registers a logic value of 1. The flip-flops 99b and 99c take in logic values [11] from the first combination circuit 91, respectively. As a result, the logic values registered in the flip-flop 99a, 99b, and 99c become [111]. In step S707, if the answer is Yes, this means that the failure 120 influences the flip-flop 99a, in the same manner as earlier. However, the expected logic values when the first combination circuit 91 does not include the failure 120 are [101], and are different from the scanned and shifted-out logic values [111], thus the compression results must also different. This process then proceeds to S709.

(f) In step S709, the control circuit 22a determines whether or not the flag is 0. The flag is 1. This process then proceeds to step S710. In step S710, the failure register determination circuit 32 determines that the failure 120 does not influence the flip-flop 99a. A first operation of the flip-flop 99a holding the logic value as is, and a second operation of the flip-flop 99a inverting the logic value in this manner prove that the failure 120 occurred in the first combination circuit 91 has not influenced the flip-flop 99a. This is because whether the logic value in the flip-flop 99a is either of 0 or 1, and does not match the corresponding expected value proves that the failure 120 has influenced either one of the other flip-flops 99b or 99c. In other words, irrelevant to the logic value in the flip-flop 99a, the fact that the expected signature does not match indicates that there is a failure in a logic value stored in one of the other flip-flops 99b and 99c.

(g) Instep S711, whether there is a target flip-flop, which is not set in step S700 yet, is verified. In step S711, if there is no target flip-flop, this process is over. Otherwise, if there is a target flip-flop, or it is not the last flip-flop, this process proceeds to step S712. In step S712, a target flip-flop is changed to be from the flip-flop 99a to the flip-flops 99b and 99c. This process then returns to step S701. More specifically, the control circuit 22a increases the shift counter 102. At the same time, the logic value in the toggle F/F circuit 101 is controlled to be 0. As a result, the select signal 100b becomes a logic value of 0. The select signals 100a and 100c become a logic value of 1. Moreover, the control signal 95 becomes a logic value of 0. At this time, when the failure pattern [010] is scanned and shifted in and a clock signal is supplied, the logic values of the flip-flops 99a, 99b, and 99c become [111]. In this state, in step S703, the failure pattern [010] is scanned and shifted in. In step S704, a clock signal is supplied. The logic values in the flip-flops 99a, 99b, and 99c become [111].

(h) In step S705, the flip-flops 99a, 99b, and 99c scan and shift out the logic values [111] to the block compression unit 3. In step S706, in the case where there is no failure 120 in the first combination circuit 91, expected logic values are [101], which are different from the scanned and shifted-out logic values [111]. Therefore, the compression result DCpa in FIG. 7 differs from the expected value DRpa. In step S707, since the compression result DCpa differs from the expected value DRpa, this process proceeds to step S709. In step S709, since the flag is 0, this process proceeds to step S713. In step S713, the control circuit 59 inverts the logic value in the toggle F/F circuit 101 into 1. As a result, the control signal 92 becomes a logic value of 1. Since the state of the shift counter 102 does not change, neither do the select signals 100a to 100c. In step S714, the flag is set to 1.

(i) At this time, this process proceeds to step S703 in which using the scan chain 17a, the failure pattern [010] is scanned and shifted into the three flip-flops 99a to 99c. In step S704, a clock signal is supplied. Since the control signal 95 is 1, the flip-flop 99b inverts the scanned and shifted-in logic value 1, registering the resulting logic value of 0. The flip-flops 99a and 99c take in the logic values [11] from the first combination circuit 91. As a result, the logic values registered in the flip-flops 99a, 99b, and 99c become [101]. In step S705, these logic values [101] are scanned and shifted out to the block compression unit 3. In step S706, since these logic values [101] match the corresponding expected logic values, the data compressed value DCpa also matches the corresponding expected value DRpa. In step S707, since the data compressed value DCpa matches the corresponding expected value DRpa, this process proceeds to step S708.

In step S708, the failure register determination circuit 32 determines that the failure 120 influences the flip-flop 99b. This is because if the failure 120 influence the flip-flops 99a and 99c, which take in data from the first combination circuit 91, the data compressed value DCpa does not match the corresponding expected value DRpa. In the case of the logic value in the flip-flop 99b being held (i.e., logic value 1), a mismatch with the expected value occurs, while in the case of the inverted logic value (logic value 0), a match occurs, which means that a value of 1 is propagated to the flip-flop 99b for the expected value of 0.

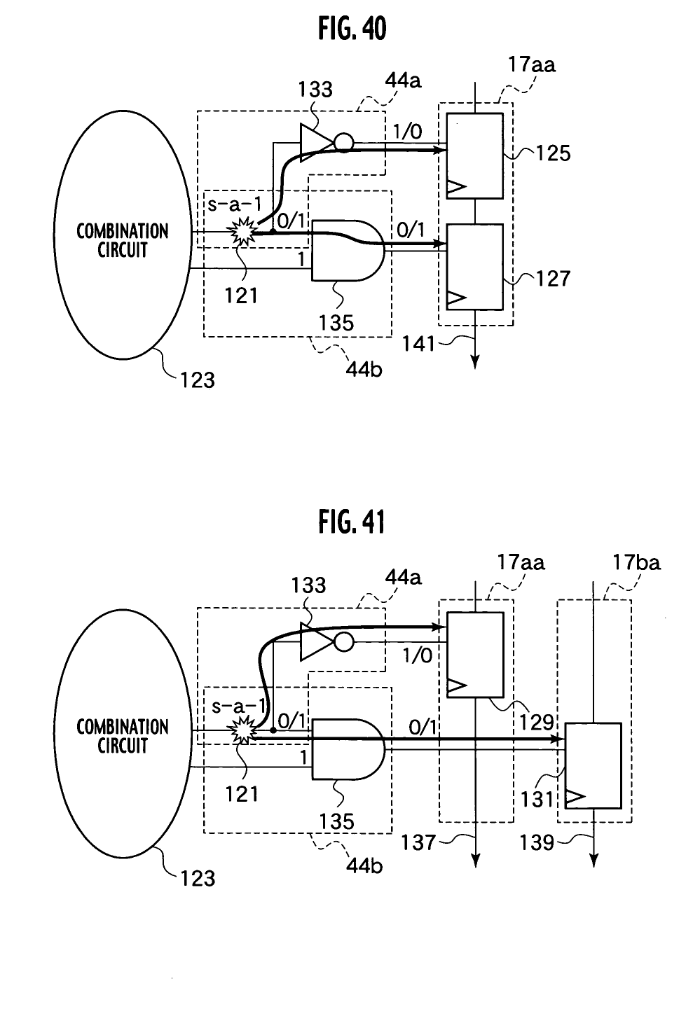

It should be noted that usage of the method shown in the third embodiment allows identification of the flip-flop 99b that the failure 120 has influenced. However, as shown in FIG. 40, there may be a case where two failure flip-flops 125 and 127, or more exist in the failure block 17a that the failure 121 has influenced. In other words, a flip-flop 125 is connected to a combination circuit 123 via an inverter 133. Moreover, a flip-flop 127 is connected to the combination circuit 123 via a logical multiplication circuit 135. The flip-flops 125 and 127 belong to a single scan chain 17a. In the case of the failure 121 influencing both of the flip-flops 125 and 127 belonging to the same block 17aa, the method shown in FIGS. 38 and 39 does not allow identification of a failure flip-flop that the failure 121 has influenced.

To solve this problem, as shown in FIG. 41, by making the flip-flops 125 and 127 that the failure 121 has influenced belong to the blocks 17aa and 17ba in different scan chains 137 and 139, respectively, each of the flip-flops 125 and 127 can be identified. In other words, by designing the scan chains as shown in FIG. 41, identification of a flip-flop using the proposed system is possible. A method of identifying a flip-flop using the proposed system is described later in a fourth embodiment.

The first to the third embodiment may be combined. To begin with, as shown in FIG. 9, in step S500, the failure scan chain 254 and the failure pattern 217 are identified using the method given in the first embodiment and the modified example thereof. In step S510, the failure block 260 in the failure scan chain 254 that a failure has influenced is identified using the method given in the second embodiment and the modified example thereof. Finally, in step S520, the failure-influenced failure flip-flop 256 is identified using the method given in the third embodiment and the modified example thereof.

As described above, according to the integrated circuit of the modified example of the third embodiment, a failure flip-flop can be easily identified.

(Fourth Embodiment)

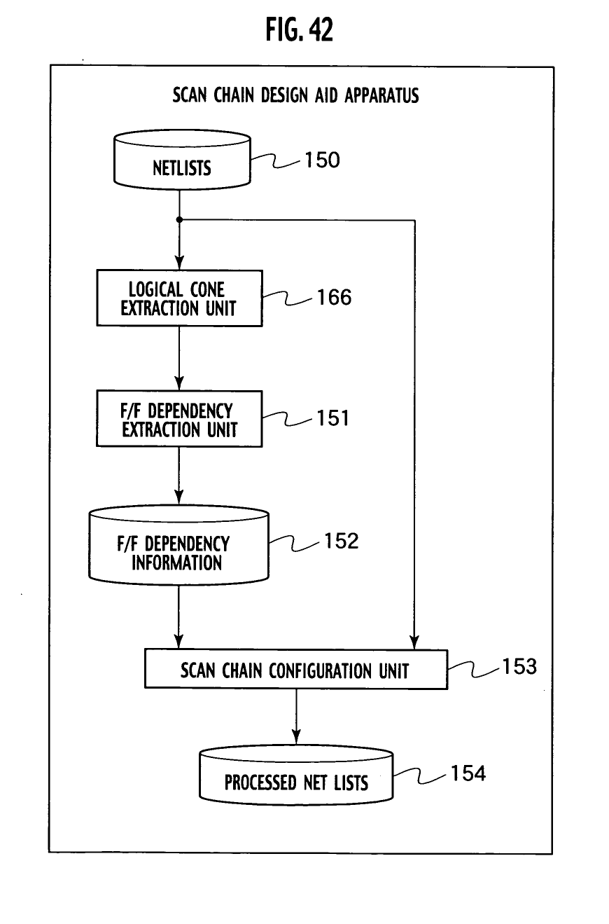

As shown in FIG. 42, a scan chain design aid apparatus, according to the fourth embodiment of the present invention, includes a calculation unit, which configures a net list for the scan chains 17a to 17n in the to-be-tested logic 18, and a storage unit connected to the calculation unit. The storage unit is permanently stored with a variety of data such as a net list 150, flip-flop dependency information 152, or a processed net list 154. The calculation unit includes a logical cone extraction unit 166, which extracts logical cones 44a and 44b of flip-flops 129 and 131 making up scan chains 137 and 139 in FIG. 41, a scanning F/F dependency extraction unit 151, which extracts a dependency between the extracted logical cones 44a and 44b, and a scan chain configuration unit 153, which constructs the scan chains 137 and 139 based on scanning F/F dependency information 117 and a net list 150.

The calculation unit should be configured as a part of a central processing unit (CPU) in a conventional computer system. The logical cone extraction unit 166, the scanning F/F dependency extraction unit 151, and the scan chain configuration unit 153 may be configured with dedicated hardware, respectively, or may be configured with software using a CPU of a regular computer system, which provides substantially the same capability as that hardware-based configuration. The storage unit may be configured with semiconductor memory such as semiconductor ROM or semiconductor RAM, an auxiliary storage unit such as a magnetic disc unit, a magnetic drum, or a magnetic tape unit, or a main storage unit of a CPU. An input unit, which receives data, instructions or the like from an operator, and an output unit, which outputs data of a processed net list 154, are connected to the calculation unit via an input/output control unit. The input unit includes a keyboard, a mouse, a light-pen, a flexible disc unit or the like. The output unit includes a printer, a display and the like. The display includes display units such as a CRT or liquid crystal. Program instructions for each processing to be executed by the calculation unit are stored in a program storage unit. Program instructions are read into a CPU as necessary, and the calculation unit in the CPU executes corresponding calculations. At the same time, data such as numeric information generated in each of a series of calculations is temporarily stored in the main storage unit of the CPU. The scan chain design aid apparatus may be a computer, and the scan chain design aid apparatus may be provided through execution of a written computer program.

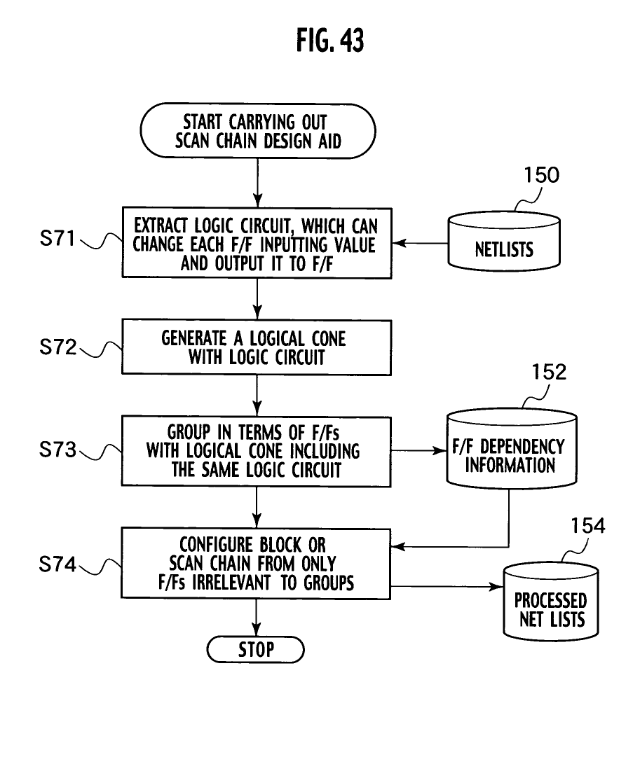

As shown in FIG. 43, according to a scan chain design aid method, to begin with, in step S71, the logical cone extraction unit 166 extracts logic circuits 123, 133, and 135, which output the values that allows change in the input values to the flip-flops 129 and 131, from the net list 150 showing connections relevant to the flip-flops 129 and 131. In step S72, the logical cone extraction unit 166 generates logical cones 44a and 44b based on the extracted logic circuits 123, 133, and 135 for each of the flip-flops 129 and 131.

In step S73, the flip-flop dependency extraction unit 151 extracts flip-flop dependency information 152 based on the generated logical cones 44a and 44b. The flip-flop dependency information 152 denotes dependency between the logical cones 44a and 44b, or an overlapping relationship therebetween. More specifically, grouping based on the flip-flops 129 and 131 having the logical cones 44a and 44b including the same logic circuit 123 is carried out.

In step S74, the scan chain configuration unit 153 generates the processed net list 154 based on the flip-flop dependency information 152 and the net list 150. More specifically, the scan chain configuration unit 153 modifies the net list 150 so that the flip-flops 129 and 131 with overlapped logical cones 44a and 44b cannot be connected in the same scan chain 141, and the scan chains 137 and 139 can be configured with flip-flop circuits without dependence on the logical cones 44a and 44b. The blocks 17aa and 17ab or the scan chains 137 and 139 are configured with only flip-flops irrelevant to group. The processed net list 154 is then generated.

According to the scan chain design aid method shown in FIG. 43, even in the case where the failure 121 occurs at an overlapping portion of the logical cones 44a and 44b, the flip-flops 129 and 131 with the logical cones 44a and 44b can belong to different scan chains 137 and 139. Therefore, as shown in FIG. 40, forming a scan chain 141 in which the failure 121 influences two flip-flops 125 and 127 or more, which belong to the scan chain 141, is no longer necessary. Moreover, optimal scan chains can be constructed using additional physical layout information. The scan chain design aid method can be implemented with a scan chain design aid program, which can be executed by a computer. Having a computer execute this scan chain design aid program allows implementation of the scan chain design aid method.

As described above, according to the scan chains design aid apparatus and the scan chain design aid method of the fourth embodiment, a failure 121 can be easily identified.

(Fifth Embodiment)

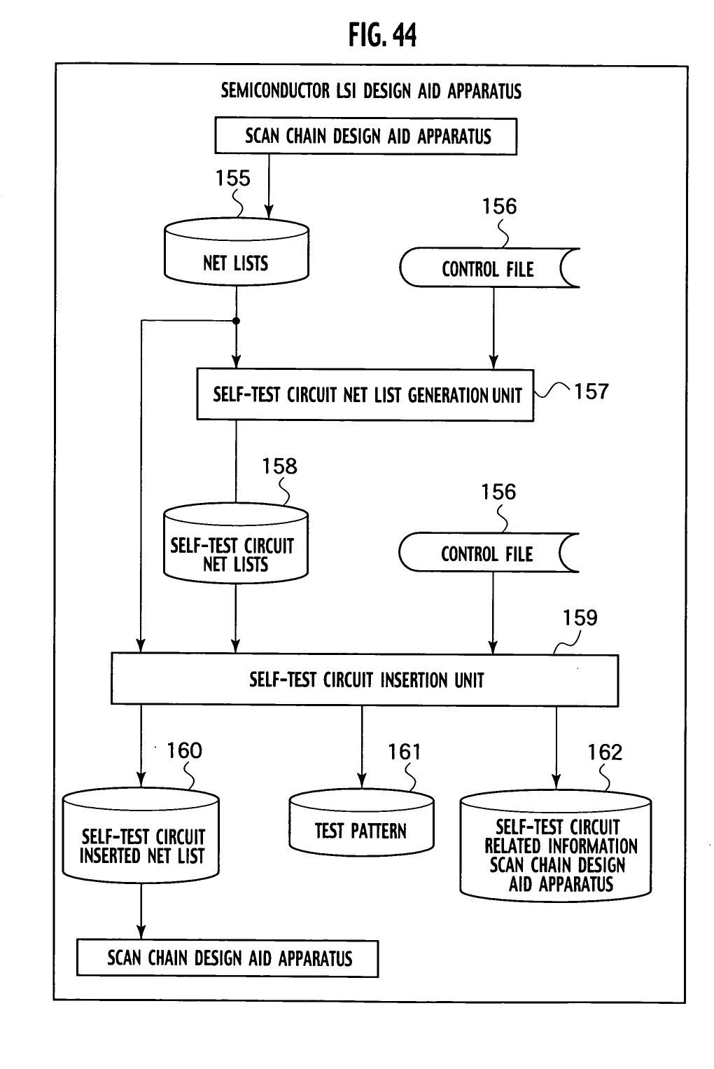

As shown in FIG. 44, an integrated circuit design aid apparatus according to a fifth embodiment of the present invention includes a calculation unit, which inserts a peripheral circuit in the to-be-tested logic 18 shown in FIGS. 10, 15 and 20 so that a self-test can be carried out, and a storage unit, which is connected to the calculation unit. Moreover, the integrated circuit design aid apparatus includes a scan chain design aid apparatus. The storage unit is permanently stored with a variety of data such as circuit data 155 for the to-be-tested logic 18, a control file 156 to be used to control a self-test, a net list 158 for a self-test circuit, a net list 160 after the self-test circuit has been inserted, a test pattern 161 and self-test circuit related information 162. The calculation unit includes a self-test circuit net list generation unit 157, which generates a peripheral circuit for a self-test, and a self-test circuit insertion unit 159, which inserts a self-test circuit net list 158 in the net list 155.

The calculation unit should be configured as a part of a central processing unit (CPU) in a regular computer system. The self-test circuit net list generation unit 157 and the self-test insertion unit 159 may be configured with dedicated hardware, or software using a CPU of a regular computer system, which is capable of providing substantially the same capability as that hardware-based configuration. The storage unit may be configured with semiconductor memory such as semiconductor ROM or semiconductor RAM, an auxiliary storage unit such as a magnetic disc unit, a magnetic drum, or a magnetic tape unit, or a main storage unit of a CPU. An input unit, which receives data or instructions from an operator via an input/output control unit, and an output unit, which outputs data from the processed net list 154, are connected to the calculation unit. Program instructions for each processing to be executed by the calculation unit are stored in a program storage unit. The program instructions are read into the CPU if necessary, and the calculation unit in the CPU executes corresponding calculations. At the same time, data such as numeric information generated in each step of a series of calculations is temporarily stored in the main storage unit of the CPU.

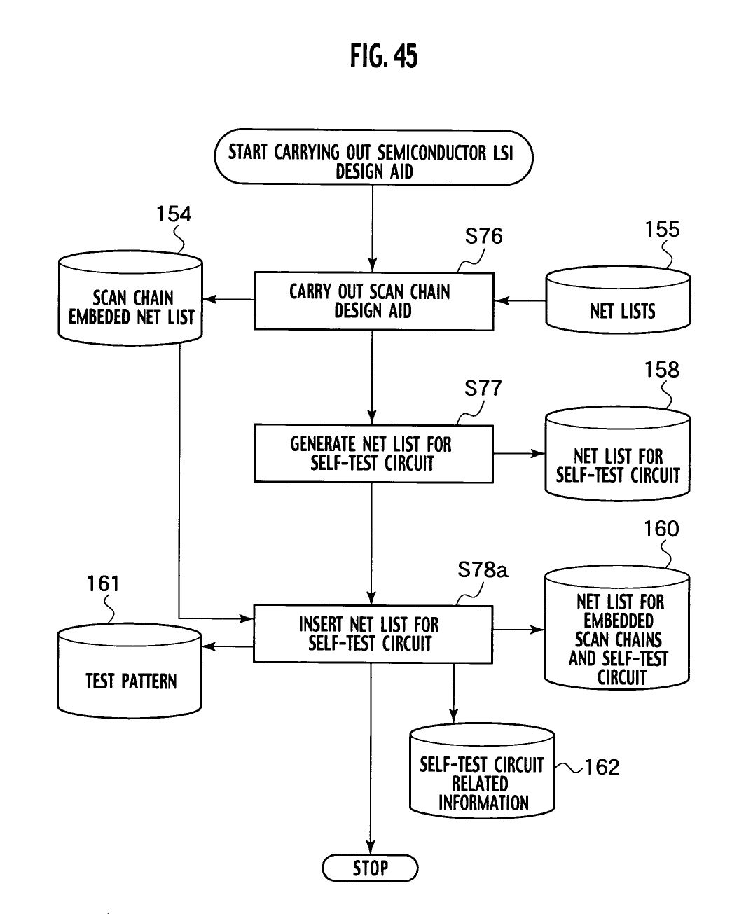

As shown in FIG. 45, according to the integrated circuit design aid method, to begin with, in step S77, the self-test circuit net list generation unit 157 generates the self-test circuit net list 158 suitable for the to-be-tested logic 18 according to the net list 155, based on the net list 155 and the control file 156.

In step S78, the self-test circuit insertion unit 159 then generates the self-test circuit inserted net list 160, the test pattern 161 and the self-test circuit relevant information 162 based on the net list 155, the self-test circuit net list 158 and the control file 156. More specifically, peripheral circuits for a self-test, such as the control circuit 22a, the shift counter 23, the pattern counter 24, the test pattern generation unit 29, the collective compression unit 16, the scan chain compression unit 2, the block compression unit 3, the expected pattern value comparison circuit 4, the failure pattern determination circuit 5, the scan chain expected value comparison circuit 6, the failure scan chain determination circuit 7, the block expected value comparison circuit 8, the failure block determination circuit 9, the failure register determination circuit 32, the register inversion circuit 33, and the register selection circuit 34, are inserted to the to-be-tested logic 18 according to the net list 155. As a result, a self-test circuit inserted circuit is generated. Moreover, the test pattern 161 and the self-test circuit relevant information 162 to be used for a self-test are generated.

As described above, the integrated circuit design aid apparatus and the integrated circuit design aid method according the fifth embodiment can easily identify failures.

It should be noted that the scan chain design aid apparatus of the fourth embodiment may be integrated into the integrated circuit design aid apparatus of the fifth embodiment. In step S76 of FIG. 45, the scan chains 17a to 17n in the to-be-tested logic 18 are constructed using the scan chains design aid apparatus shown in FIG. 42. Moreover, the self-test circuit net list 158 can be generated and inserted based on the net list 155 according to the to-be-tested logic 18 using the integrated circuit design aid apparatus in FIG. 44. It should be noted that either step S76 or steps S77 and S78 may be carried out first.

The present invention may be embodied in other specific forms without departing from the spirit or essential characteristics thereof. The embodiments are therefore to be considered in all respects as illustrative and not restrictive, the scope of the present invention being indicated by the appended claims rather than by the foregoing description, and all changes which come within the meaning and range of equivalency of the claims are therefore intended to be embraced therein.

What is claimed is:

1. An integrated circuit comprising:
scan chains implemented by registers disposed in a logic circuit, configured to shift in test patterns, to transfer the test patterns to the logic circuit, to receive test results of the logic circuit, and to shift out the test results;
a test pattern generation unit configured to transform the test patterns as scanning test patterns for feeding into the scan chains; and
a test result compression unit connected to the output stages of the scan chains, configured to compress the test results so as to generate the same number of compressed test result signatures as the number of the test results, and to transfer the resulting compressed test result signatures to the scan chains in a first order to allow one-to-one mapping.

2. The integrated circuit as claimed in claim 1, further comprising:
an expected value comparison circuit configured to compare the compressed test result signatures with a corresponding expected value in the first order, and detects a compressed test result signature which fails to match the corresponding expected value.

3. The integrated circuit as claimed in claim 2, further comprising:
a failure scan chain determination circuit configured to count the order of a compressed test result signature fails to match the corresponding expected value during comparison in the first order, and determines a failure scan chain, which includes a failure detected in the scan chains.

4. The integrated circuit as claimed in claim 1, wherein the test result compression unit includes:
data compression units connected to the respective output terminals of the scan chains, configured to receive the test results, and to transfer the compressed test result signatures, the number of the data compression units is the same as the number of the test results; and
a parallel to serial converter connected to all of the data compression units, configured to receive the compressed test result signatures in parallel, and to serially transfer the compressed test result signatures in the first order.

5. The integrated circuit as claimed in claim 1, wherein the test result compression unit comprises:
a first selector connected to the output terminals of the scan chains, configured to select and transfer the test results in a second order;
a plurality of data compression units connected to the first selector configured to receive the test results, and to transfer the compressed test result signatures, the number of the data compression units being smaller than the number of the test results; and
a parallel to serial converter connected to the data compression unit configured to receive the compressed test result signatures in parallel, and to serially transfer the compressed test result signatures in the first order.

6. The integrated circuit as claimed in claim 1, wherein the test result compression unit comprises:
a mode changeover circuit connected to the output stages of the scan chains configured to receive the test results in parallel and output the test results in parallel in a self-test mode, to receive the test results in parallel in a failure analysis mode, and to transfer the test results to the scan chains in a first order that allows one-to-one mapping; and
a data compression unit connected to the mode changeover circuit configured to receive the test results in parallel in the self-test mode, to collectively compresses the test results into a single compressed test result signature, and to compresses the test results in the first order in the failure analysis mode.

7. The integrated circuit as claimed in claim 1, wherein
the test pattern generation unit divides the test pattern, generating scanning test patterns;
the scan chains shift in the scanning test patterns and simultaneously transfer the scanning test patterns to the logic circuit, receive the test results fron the logic circuit, and shift out the block test results dividing the test results from respecitive last stages of blocks in the scan chains; and
the integrated circuit further comprises a block compression unit configured to receive the block test results, to compress the test results so as to generate the same number of compressed test result signatures as the test results, and to transfer the resulting compressed block test result signatures to the blocks in a third order that allows one-to-one mapping.

8. The integrated circuit as claimed in claim 7, further comprising:
a block expected value comparison circuit configured to compare the compressed block test result signatures with the corresponding expected values in a third order, and to detect a compressed block test result signature that fails to match the corresponding expected value; and
a failure block determination circuit configured to count the order of the compressed block test result signature that fails to match the corresponding expected value in the third order, and to identify a failure block having a failure detected in the blocks.

9. The integrated circuit as claimed in claim 7, wherein the block compression unit comprises:
second data compression units, connected to the output terminals of the blocks, configured to receive the block test results, and to tranfer compressed block test result signatures, the number of the second data compression units is the same as the number of the block test results; and
a second parallel to serial converter configured to receive in parallel the compressed block test result signature from the second data compression units, which are connected to the divided blocks in one of the scan chains, and to serially transfer the compressed block test result signatures in the third order.

10. The integrated circuit as claimed in claim 7, wherein the block compression unit comprises:
a second selector configured to transfer the block test results delivered from a failure scan chain; and
second data compression units connected to the second selector, configured to receive the block test results, and to transfer the compressed block test result signatures, the number of the second data compression units is smaller than the number of the block test results; and
a second parallel to serial converter configured to receive in parallel the compressed block test result signatures from the second data compression unit connected to the divided blocks in one of the scan chains and to serially output the compressed block test result signatures in the third order.

11. The integrated circuit as claimed in claim 7, wherein the block compression unit comprises:
a second selector connected to output terminals of the blocks, configured to select and to transfer each of the block test results in a fourth order; and
data compression units connected to the second selector, configured to receive the block test results and to transfer the compressed block test result signatures, the number of the data compression units is smaller than the number of the block test results.

12. The integrated circuit as claimed in claim 3, wherein
the test pattern generation unit is initialized as the test pattern into scanning test patterns in a failure pattern determination mode, a failure shift register determination mode, and a failure block determination mode;
the scan chains shift in the scanning test patterns, simultaneously transfer the scanning test patterns to the logic circuit, and receive the test results from the logic circuit, and in the failure pattern determination mode and the failure shift register determination mode, shift out the test results from the last stages of the scan chains, and in the failure block determination mode, shift out the block test results, which result from dividing the test results, from the last stages of the divided blocks in the scan chains; and
the test result compression unit receives the test results in parallel and collectively compresses the test results into a single compressed test result signature in the failure pattern determination mode, and in the failure shift register determination mode, transfers the compressed test result signature in the first order, and in the failure block determination mode, receives the block test results, compresses the test results so as to generate the same number of compressed test result signatures as the test results, and transfers the resulting compressed block test result signatures to the blocks in a third order that allows one-to-one mapping.

13. The integrated circuit as claimed in claim 12, wherein the test result compression unit comprises:
a second selector configured to transfer the test results in the failure pattern determination mode and the failure shift register determination mode, and in the failure block determination mode, to select and to transfer the block test results in a fourth order;
a mode changeover circuit connected to the second selector, configured to receive and to transfer the test results in parallel in the failure pattern determination mode, to receive the test results in parallel and to transfer the test results in parallel in the first order in the failure scan chain determination mode, and to transfer the block test results output from the failure scan chain in the failure block determination mode; and
a data compression unit connected to the mode changeover circuit, configured to receive the test results in parallel and to collectively compress, the test results into a single compressed test result signature in the failure pattern determination mode, to compress each of the test results in the first order and to transfer the resulting compressed test result signature in the first order in the failure scan chain determination mode, and to compress each of the block test results in the third order and to transfer the resulting compressed block test results in the third order in the failure block determination mode.

14. The integrated circuit as claimed in claim 7, wherein the block compression unit comprises:
an exclusive-OR calculation unit configured to transfer an exclusive-ORed value of the block test results, which are delivered from the scan chains including a failure scan chain;
second data compression units connected to the exclusive-OR calculation unit, configured to receive the exclusive-ORed value, and to transfer the compressed block test result signatures, the number of the second data compression units is smaller than the number of the block test results; and
a second parallel to serial converter configured to receive in parallel the compressed block test result signatures from the second data compression unit connected to the divided blocks in one of the scan chains and to serially transfer the compressed block test result signatures in the third order.

15. The integrated circuit as claimed in claim 7, further comprising:
a register selection circuit configured to select each of the registers implementing the blocks in a fourth order; and
a register inversion circuit configured to invert one of the value of the block test result and the value of the block test pattern received by a selected one of the registers into the resulting inverted block test result, the block compression unit receives the inverted block test result and compresses the inverted block test results into the resulting compressed, inverted block test results.

16. The integrated circuit as claimed in claim 15, wherein the block expected value comparison circuit compares the compressed, inverted block test results with the corresponding expected values, and detects a compressed, inverted block test result that matches that corresponding expected value; and
the integrated circuit further comprises a failure register determination circuit configured to count the order of the compressed, inverted block test result that matches the corresponding expected value in the fourth order, and to identify a failure register having a failure detected in the blocks.

17. The integrated circuit as claimed in claim 15, wherein
the register selection circuit comprises a first shift counter which selects each of the registers in the fourth order; and
the register inversion circuit comprises a toggle F/F circuit configured to control a hold/inversion of one of the value of the block test result and the value of the block test pattern received by a selected one of the registers.

18. The integrated circuit as claimed in claim 15, wherein at least two registers influenced by a failure belong to different scan chains.

19. A computer implemented apparatus for designing an integrated circuit comprising:
a net list generation unit configured to generate a net list for
a test pattern generation unit configured to divide a test pattern into a plurality of scanning test patterns,
scan chains implemented by registers disposed in a logic circuit, configured to shift in the scanning test patterns and to simultaneously transfer the scanning test patterns, and to receive test results from the logic circuit and to shift out the test results, the number of the scan chains is the same as the number of those test results, and
a test result compression unit connected to the output stages of the scan chains to compress the test results so as to generate the same number of compressed test result signatures as the test results, and to transfer a resulting compressed test result signatures to the scan chains in a first order that allows one-to-one mapping; and
a self-test circuit insertion unit configured to insert the net list for the test pattern generation unit, the scan chains, and the test result compression unit in the net list for the integrated circuit.

20. A computer implemented apparatus for designing scan chains inplemented by registers in an integrated circuit comprising:
a logical cone extraction unit configuted to extract a logic circuit that outputs a value according to changeable input values in the registers, and to generate a logical cone, which is a combination circuit that is included by the logic circuit, for each register;
a dependency extraction unit configured to generate a group of the registers in the logical cone including the same logic circuit; and
a scan chain configuration unit configured to generate any scan chains using only the registers not belonging to the same group.
